(19) United States
(12) Patent Application Publication
(10) Pub. No.: US 2025/0272724 A1
(43) Pub. Date: Aug. 28, 2025

(54) SMART CONTRACT-FACILITATED MINTING AND MANAGEMENT OF MULTI-ASSET BACKED TOKENS

(71) Applicant: Strong Force TX Portfolio 2018, LLC, Fort Lauderdale, FL (US)

(72) Inventors: Charles Howard Cella, Pembroke, MA (US); Hristo Malchev, Alta Loma, CA (US); Teymour El-Tahry, Detroit, MI (US); Andrew Locke, Farmington, MI (US); Jenna Parenti, Denver, CO (US); Brad Kell, Kenmore, WA (US)

(21) Appl. No.: 19/190,094

(22) Filed: Apr. 25, 2025

Related U.S. Application Data
(63) Continuation of application No. PCT/US2023/077998, filed on Oct. 27, 2023.
(60) Provisional application No. 63/381,547, filed on Oct. 28, 2022.
(60) Provisional application No. 63/472,223, filed on Jun. 9, 2023.

(51) Int. Cl. G06Q 30/0283; G06Q 30/018

(52) U.S. Cl. CPC G06Q 30/0283; G06Q 30/018; G06Q 2220/00

(57) ABSTRACT

A tokenization system/platform/method for minting asset-class backed tokens on a distributed ledger is described herein. A tokenization system/platform receives a token configuration indicating multiple revenue-generating assets of different types and a minting party. The platform configures smart contracts to manage revenue associated with revenue-generating assets, including a first function to mint asset-class backed tokens backed by the plurality of assets and a second function to computationally apportion and distribute revenue among blockchain addresses of token owners. After deploying the configured smart contracts on the distributed ledger, the platform initiates blockchain transactions to invoke the smart contract functions, including a first transaction that mints tokens and assigns them to purchasing users' blockchain addresses, and one or more second transactions that distribute cryptocurrency corresponding to revenue among token owners. The system/platform/method may provide for fractional ownership and management of different types of revenue-generating assets and/or portfolios of revenue-generating assets.

### CROSS-REFERENCE TO RELATED APPLICATIONS

This application is a continuation of International Application No. PCT/US2023/077998 (STRF-0024-WO), filed Oct. 27, 2023, entitled “ASSET-CLASS BACKED TOKENIZATION PLATFORM”, now published on May 2, 2024 as WO 2024/092183.

International Application No. PCT/US2023/077998 claims priority to the following U.S. Provisional Applications: Ser. No. 63/381,547 (SFTX-0022-P01), filed Oct. 28, 2022, and entitled “ASSET CLASS BACKED TOKEN DESIGN”; and Ser. No. 63/472,223 (SFTX-0023-P01), filed Jun. 9, 2023, and entitled “ASSET-CLASS BACKED TOKENIZATION PLATFORM.”

Each of the foregoing applications is incorporated herein by reference in its entirety.

U.S. patent application Ser. No. 17/554,663, filed Dec. 17, 2021, entitled “MARKET ORCHESTRATION SYSTEM FOR FACILITATING ELECTRONIC MARKETPLACE TRANSACTIONS” is also incorporated by reference in its entirety.

### BACKGROUND

Cryptocurrencies appear to be here to stay, as leading players like Bitcoin and Ethereum, as well as emerging ones like Crypto Kitties, have generated astounding levels of wealth and mainly private valuations. Many concerns remain, including volatility, lack of “true utility” that allows fundamental value analysis, and anticipated regulatory crackdown, among others. As a result, most institutional investment platforms either do not support trading in cryptocurrencies for their clients or offer very constrained access. However, investor interest continues to grow despite these limitations.

While bespoke tokens exist that are linked to other asset classes, such as patents or works of art, the range of possible types is almost certain to proliferate, leading to challenges for designers, purchasers, sellers, lenders, and others who interact with tokens, such as in marketplaces and exchanges.

### SUMMARY

Embodiments herein provide for tokens that solve or mitigate the problems with current cryptocurrencies, and a platform that facilitates convenient design, development, and deployment of such tokens. One key issue, utility, can be addressed by backing a cryptocurrency with another asset or asset class, in particular one that is more amenable to fundamental valuation analysis. Embodiments herein provide a robust platform that facilitates design, development, simulation, deployment, monitoring and analysis of new sets of tokens, including ones linked to a wide range of alternative asset classes, to a mix of asset classes, and to aspects of an asset class, such as a risk profile, volatility profile, and/or value profile, including value responses to certain types of events.

An asset-class backed tokenization platform is disclosed which includes a set of interconnected tools, services and applications to enable users to design, develop, simulate, deploy, monitor and analyze cryptographically secure, tradeable tokens, such as ones that are linked to or backed by one or more other asset classes, including alternative asset classes such as revenue streams from intellectual property, farms, manufacturing production capacity, energy production facilities, and real estate. In the platform, users may discover characteristics of asset classes and related tokens and configure token sets to satisfy a set of goals and/or to adhere to a strategy (e.g., by designing a set of tokens and/or an umbrella token that provides a risk/reward profile that is tuned to the goals of the designer). These tokens may render the drivers of volatility more transparent by tying them to the other asset classes, may mitigate or manage volatility by blending or combining the economic characteristics of multiple asset classes (e.g., to provide a desired positioning in a risk/reward space), may be configured to satisfy diversification and/or asset allocation goals, and the like.

Tokens linked to alternative asset classes may be referred to herein as “asset-class backed tokens,” “asset-linked tokens,” and the like. Such terms are used interchangeably except where context indicates otherwise. Backing or linking of a token with an alternative asset class or member thereof may be undertaken in a variety of ways, such as, without limitation: indexing the value of a token to a set of economic parameters of an asset class or particular asset or value stream within it (e.g., the amount of income generated by an asset, the valuation ascribed to the token in a secondary market, lending market, or insurance market, the value of an index on the underlying asset class or member, or many others); making a token redeemable for a set of units and/or a particular portion of a value stream (e.g., a percentage share, a time period, or combination thereof); using the token as an access-control mechanism for a holder to access a value stream (e.g., the right to control production of units by a 3D printer); setting a rule, algorithm, or the like by which the value of the token is determined, where the rule operates on underlying economic data associated with an asset class or member thereof (e.g., basing a real estate token's value on the average selling price of real estate in a relevant geography); comparing the token to other tokens that have similar characteristics (e.g., other tokens that are redeemable for a similar asset class or member thereof); and others. References to linking or backing throughout this disclosure are intended to encompass any of these, or combinations of these, except where context specifically indicates otherwise.

According to some embodiments of the present disclosure, a method for generating an asset-class backed token portfolio using a tokenization platform is disclosed. The method includes receiving, by the tokenization platform, a plurality of asset performance attributes from a user device. The method further includes prioritizing, by the tokenization platform, the plurality of asset performance attributes by providing the asset performance attributes to a first artificial intelligence (AI) model trained to detect conflicts between the plurality of asset performance attributes and to rank the plurality of asset performance attributes. The method further includes mapping, by the tokenization platform, the prioritized plurality of asset performance attributes to a plurality of real-world assets, wherein the mapping comprises determining types and numbers of assets that correspond to the prioritized plurality of token performance attributes. The method further includes simulating a performance of the plurality of real-world assets using a token simulator comprising a second AI model that is configured to simulate changes in value of real-world assets based on different input scenarios. The method further includes iteratively adjusting the types and numbers of assets based on the simulated performance to improve the mapping between the plurality of real-world assets and the prioritized plurality of token performance attributes. The method further includes generating an asset-class backed non-fungible token on a distributed ledger, wherein the asset-class backed non-fungible token is backed by a first number of a first asset and a second number of a second asset selected from the iteratively adjusted type and number of assets, wherein the first asset is a first type of asset and the second asset is a second type of asset, wherein the asset-class backed non-fungible token comprises a plurality of token attributes including a first asset identifier attribute that identifies the first asset, a first asset amount attribute that identifies a portion of the first asset, a second asset identifier attribute that identifies the second asset, and a second asset amount attribute that identifies a portion of the second asset. In some embodiments, the method further includes generating a second asset-class backed non-fungible token on the distributed ledger, wherein the second asset-class backed non-fungible token is backed by a third asset of the plurality of assets and a fourth asset of the plurality of assets, wherein the third asset is the first type of asset and the fourth asset is the second type of asset. Additionally or alternatively, the asset-class backed non-fungible token is redeemable for the first asset and the second asset. Additionally or alternatively, the asset-class backed non-fungible token is redeemable for either the first asset or the second asset. Additionally or alternatively, prioritizing the plurality of performance attributes comprises using a trained model to rank the plurality of performance attributes. In some of these embodiments, the method further includes training the model using a training data set comprising sets of user provided attributes and ranking labels for each set of user provided attributes. In some embodiments, the first asset comprises at least partial ownership of land and the second asset comprises usage rights to the land. Additionally or alternatively, the first asset comprises at least partial ownership of a productive asset and the second asset comprises at least a portion of an income stream from the productive asset. Additionally or alternatively, the first asset is a derivative asset corresponding to a first set of assets and the second asset is a derivative asset corresponding to a second set of assets. In some of these embodiments, the first set of assets are each related to a first infrastructure project and the second asset of assets are each related to a second infrastructure project. In some embodiments, at least one of the first asset and the second asset is an intellectual property asset. Additionally or alternatively, optimizing the plurality of assets comprises iteratively adjusting the number of assets in the plurality of assets and re-simulating the performance of the adjusted plurality of assets until the simulated performance is optimized. Additionally or alternatively, the plurality of assets comprise an oil and/or gas production facility. Additionally or alternatively, the plurality of assets comprise a digital twin of a revenue generating facility. Additionally or alternatively, the method further includes generating a plurality of governance rules based on one or more governance requirements associated with the plurality of assets; and configuring a token management smart contract stored on the distributed ledger based on the plurality of governance rules. In some embodiments, generating the asset-class backed non-fungible token on the distributed ledger comprises: generating a token description for the asset-class backed non-fungible token; configuring a smart contract on the distributed ledger based on the token description; and initiating a distributed ledger transaction configured to cause the configured smart contract to mint the asset-class backed non-fungible token based on the token description. Additionally or alternatively, the plurality of attributes further include at least one of an availability trigger that specifies when the first asset becomes available for redemption or an expiration trigger that specifies when the first asset is no longer available for redemption. Additionally or alternatively, the plurality of attributes further include one or more of token redemption rules or token governance rules. Additionally or alternatively, the method further includes generating a minting schedule based on the portfolio strategy; and after a time period specified by the minting schedule, generating additional asset-class backed non-fungible tokens backed by the plurality of assets. In some embodiments, the smart contract is further configured to collect revenue associated with at least one of the first asset and the second asset and to distribute the collected revenue among token holders.

According to some embodiments of the present disclosure, a method of minting a plurality of asset-class backed tokens on a distributed ledger is disclosed. The method further includes receiving, by a tokenization platform, a token configuration indicating a plurality of revenue-generating assets and a minting party, wherein the plurality of revenue-generating assets includes at least two different types of assets. The method further includes deploying, by the tokenization platform, at least one smart contract on the distributed ledger, wherein the deployed at least one smart contract is configured to receive revenue associated with the plurality of revenue-generating assets, wherein the deployed at least one smart contract includes: a first function configured to mint a plurality of asset-class backed tokens that are backed by the plurality of assets; and a second function configured to distribute the received revenue among blockchain addresses of current owners of the plurality of asset-class backed tokens. The method further includes, responsive to one or more purchase requests received by the tokenization platform, initiating, by the tokenization platform, the first function of the smart contract to cause minting of the plurality of asset-class backed tokens and assignment of each minted asset-class backed token to the blockchain address of a purchasing user; and periodically invoking, by the tokenization platform, the second function of the smart contract to distribute the received revenue to the blockchain addresses of the current owners of the plurality of asset-class backed tokens. In some embodiments, the method further includes verifying, by the tokenization platform, that the minting party owns the plurality of revenue-generating assets prior to deploying the at least one smart contract. Additionally or alternatively, the minting party is a crowdfunding pool, wherein the blockchain addresses of the current owners of the plurality of asset-class backed tokens are associated with users of the crowdfunding pool, and wherein the distribution of the received revenue is in proportion to an amount a corresponding user contributed to the crowdfunding pool. Additionally or alternatively, the minting party in a portfolio seller, wherein the blockchain addresses correspond to portfolio buyers. Additionally or alternatively, each asset-class backed token is redeemable for a portion of the plurality of assets. Additionally or alternatively, the token configuration is received from a token strategy engine configured to generate the token configuration based on a plurality of token performance attributes provided by the minting party. Additionally or alternatively, the plurality of assets comprises ownership of land and usage rights to the land. Additionally or alternatively, the plurality of assets comprises ownership of a productive asset and an income stream from the productive asset. Additionally or alternatively, the plurality of assets comprises a derivative asset corresponding to a first set of assets and a derivative asset corresponding to a second set of assets. In some of these embodiments, the first set of assets are each related to a first oil and/or gas production facility and the second asset of assets are each related to a second oil and/or gas production facility. Additionally or alternatively, at least one of plurality of assets is an intellectual property asset. In some of these embodiments, owners of the plurality of asset-class backed tokens are entitled to sublicense at least a portion of intellectual property rights corresponding to the intellectual property asset. Additionally or alternatively, the method further includes receiving, by the tokenization platform, a plurality of governance rules based on one or more governance requirements associated with the plurality of assets; and configuring, by the tokenization platform, the one or more smart contracts based on the plurality of governance rules. Additionally or alternatively, each of the plurality of asset-class backed tokens are backed by a first asset of the plurality of assets and a second asset of the plurality of assets, wherein the first asset is a first type of asset and the second asset is a second type of asset, wherein each asset-class backed token comprises a plurality of attributes including a first asset identifier attribute that identifies the first asset, a first asset amount attribute that identifies a portion of the first asset, a second asset identifier attribute that identifies the second asset, and a second asset amount attribute that identifies a portion of the second asset. In some of these embodiments, the plurality of attributes further include at least one of an availability trigger that specifies when the first asset becomes available for redemption or an expiration trigger that specifies when the first asset is no longer available for redemption. Additionally or alternatively, the plurality of attributes further include one or more of token redemption rules or token governance rules. Additionally or alternatively, the method further includes generating a minting schedule based on the token configuration; and after a time period specified by the minting schedule, generating additional asset-class backed tokens backed by the plurality of assets. Additionally or alternatively, the method further includes generating, using a token simulator system, an estimated value of the plurality of assets; determining, based on the estimated value of the plurality of assets, an estimated value of each token of the plurality of asset-class backed tokens; and transmitting, to a marketplace system, an indication of the estimated value of each token of the plurality of asset-class backed tokens. In some of these embodiments, the marketplace system sets a minimum price of each of the plurality of asset-class backed tokens based on the estimated value of each token of the plurality of asset-class backed tokens. Additionally or alternatively, the estimated value of plurality of assets includes an estimated income produced by an income stream asset.

According to some embodiments of the present disclosure, a method for configuring at least one smart contract on a distributed ledger to manage a plurality of asset-class backed tokens is disclosed. The method further includes receiving, by a tokenization platform, a token configuration indicating a plurality of assets, wherein the plurality of assets includes at least two different types of assets, wherein at least one of the types of assets comprises a revenue-generating asset. The method further includes configuring, by a tokenization platform, at least one smart contract on the distributed ledger to mint and manage a plurality of asset-class backed tokens that are backed by the plurality of assets, wherein the at least one smart contract is configured to: authorize token transfers from a first distributed ledger account to a second distributed ledger account in accordance with one or more governance rules, wherein the governance rules are configured to prohibit transfer to the second distributed ledger account if the second distributed ledger account does not meet qualifications specified by the one or more governance rules; monitor a distributed ledger oracle for one or more asset-related events; receive revenue related to the plurality of assets; and distribute the received revenue to current owners of the asset-class backed tokens; responsive to one or more purchase requests received by the tokenization platform, initiating, by the tokenization platform, minting of the plurality of asset-class backed tokens and assignment of each minted asset-class backed token to the blockchain address of a purchasing user; and causing, by the tokenization platform, the smart contract to distribute the received revenue to the blockchain addresses of current owners of the plurality of asset-class backed tokens, wherein the distribution is responsive to the one or more asset-related events. In some embodiments, the one or more asset-related events comprise at least one of: a new purchase or license of at least one of the plurality of assets; a change in recurring revenue for a revenue-generating asset; a revenue-generating asset starting operation; a revenue-generating asset stopping operation; or a receipt of revenue related to an asset. Additionally or alternatively, the plurality of assets comprise intellectual property rights, wherein the distributed ledger oracle is configured to maintain a list of licensees of intellectual property rights, and wherein the tokenization platform configures the at least one smart contract to enforce collection of revenues from the licensees of the intellectual property rights. In some of these embodiments, the at least one smart contract is configured to execute a breach workflow against a licensee that does not transfer revenues to the at least one smart contract. Additionally or alternatively, owners of the plurality of asset-class backed tokens are entitled to sublicense at least a portion of the intellectual property rights. Additionally or alternatively, the plurality of assets comprises property rights, wherein the distributed ledger oracle is configured to maintain a list of lessees of the property, and wherein the tokenization platform configures the at least one smart contract to enforce collection of revenues from the lessees of the property. Additionally or alternatively, each asset-class backed token is redeemable for a portion of the plurality of assets. Additionally or alternatively, the token configuration is received from a token strategy engine configured to generate the token configuration based on a plurality of portfolio goals provided by the minting party. Additionally or alternatively, the plurality of assets comprises ownership of land and usage rights to the land. Additionally or alternatively, the plurality of assets comprises ownership of a productive asset and an income stream from the productive asset. Additionally or alternatively, the plurality of assets comprises a derivative asset corresponding to a first set of assets and a derivative asset corresponding to a second set of assets. In some of these embodiments, the first set of assets are each related to a first oil and/or gas production facility and the second asset of assets are each related to a second oil and/or gas production facility. Additionally or alternatively, the plurality of assets comprise a digital twin of a revenue generating facility. Additionally or alternatively, each of the plurality of asset-class backed tokens are backed by a first asset of the plurality of assets and a second asset of the plurality of assets, wherein the first asset is a first type of asset and the second asset is a second type of asset, wherein each asset-class backed token comprises a plurality of attributes including a first asset identifier attribute that identifies the first asset, a first asset amount attribute that identifies a portion of the first asset, a second asset identifier attribute that identifies the second asset, and a second asset amount attribute that identifies a portion of the second asset. In some of these embodiments, the plurality of attributes further include at least one of an availability trigger that specifies when the first asset becomes available for redemption or an expiration trigger that specifies when the first asset is no longer available for redemption. Additionally or alternatively, the plurality of attributes further include one or more of token redemption rules or token governance rules. Additionally or alternatively, the method further includes generating a minting schedule based on the token configuration; after a time period specified by the minting schedule, generating additional asset-class backed non-fungible tokens backed by the plurality of assets. Additionally or alternatively, the method further includes generating, using a token simulator system, an estimated value of the plurality of assets; determining, based on the estimated value of the plurality of assets, an estimated value of each token of the plurality of asset-class backed tokens; and transmitting, to a marketplace system, an indication of the estimated value of each token of the plurality of asset-class backed tokens. In some of these embodiments, the marketplace system sets a minimum price of each of the plurality of asset-class backed tokens based on the estimated value of each token of the plurality of asset-class backed tokens. Additionally or alternatively, the estimated value of plurality of assets includes an estimated income produced by an income stream asset.

According to some embodiments of the present disclosure, a method for simulating the value of an asset-class backed token linked to a product in development is disclosed. The method includes receiving, at a tokenization platform, an asset component specification for the product in development, wherein the asset component specification specifies a plurality of components for manufacturing the product. The method further includes receiving, for at least one of the plurality of components, a material input specification defining materials used in manufacturing the component. The method further includes simulating, by the tokenization platform, a development of the plurality of components using an artificial intelligence (AI) model, wherein the simulating is based on the material input specification, wherein the AI model is trained to simulate the development of the plurality of components in different market conditions. The method further includes simulating, by the tokenization platform, a performance of the product using a second AI model that is trained to predict market sales in different market conditions. The method further includes aggregating, by the tokenization platform, the simulation of the development of the plurality of components in different market conditions and the simulation of the performance of the planned product in different market conditions to generate simulation outputs. The method further includes estimating a value of a plurality of asset-class backed tokens linked to the product based on the simulation outputs. The method further includes generating a sales listing for the asset-class backed token, wherein the value of the sales listing is based on the estimated value. The method further includes deploying a smart contract to a blockchain, wherein the smart contract is configured to: mint a plurality of asset-class backed tokens; distribute first revenue from sales of the plurality of asset-class backed tokens to a producer of the product; receive second revenue related to sales of the asset-class backed tokens; and distribute the second revenue to current owners of the asset-class backed tokens. In some embodiments, the planned product is an electronic device, wherein the plurality of components comprises a processor, a display, a memory, and a software component. Additionally or alternatively, the simulating of the development of the plurality of components uses a machine learning model, wherein the inputs to the machine learning model comprise an estimated cost of a first component of the plurality of components and an estimated cost of materials used to manufacture a second component of the plurality of components. In some of these embodiments, the machine learning model is trained to output a cost of the plurality of components in a first set of market conditions, wherein a second machine learning model is trained to output a cost of the plurality of components in a second set of market conditions. Additionally or alternatively, the method further includes simulating the performance of the planned product comprises uses a machine learning model configured to estimate one or more economics factors, geopolitical factors, or weather factors. Additionally or alternatively, the method further includes generating a plurality of asset-class backed tokens corresponding to the planned product, and selling the plurality of asset-class backed tokens to raise funding for manufacturing the product. In some of these embodiments, the plurality of asset-class backed tokens are backed by a percentage of sales revenue of the planned product. Additionally or alternatively, the plurality of asset-class backed tokens are backed by a fees paid by software developers of applications for the planned product. Additionally or alternatively, the plurality of asset-class backed tokens are backed by a percentage of subscription revenue from customers of the planned product. Additionally or alternatively, simulation outputs indicate which market conditions are most important for achieving a best-case outcome.

According to some embodiments of the present disclosure, a method of configuring a deployment of an automated market maker (AMM) smart contract on a blockchain is disclosed. The method includes receiving, by a tokenization platform, a token configuration indicating a plurality of assets, wherein the plurality of assets includes at least two different types of assets, wherein at least one of the types of assets comprises a revenue-generating asset. The method further includes configuring, by a tokenization platform, at least one smart contract on the blockchain to mint and manage a plurality of asset-class backed tokens that are linked to the plurality of assets. The method further includes generating, by the tokenization platform, an AMM configuration using a trained machine learning model, wherein the AMM configuration comprises at least one trading pair and a trading function, wherein one of the tokens of the trading pair is the asset-class backed token, wherein the trading function defines a formula for trading a first type of token for the asset-class backed token and for trading the asset-class backed token for the first type of token. The method further includes deploying, by the tokenization platform, an AMM smart contract on the blockchain, wherein the deployed AMM smart contract is configured to receive revenue into a liquidity pool managed by the AMM smart contract and to implement the trading function for the trading pair. The method further includes generating, by the tokenization platform, a graphical user interface configured to allow a user that owns at least a first amount of the first type of token of the trading pair to exchange the first amount of the first type of token for at least a second amount of a second token of the trading pair based on the trading function. The method further includes receiving, by the tokenization platform, an AMM trading request from a user associated with a user blockchain account. The method further includes generating, by the tokenization platform, an AMM trading transaction for signature by the user using a private key associated with the blockchain account. The method further includes transmitting, by the tokenization platform, the signed AMM trading transaction to the blockchain, wherein the signed AMM transaction causes an exchange of tokens using the AMM smart contract based on the trading function. In some embodiments, the AMM is one or more of a constant product market maker, a constant sum market maker, or a constant mean market maker. Additionally or alternatively, the AMM is one or more of a hybrid automated market maker, a dynamic automated market maker, a proactive market maker, or a virtual automated market maker. Additionally or alternatively, generating the AMM configuration comprises using the trained machine learning model comprises: receiving one or more user inputs specifying AMM configuration parameters; and using the trained machine learning model to generate additional AMM configuration parameters based on the one or more user inputs. In some of these embodiments, the AMM configuration parameters comprise one or more of: the trading pair; the trading function; one or more liquidity pool rules; one or more risk mitigation rules; or one or more distribution rules. Additionally or alternatively, the tokenization platform is further configured to receive transactions involving the AMM smart contract and generate one or more analyses of the transactions, wherein the one or more analyses comprise one or more of a trading volume analysis, a liquidity pool analysis, or a price change analysis. In some of these embodiments, the graphical user interface is further configured to display the one or more analyses. Additionally or alternatively, the graphical user interface is further configured to generate a liquidity pool funding transaction for signature by a liquidity pool contributor. Additionally or alternatively, the plurality of assets comprise at least partial ownership of land and usage rights to the land. Additionally or alternatively, the plurality of assets comprise at least partial ownership of a productive asset and at least a portion of an income stream from the productive asset. Additionally or alternatively, the plurality of assets comprise a derivative asset corresponding to a first set of assets and a derivative asset corresponding to a second set of assets. Additionally or alternatively, the plurality of assets comprise a first set of assets related to a first infrastructure project and a second set of assets related to a second infrastructure project. Additionally or alternatively, the plurality of assets comprise an intellectual property asset. Additionally or alternatively, the plurality of assets comprise an oil and/or gas production facility. Additionally or alternatively, the plurality of assets comprise a digital twin of a revenue generating facility.

### BRIEF DESCRIPTION OF FIGURES

FIG. 1 schematically depicts components and interactions of an asset-class backed tokenization platform, applications, and supporting systems in accordance with various embodiments.

FIG. 2 schematically depicts an asset-based tokenization platform in accordance with various embodiments.

FIG. 3 schematically depicts a token design system in accordance with various embodiments.

FIG. 4 depicts token attributes in accordance with various embodiments.

FIG. 5 depicts asset class attributes in accordance with various embodiments.

FIG. 6 depicts asset token framework parameters in accordance with various embodiments.

FIG. 7 depicts parameters for a token simulator in accordance with various embodiments.

FIG. 8 depicts an example system for creating asset linked tokens in accordance with various embodiments.

FIG. 9 depicts an example tokenization controller in accordance with various embodiments.

FIG. 10 depicts an example token link description in accordance with various embodiments.

FIG. 11 depicts an example token deployment controller in accordance with various embodiments.

FIG. 12 depicts an example token marketplace controller in accordance with various embodiments.

FIG. 13 depicts an example asset class description in accordance with various embodiments.

FIG. 14 depicts an example beneficial characteristic in accordance with various embodiments.

FIG. 15 depicts an example performance representation in accordance with various embodiments.

FIG. 16 depicts an example procedure to generate an asset class linked token in accordance with various embodiments.

FIG. 17 depicts an example procedure to generate an asset linked token in accordance with various embodiments.

FIG. 18 depicts an example procedure to adjust an asset linked token in accordance with various embodiments.

FIG. 19 depicts an example strategy engine in accordance with various embodiments.

FIG. 20 depicts an example method for designing a portfolio strategy in accordance with various embodiments.

FIG. 21 depicts an example smart contract for generating asset-class backed tokens on a distributed ledger in accordance with various embodiments.

FIG. 22 depicts an example method for minting asset-class backed tokens on a distributed ledger in accordance with various embodiments.

FIG. 23 depicts an example environment including a smart contract for managing tokens stored on a blockchain in accordance with various embodiments.

FIG. 24 depicts an example method for authorizing the transfer of asset-class backed tokens using a smart contract in accordance with various embodiments.

FIG. 25 depicts an example method for updating a token management smart contract on a blockchain based on off-chain events in accordance with various embodiments.

FIG. 26 depicts an example method for receiving and distributed revenue related to asset-class backed tokens in accordance with various embodiments.

FIG. 27 depicts an example token simulator for simulating token performance in accordance with various embodiments.

FIG. 28 depicts an example method for simulating performance of a planned product and corresponding asset-class backed tokens in accordance with various embodiments.

FIG. 29 depicts an example method for generating a purchase recommendation for an asset-class backed token in accordance with various embodiments.

### DETAILED DESCRIPTION

Systems and methods described herein significantly advance the state of the distributed ledger and blockchain technologies by providing for various hybrid tokens and other advanced use cases. For example, in some embodiments of the present disclosure a single digital token backed by a plurality of assets can be used to represent an entire portfolio, such that the digital token may be configured for a particular investment profile (e.g., age, volatility sensitivity, sophistication, etc.) and may be offered to any user to meet that user's full set of investing or business objectives. Systems described herein may be capable of ingesting a user's or a group of users' goals and designing a token strategy to generate and/or acquire the right token or tokens. Designing a token strategy may further include predicting a future value of a token such that a strategy embodied by linking the token to one or more asset classes or value streams is likely to meet a user's needs both in the present and in the future. In embodiments, a value stream of an asset-class backed token may refer to the proceeds (e.g., cash, cryptocurrency, or other forms of value transfer) that are awarded to an owner of the token. In these scenarios, an asset-class backed token may provide value streams for their holders, while also providing long term growth potential. For example, an asset-class backed token may be linked to an annuity to meet ongoing spending needs, where the token can be partially redeemed to receive the income at each of a set of time intervals, while also being linked to another asset class for long-term wealth creation.

Advanced use cases described herein further include “tokens on tokens,” which may allow a user to hold a token that represents a group of tokens or fractions of tokens. Similarly, tokens described herein may allow for fractional token ownership, allowing a user to have cross ownership (e.g., of artwork or other non-fungible physical assets, with rules for sharing the asset and/or a value-only interest in the asset). Additionally or alternatively, tokens described herein may include a bundle of rights associated with an object/machine/product/entity, such that different kinds of ownership may be tokenized collectively or separately. These multiple kinds of ownership may include, for example, the ownership of the digital rights for movies versus the ownership of rights for display in an art gallery. Moreover, the rights may be split up by geographic regions, such that the rights to an asset class of value stream in a specific region may be tokenized.

In embodiments, advanced token configurations as described herein may include derivative tokens, which may be used to hold an option position in the market that may be traded in independently from market trades. Additionally or alternatively, tokens may be configured to provide futures position(s) on the value of a token on the market.

To enhance and enable these and other advanced use cases, an asset-class backed tokenization platform may be configured with a plurality of systems and functions. These systems and functions may include a strategy engine for designing and minting a set of asset-class backed tokens in accordance with user-defined priorities and goals while taking into account legal and other governance standards, a token simulator configured to simulates the current and future value of tokens in various conditions, one or more smart contracts configured to mint and/or manage tokens automatically, and/or a variety of other systems, components, and method as described in more detail herein.

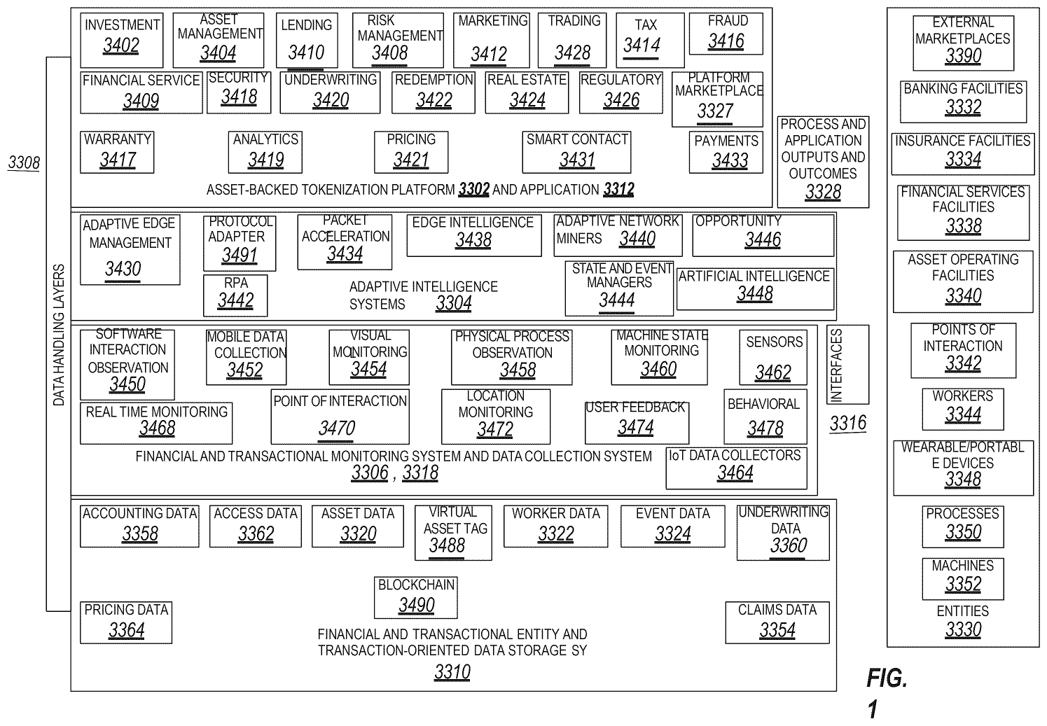

Referring to FIG. 1, additional details, components, sub-systems, and other elements of an optional embodiment of an asset-class backed tokenization platform layer 3302 and associated applications 3312 are illustrated. The asset-class backed tokenization platform layer 3302 and subsequent figures. The data handling layers can automatically collect relevant information, such as through edge, IoT, and other networking systems, can store the relevant data for use by relevant services and applications (including ones involved in token design, configuration, simulation, deployment, monitoring and analysis), can apply various algorithms and intelligence to the data (including for producing relevant analytics, for simulation of token behavior, for similarity and clustering and other uses), and the like. All of these capabilities enable the various core capabilities of an asset-class backed tokenization platform described throughout this disclosure. The asset-class backed tokenization platform 3302 may, in various optional embodiments, include a set of applications, systems, solutions, interfaces, or the like, collectively referred to for convenience as applications 3312, by which an operator or owner of an asset, token, transactional or financial entity, or other users, may manage, monitor, control, analyze, or otherwise interact with one or more elements of the entity 3330. In embodiments, the asset-class backed tokenization platform layer 3302 may include a set of data handling layers 3308 each of which is configured to provide a set of capabilities that facilitate development and deployment of intelligence, such as for facilitating automation, machine learning, applications of artificial intelligence, intelligent transactions, state management, event management, process management, and many others, for a wide variety of financial and transactional applications and end uses. In embodiments, the data handling layers 3308 include a financial and transactional monitoring systems layer 3306, a financial and transactional entity-oriented data storage systems layer 3310 (referred to in some cases herein for convenience simply as a data storage layer 3310), an adaptive intelligence systems layer 3304 and an asset-class backed tokenization platform layer 3302. Each of the data handling layers 3308 may include a variety of services, programs, applications, workflows, systems, components, and modules, as further described herein and in the documents incorporated herein by reference. In embodiments, each of the data handling layers 3308 (and optionally the asset-class backed tokenization platform layer 3302 as a whole) is configured such that one or more of its elements can be accessed as a service by other data handling layers 3308 or by other systems (e.g., being configured as a platform-as-a-service deployed on a set of cloud infrastructure components in a microservices architecture). For example, a data handling layer 3308 may have a set of interfaces 3316, such as application programming interfaces (APIs), brokers, services, connectors, wired or wireless communication links, ports, human-accessible interfaces, software interfaces or the like by which data may be exchanged between the data handling layer 3308 and other layers, systems or sub-systems of the asset-class backed tokenization platform layer 3302, as well as with other systems, such as financial entities 3330 or external systems, such as cloud-based or on-premises enterprise systems (e.g., accounting systems, resource management systems, CRM systems, supply chain management systems and many others. Each of the data handling layers 3308 may include a set of services (e.g., microservices), for data handling, including facilities for data extraction, transformation and loading; data cleansing and deduplication facilities; data normalization facilities; data synchronization facilities; data security facilities; computational facilities (e.g., for performing pre-defined calculation operations on data streams and providing an output stream); compression and de-compression facilities; analytic facilities (such as providing automated production of data visualizations) and others.

In embodiments, each data handling layer 3308 has a set of application programming interfaces 3316 for automating data exchange with each of the other data handling layers 3308. These may include data integration capabilities, such as for extracting, transforming, loading, normalizing, compressing, decompressing, encoding, decoding, and otherwise processing data packets, signals, and other information as it exchanged among the layers and/or the applications 3312, such as transforming data from one format or protocol to another as needed in order for one layer to consume output from another. In embodiments, the data handling layers 3308 are configured in a topology that facilitates shared data collection and distribution across multiple applications and uses within the asset-class backed tokenization platform layer 3302 by the financial and transactional monitoring systems layer 3306. The financial and transactional monitoring systems layer 3306 may include, integrate with, and/or cooperate with various data collection and management systems 3318, referred to for convenience in some cases as data collection systems 3318, for collecting and organizing data collected from or about financial and transactional entities 3330, as well as data collected from or about the various data handling layers 3308 or services or components thereof.

The set of applications 3312 may include, without limitation, one or more of any of a wide range of types of applications, such as an investment application 3402 (such as, without limitation, for investment in shares, interests, currencies, commodities, options, futures, derivatives, real property, trusts, cryptocurrencies, tokens, and other asset classes); an asset management application 3404 (such as, without limitation, for managing investment assets, real property, fixtures, personal property, real estate, equipment, intellectual property, vehicles, human resources, software, information technology resources, data processing resources, data storage resources, power generation and/or storage resources, computational resources and other assets); a lending application 3410 (such as, without limitation, for personal lending, commercial lending, collateralized lending, microlending, peer-to-peer lending, insurance-related lending, asset-class backed lending, secured debt lending, corporate debt lending, student loans, mortgage lending, automotive lending, and others); a risk management application 3408 (such as, without limitation, for managing risk or liability with respect to a product, an asset, a person, a home, a vehicle, an item of equipment, a component, an information technology system, a security system, a security event, a cybersecurity system, an item of property, a health condition, mortality, fire, flood, weather, disability, malpractice, business interruption, infringement, advertising injury, slander, libel, violation of privacy or publicity rights, injury, damage to property, damage to a business, breach of a contract, and others); a payments application 3433 (such as for enabling various payments within and across marketplaces, including credit card, debit card, wire transfer, ACH, checking, currency and other payments); a marketing application 3412 (such as, without limitation, an application for marketing a financial or transactional product or service, an advertising application, a marketplace platform or system for goods, services or other items, a marketing analytics application, a customer relationship management application, a search engine optimization application, a sales management application, an advertising network application, a behavioral tracking application, a marketing analytics application, a location-based product or service targeting application, a collaborative filtering application, a recommendation engine for a product or service, and others); a trading application 3428 (such as, without limitation, a buying application, a selling application, a bidding application, an auction application, a reverse auction application, a bid/ask matching application, a securities trading application, a commodities trading application, an option trading application, a futures trading application, a derivatives trading application, a cryptocurrency trading application, a token-trading application, an analytic application for analyzing financial or transactional performance, yield, return on investment, or other metrics, a book-building application, or others); a tax application 3414 (such as, without limitation, for managing, calculating, reporting, optimizing, or otherwise handling data, events, workflows, or other factors relating to a tax, a levy, a tariff, a duty, a credit, a fee or other government-imposed charge, such as, without limitation, sales tax, income tax, property tax, municipal fees, pollution tax, renewal energy credit, pollution abatement credit, value added tax, import duties, export duties, and others); a fraud prevention application 3416 (such as, without limitation, one or more of an identity verification application, a biometric identify validation application, a transactional pattern-based fraud detection application, a location-based fraud detection application, a user behavior-based fraud detection application, a network address-based fraud detection application, a black list application, a white list application, a content inspection-based fraud detection application, or other fraud detection application, a financial service, application or solution 3409 (referred to collectively as a “financial service”, such as, without limitation, a financial planning service, a tax planning service, a portfolio management service, a transaction service, a lending service, a banking service, a currency conversion service, a currency exchange service, a remittance service, a money transfer service, a wealth management service, an estate planning service, an investment banking service, a commercial banking service, a foreign exchange service, an insurance service, an investment service, an investment management service, a hedge fund service, a mutual fund service, a custody service, a credit card service, a safekeeping service, a checking service, a debit card service, a lending service, an ATM service, an ETF service, a wire transfer service, an overdraft service, a reporting service, a certified checking service, a notary service, a capital markets service, a brokerage service, a broker-dealer service, a private banking service, an insurance service, an insurance brokerage service, an underwriting service, an annuity service, a life insurance service, a health insurance service, a retirement insurance service, a property insurance service, a casualty insurance service, a finance and insurance service, a reinsurance service, an intermediation service, a trade clearinghouse service, a private equity service, a venture capital service, an angel investment service, a family office investment service, an exchange service, a payments service, a settlement service, an interbank networking service, a debt resolution service, or other financial service); a security application, solution or service 3418 (referred to herein as a security application, such as, without limitation, any of the fraud prevention applications 3416 noted above, as well as a physical security system (such as for an access control system (such as using biometric access controls, fingerprinting, retinal scanning, passwords, and other access controls), a safe, a vault, a cage, a safe room, or the like), a monitoring system (such as using cameras, motion sensors, infrared sensors and other sensors), a cyber security system (such as for virus detection and remediation, intrusion detection and remediation, spam detection and remediation, phishing detection and remediation, social engineering detection and remediation, cyber-attack detection and remediation, packet inspection, traffic inspection, DNS attack remediation and detection, and others) or other security application); an underwriting application 3420 (such as, without limitation, for underwriting any insurance offering, any loan, or any other transaction, including any application for detecting, characterizing or predicting the likelihood and/or scope of a risk, including underwriting based on any of the data sources, events or entities noted throughout this disclosure or the documents incorporated herein by reference); a redemption application 3422 (such as, without limitation, a distribution system for providing an investor or owner with the output of the underlying asset class, or member thereof that is linked to or that backs the token, whether the output is a financial dividend, a revenue share, a production facility, or the like, which can involve any of the linking or backing frameworks noted herein (e.g., using a token as evidence of a redemption right, using a token as an access control mechanism for a production element, tying the value of a token to an index, etc.) and which can be optionally deployed through existing financial intermediaries or through one or more peer-to-peer payment systems); a real estate application 3424 (such as, without limitation, a real estate brokerage application, a real estate valuation application, a real estate investment trust application, a real estate mortgage or lending application, a real estate assessment application, a real estate marketing application, or other); a regulatory application 3426 (such as, without limitation, an application for regulating any of the applications, services, transactions, activities, workflows, events, entities, or other items noted herein and in the documents incorporated by reference herein, such as regulation of pricing, marketing, offering of securities, offering of insurance, undertaking of broker or dealer activities, use of data (including data privacy regulations, regulations relating to storage of data and others), banking, marketing, sales, financial planning, and many others); a platform-operated marketplace 3327 application, solution or service (referred to in some cases simply as a marketplace application (which term may also, as context permits include various types of external marketplaces 3390), such as, without limitation an e-commerce marketplace, an auction marketplace, a physical goods marketplace, a virtual goods marketplace, an advertising marketplace, a reverse-auction marketplace, an advertising network, a marketplace for attention resources, an energy trading marketplace, a marketplace for computing resources, a marketplace for networking resources, a spectrum allocation marketplace, an Internet advertising marketplace, a television advertising marketplace, a print advertising marketplace, a radio advertising marketplace, an in-game advertising marketplace, an in-virtual reality advertising marketplace, an in-augmented reality marketplace, a real estate marketplace, a hospitality marketplace, a travel services marketplace, a financial services marketplace, a blockchain-based marketplace, a cryptocurrency marketplace, a token-based marketplace, a loyalty program marketplace, a time share marketplace, a rideshare marketplace, a mobility marketplace, a transportation marketplace, a space-sharing marketplace, or other marketplace); a warranty application 3417 (such as, without limitation, an application for a warranty or guarantee with respect to a product, a service, an offering, a solution, a physical product, software, a level of service, quality of service, a financial instrument, a debt, an item of collateral, performance of a service, or other item); an analytics solution 3419 (such as, without limitation, an analytic application with respect to any of the data types, applications, events, workflows, or entities mentioned throughout this disclosure or the documents incorporated by reference herein, such as a big data application, a user behavior application, a prediction application, a classification application, a dashboard, a pattern recognition application, an econometric application, a financial yield application, a return on investment application, a scenario planning application, a decision support application, and many others); a pricing application 3421 (such as, without limitation, for pricing of goods, services (including any mentioned throughout this disclosure and the documents incorporated by reference herein), applications (including any mentioned throughout this disclosure and the documents incorporated by reference herein), software, data services, insurance, virtual goods, advertising placements, search engine and keyword placements, and many others; and a smart contract application, solution, or service (referred to collectively herein as a smart contract application, such as, without limitation, any of the smart contract types referred to in this disclosure or in the documents incorporated herein by reference, such as a smart contract using a token or cryptocurrency for consideration, a smart contract that vests a right, an option, a future, or an interest based on a future condition, a smart contract for a security, commodity, future, option, derivative, or the like, a smart contract for current or future resources, a smart contract that is configured to account for or accommodate a tax, regulatory or compliance parameter, a smart contract that is configured to execute an arbitrage transaction, or many others). Thus, the asset-class backed tokenization platform layer 3302 may host an enable interaction among a wide range of disparate applications 3312 (such term including the above-referenced and other financial or transactional applications, services, solutions, and the like), such that by virtue of shared microservices, shared data infrastructure, and shared intelligence, any pair or larger combination or permutation of such services may be improved relative to an isolated application of the same type.

In embodiments, the adaptive intelligence systems layer 3304 may include a set of systems, components, services, and other capabilities that collectively facilitate the coordinated development and deployment of intelligent systems, such as ones that can enhance one or more of the applications 3312 at the asset-class backed tokenization platform layer 3302. These adaptive intelligence systems layer 3304 may include an adaptive edge compute management solution 3430, a robotic process automation system 3442, a set of protocol adaptors 3491, a packet acceleration system 3434, an edge intelligence system 3438, an adaptive networking system 3440, a set of state and event managers 3444, a set of opportunity miners 3446, a set of artificial intelligence systems 3448 and other systems. The robotic process automation system 3442 may be configured to take outputs and outcomes 3328 from various applications.

In embodiments, the financial and transactional monitoring systems layer 3306 and its data collection systems 3318 may include a wide range of systems for collection of data. This layer may include, without limitation, real time monitoring systems 3468 (such as onboard monitoring systems like event and status reporting systems on ATMs, POS systems, kiosks, vending machines and the like; onboard diagnostic and telematics systems on vehicle and equipment; systems providing diagnostic codes and events via an event bus, communication port, or other communication system; monitoring infrastructure (such as cameras, motion sensors, beacons, RFID systems, smart lighting systems, asset tracking systems, person tracking systems, and ambient sensing systems located in various environments where transactions and other events take place), as well as removable and replaceable monitoring systems, such as portable and mobile data collectors, RFID and other tag readers, smart phones, tablets and other mobile device that are capable of data collection and the like); software interaction observation systems 3450 (such as for logging and tracking events involved in interactions of users with software user interfaces, such as mouse movements, touchpad interactions, mouse clicks, cursor movements, keyboard interactions, navigation actions, eye movements, finger movements, gestures, menu selections, and many others, as well as software interactions that occur as a result of other programs, such as over APIs, among many others); mobile data collectors 3452 (such as described extensively herein and in documents incorporated by reference), visual monitoring systems 3454 (such as using video and still imaging systems, LIDAR, IR and other systems that allow visualization of items, people, materials, components, machines, equipment, personnel, gestures, expressions, positions, locations, configurations, and other factors or parameters of entities 3330, as well as inspection systems that monitor processes, activities of workers and the like); point of interaction systems 3470 (such as point of sale systems, kiosks, ATMs, vending machines, touch pads, camera-based interaction tracking systems, smart shopping carts, user interfaces of online and in-store vending and commerce systems, tablets, and other systems at the point of sale or other interaction by a customer or worker involved in shopping and/or a transaction); physical process interaction observation systems 3458 (such as for tracking physical activities of customers, physical activities of transaction parties (such as traders, vendors, merchants, customers, negotiators, brokers, and the like), physical interactions of workers with other workers, interactions of workers with physical entities like machines and equipment, and interactions of physical entities with other physical entities, including, without limitation, by use of video and still image cameras, motion sensing systems (such as including optical sensors, LIDAR, IR and other sensor sets), robotic motion tracking systems (such as tracking movements of systems attached to a human or a physical entity) and many others; machine state monitoring systems 3460 (including onboard monitors and external monitors of conditions, states, operating parameters, or other measures of the condition of a machine, such as a client, a server, a cloud resource, an ATM, a kiosk, a vending machine, a POS system, a sensor, a camera, a smart shopping cart, a smart shelf, a vehicle, a robot, or other machine); sensors and cameras 3462 and other IoT data collection systems 3464 (including onboard sensors, sensors or other data collectors (including click tracking sensors) in or about a financial or transactional environment (such as, without limitation, an office, a back office, a store, a mall, a virtual store, an online environment, a web site, a bank, or many others), cameras for monitoring an entire environment, dedicated cameras for a particular machine, process, worker, or the like, wearable cameras, portable cameras, cameras disposed on mobile robots, cameras of portable devices like smart phones and tablets, and many others, including any of the many sensor types disclosed throughout this disclosure or in the documents incorporated herein by reference); indoor location monitoring systems 3472 (including cameras, IR systems, motion-detection systems, beacons, RFID readers, smart lighting systems, triangulation systems, RF and other spectrum detection systems, time-of-flight systems, chemical noses and other chemical sensor sets, as well as other sensors); user feedback systems 3474 (including survey systems, touch pads, voice-based feedback systems, rating system, expression monitoring systems, affect monitoring systems, gesture monitoring systems, and others); behavioral monitoring systems 3478 (such as for monitoring movements, shopping behavior, buying behavior, clicking behavior, behavior indicating fraud or deception, user interface interactions, product return behavior, behavior indicative of interest, attention, boredom or the like, mood-indicating behavior (such as fidgeting, staying still, moving closer, or changing posture) and many others); and any of a wide variety of Internet of Things (IoT) data collectors 3464, such as those described throughout this disclosure and in the documents incorporated by reference herein.

Financial and transactional entities 3330 may include any of the wide variety of assets, systems, devices, machines, facilities, individuals or other entities mentioned throughout this disclosure or in the documents incorporated herein by reference, such as, without limitation: financial machines 3352 and their components (e.g., automated teller machines, point of sale machines, vending machines, kiosks, smart-card-enabled machines, and many others); financial and transactional processes 3350 (such as lending processes, software processes (including applications, programs, services, and others), production processes, banking processes (e.g., lending processes, underwriting processes, investing processes, and many others), financial service processes, diagnostic processes, security processes, safety processes and many others); wearable and portable devices 3348 (such as mobile phones, tablets, dedicated portable devices for financial applications, data collectors (including mobile data collectors), sensor-based devices, watches, glasses, hearables, head-worn devices, clothing-integrated devices, arm bands, bracelets, neck-worn devices, AR/VR devices, headphones, and many others); workers 3344 (such as banking workers, financial service personnel, managers, engineers, floor managers, vault workers, inspectors, delivery personnel, currency handling workers, process supervisors, security personnel, safety personnel and many others); points of interaction 3342 (e.g., kiosks, ATMs, point-of-sale systems, cash registers, checkout systems, points of use and many others); and asset operating facilities 3340 (such as currency production facilities, storage facilities, vaults, bank branches, office buildings, banking facilities, financial services facilities, cryptocurrency mining facilities, data centers, trading floors, high frequency trading operations, and many others), which may include, without limitation, among many others, storage and financial services facilities 3338 (such as for financial services inventory, components, packaging materials, goods, products, machinery, equipment, and other items); insurance facilities 3334 (such as branches, offices, storage facilities, data centers, underwriting operations and others); and banking facilities 3332 (such as for commercial banking, investing, consumer banking, lending and many other banking activities).

In embodiments, the data storage layer 3310 may include a range of systems for storage of data, such as the accounting data 3358, access data 3362, pricing data 3364, asset data 3320, worker data 3322, event data 3324, underwriting data 3360 and claims data 3354. Asset data 3320 may include a wide range of historical and/or forecasted economic and other data and attributes associated with an asset class or member thereof, including price data, revenue data, profit data, yield data, rental income data, production volume data, timing data, operational data (e.g., historical and forecast production output), status data (e.g., state of health, maintenance or operating condition), workflow data (such as past and forecast activities of an asset), aggregate or index data, valuation data, ratings data (including credit ratings, quality ratings, and the like), and many others. Storage systems layer 3310 may include, without limitation, physical storage systems, virtual storage systems, local storage systems, distributed storage systems, databases, memory, network-based storage, network-attached storage systems (such as using NVME, storage attached networks, and other network storage systems), and many others. In embodiments, the data storage layer 3310 may store data in one or more knowledge graphs (such as a directed acyclic graph, a data map, a data hierarchy, a data cluster including links and nodes, a self-organizing map, or the like). In embodiments, the data storage layer 3310 may store data in a digital thread, ledger, or the like, such as for maintaining a longitudinal record of an entity 3330 over time, including any of the entities described herein. In embodiments, the data storage layer 3310 may use and enable a virtual asset tag 3488, which may include a data structure that is associated with an asset and accessible and managed as if the tag were physically located on the asset, such as by use of access controls, so that storage and retrieval of data are optionally linked to local processes, but also optionally open to remote retrieval and storage options. In embodiments, the data storage layer 3310 may include one or more blockchains 3490, such as ones that store identity data, transaction data, entity data for the entities 3330, pricing data, ownership transfer data, data for operation by smart contracts 3431, historical interaction data, and the like, such as with access control that may be role-based or may be based on credentials associated with an entity 3330, a service, or one or more applications 3312.

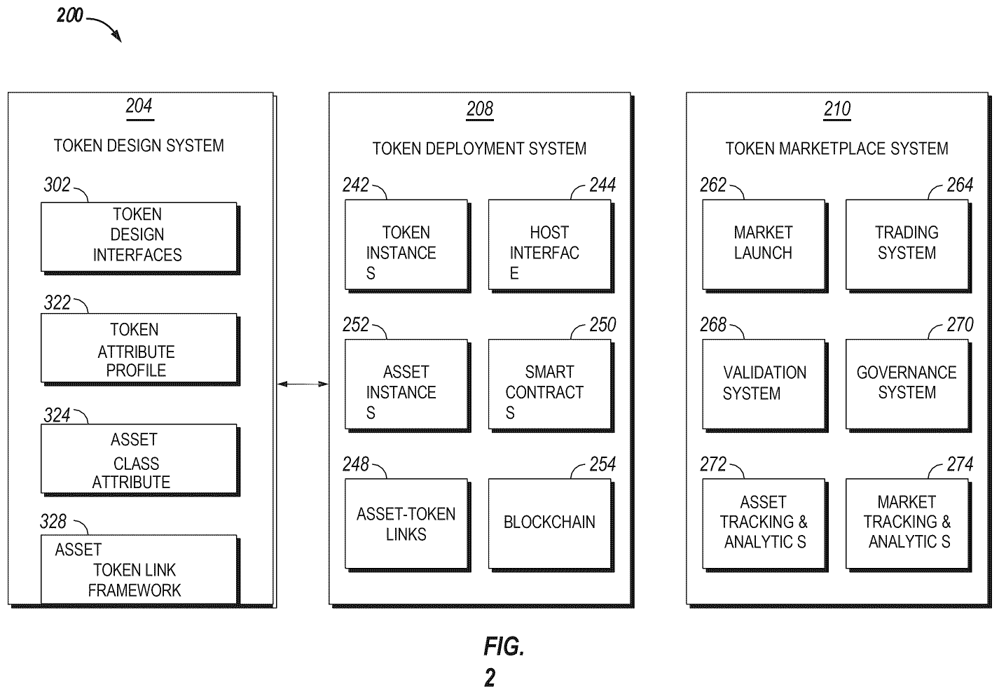

Referring to FIG. 2, an asset-class backed tokenization platform 200 is shown. The asset-class backed tokenization platform 200 may include a set of interconnected tools, services and applications to enable users to design, develop, simulate, deploy, monitor and analyze cryptographically secure, tradeable tokens, such as ones that are linked to or backed by one or more other asset classes, including alternative asset classes such as revenue streams from intellectual property, farms, manufacturing production capacity, energy production facilities, and real estate, among many others. Any asset class that produces a revenue or value stream, whether denominated in currency or other units (e.g., energy, attention (e.g., page views, clicks, or the like) may be linked or associated with a token or set of tokens to provide backing, utility or linking that supports the token. This may include linking or backing to revenue streams (e.g., from rental, royalties, revenue sharing agreement, sales commissions, services, and many others); valuations (e.g., to indexes of securities, bonds, currencies, points, tokens, and the like); production units (e.g., of goods, energy, materials, commodities, and the like); services (e.g., data services, physical services, microservices, networking services and the like); behaviors (e.g., attention); and others.

In the platform 200 users may discover characteristics of the asset classes that may be linked to or back tokens as well as characteristics of the tokens (and similar other ones). This may include data collection from public data sources, proprietary data sources, historical data, and the like, using the various mechanisms noted in connection with FIG. 1 and the embodiment of the asset-class backed tokenization platform 3302 associated therewith.

Using the interfaces of the platform 200, token designers may configure token sets to satisfy a set of goals and/or to adhere to a strategy (e.g., by designing a set of tokens and/or an umbrella token that provides a risk/reward profile that is tuned to the goals of the designer). The designed tokens may render the drivers of volatility more transparent, such as by tying them to the other asset classes, may mitigate or manage volatility (such as by blending or combining the economic characteristics of multiple asset classes), may be configured to satisfy diversification and/or asset allocation goals (such as by linking to multiple asset classes such that a set of tokens behaves economically like a portfolio or fund), and the like.

The asset-class backed tokenization platform 200 may include a token design system 204, a token deployment system 208, and a token marketplace system 210. A token design system may include token design interfaces 302 to enable a user to design a token having a specified token attribute profile 322, a specified asset class attribute profile 324, and an asset-token link framework 328. Configuring a token in the token design system 204 interface may include selecting and/or configuring the nature of the backing or linking of a token with an alternative asset class or member thereof. Such backing or linking may be undertaken in a variety of ways, such as, without limitation: indexing the value of a token to a set of economic parameters of an asset class or particular asset or value stream within it (e.g., the amount of income generated by an asset, the valuation ascribed to the token in a secondary market, lending market, or insurance market, the value of an index on the underlying asset class or member, or many others); making a token redeemable for a set of units and/or a particular portion of a value stream (e.g., a percentage share, a time period, or combination thereof); using the token as an access-control mechanism for a holder to access a value stream (e.g., the right to control production of units by a 3D printer); setting a rule, algorithm, or the like by which the value of the token is determined, where the rule operates on underlying economic data associated with an asset class or member thereof (e.g., basing a real estate token's value on the average selling price of real estate in a relevant geography); comparing the token to other tokens that have similar characteristics (e.g., other tokens that are redeemable for a similar asset class or member thereof); and others. As noted above, references to linking or backing throughout this disclosure are intended to encompass any of these, or combinations of these, except where context specifically indicates otherwise. Selecting and configuring may include choosing an asset class (such as from a drop-down menu), choosing a linking framework among various available ones, determining a number of tokens, setting timing for release, and configuring other attributes (e.g., redemption rules, timing of releases, trading rules, and the like). As such, the token design system may interpret a token link description comprising a token performance representation that corresponds to a beneficial characteristic of at least one asset and/or its asset class and the corresponding asset class description to the at least one asset and/or its asset class. The token design system may also generate at least one asset class linked token in response to the token link description and the asset class description. The token deployment system 208 may include token instances 242, asset instances 252, asset-token links 248, a host interface 244, smart contracts 250, and blockchains 254.

Once designed, a token may be simulated before being deployed, such as in a token simulator that simulates the behavior of the token based on historical economic data regarding the backing or linked asset class, as well as forecast data. Simulations may include algorithmic simulations, such as ones that aggregate other simulations, including ones that cover underlying asset classes. Simulations may allow the designer to anticipate and adjust for likely events, as well as to set up rules that address unlikely (e.g., “black swan”) events. Simulations may use data collection from real marketplaces, as well as simulated marketplaces, and may take advantage of various artificial intelligence and machine learning capabilities noted throughout this disclosure and the documents incorporated by reference herein.

When ready, the token may be deployed in a token marketplace, such as using the token marketplace system 210, which may include systems for market launch 262, market tracking and analytics 274 and an asset tracking and analytics 272. The token marketplace system 210 may further include a trading system 264, a governance system 270, and a validation system 268 or further examples of such systems as they relate to one or more asset classes.

Token designers can interact with token design interfaces 302 of the asset-class backed tokenization platform 200 to design the attributes of a proposed asset-class backed token 318 based on the asset classes they represent. A token designer may select blockchains and consensus algorithms for validation, set tokenomics parameters where applicable, determine quantities and timing for launching tranches of tokens, set opening prices, create governing rules for trading, and the like. Token design can allow tuning of token attributes to the attributes of the underlying asset class, including aligned timing, risk/reward curve, etc.

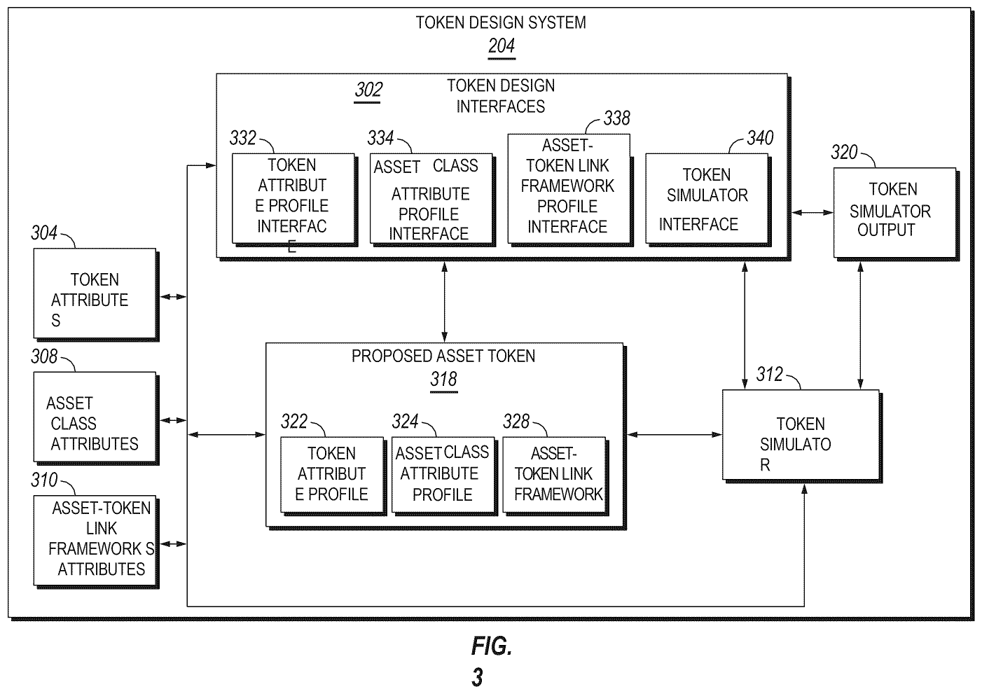

Referring to FIG. 3, the token design system 204, may include a token design interface 302 (also referenced as a user interface) to define a proposed asset-class backed token 318. The token design interface 302 may include a token attribute profile interface 332, an asset class attribute profile interface 334, and asset-token link framework profile interface 338, and a token simulator interface 340. The token attribute profile interface 332 enables a user or designer to select a variety of token attributes 304 that will define the token attribute profile 322 of the proposed asset-class backed token 318. The asset class attribute profile interface 334 enables the user or designer to select a variety of asset class attributes 308 to define the asset class attribute profile 324 of the proposed asset-class backed token 318. The asset-token link framework profile interface 338 enables a user or designer to select asset-token link framework attributes 310 to define the asset-token link framework 328. framework. The token simulator interface 340 enables a user or designer to view token simulator output 320 from running a token simulator 312 to predict a performance of the proposed asset-class backed token 318.

The token design interface 302 may allow a user to review a range of token attributes and asset classes attributes and analyze the attributes based on historical analytic datasets, design the properties of a proposed asset-class backed token 318, including selecting among a set of asset-token link framework attributes 310, and simulate the market behavior of the proposed asset-class backed token 318. This may be an iterative process as the token attribute profile 322, asset class attribute profile 324, as well as the asset-token link framework 328 may be altered based on one or more results of the simulation.

Referring to FIG. 19, another aspect of the invention relates to a strategy engine 1902 that can be engaged through the token design interface 302. In embodiments, the strategy engine 1902 includes a machine learning system 1904 that trains a set of machine-learned models 1908 to output a determination 1918 related to a set of token design strategies employed by a token designer, which is optionally trained using a training data set 1910 comprising at least one of asset class and/or token features, attributes, parameters, and outcomes. In embodiments, the strategy engine includes an artificial intelligence system 1912 that receives a request 1914 for a determination 1918 of a set of asset class attributes that may be configured to support a strategy selected and/or configured by a user and generates a set of asset class recommendations (such as relating asset class types, specific bundles of assets, relative amounts, timing of recommended acquisition or disposition, or the like) regarding a set of asset classes (optionally including a recommended set of tokens that represent, are redeemable for, are indexed to, are linked to, or otherwise are associated with the set of asset classes), such that the recommended actions with respect to the asset classes (and, as applicable, tokens), implement the strategy that is selected and/or configured by the user. The strategy may be specified in the token design interface, simulated in the simulation interface, and the like, such as to display the nature of the association of each asset class/asset class token with an aspect of the strategy. Parameters of the strategy may include specific goals sought by the strategy (e.g., preservation of capital, a desired risk/return profile, accumulation of a specified amount of value (e.g., to meet a defined goal), and the like. Behavior of asset classes in relation to strategies may be simulated, and association of asset class recommendations and simulations with token attributes may include visual representations of historical performance, optionally presented in layers such that aggregate impacts of a set of tokens are represented, with historical and/or forecasted volatility/variance. In embodiments, the strategy engine 1902 may use a search function, such as allowing a token designer to search for asset classes (including other tokens) that have a desired set of characteristics, such as maintenance of value, volatility, liquidity, trading velocity, trading volume, legal permission to trade (e.g., permissibility for trading in a given jurisdiction), compatibility with infrastructure (e.g., availability of APIs for algorithmic trading and/or presence of blockchain, smart contract, wallets, or other infrastructure), and others. This may be accomplished through an interface that allows a user to set filters to discover asset classes that meet the filters (which may include collaborative filters that leverage choices of similar users) or through algorithmic searching, such as based on similarity of an asset class to a desired asset class that may be characterized by the user in a user interface.

In embodiments, the AI system 1912 may leverage various types of generative AI models, including Generative Adversarial Networks (GANs), variational autoencoders (VAEs), long short-term memory networks (LSTMs), transformer language models, and/or condition generative models, as well as other types of generative AI models for various use cases as described elsewhere herein. In these embodiments, the AI system 1912 may include specialized hardware for efficiently implementing different types of neural network layers, various operations used by different architectures (e.g., multi-head attention layers for transformer models), and/or the like. In some embodiments, the AI system 1912 may use a transformer-based embeddings model (or another type of embeddings model) to generate embeddings for some use cases. For example, in use cases in which the platform 200 provides contextual information to a language model, the language model may use embeddings to access the contextual information, where the embeddings may be generated by the embeddings model and made available to the language model to find via a vector search. A transformer-based embeddings model may be a deep learning model that uses self-attention mechanisms to generate vector embeddings. Transformer-based embeddings models may be effective in capturing contextual nuances of language based on word position and other factors via the self-attention mechanisms of the transformer model. Additionally or alternatively, other embeddings methods, such as Word2Vec or FastText, may also be employed to generate embeddings. Word2Vec, for instance, is a shallow neural network model that can generate word embeddings by learning from the co-occurrence of words within a certain window in the text. FastText extends the Word2Vec methodology by considering subword information, which may increase its effectiveness at handling out-of-vocabulary words and misspellings.

In embodiments, the strategy engine 1902 may include a set of predetermined strategies and associated asset classes, such as: (i) asset classes with low historical volatility, guaranteed returns, backing or tethering to underlying value, or the like for capital preservation strategies; (ii) tokens representing returns from speculative asset classes like bonds of emerging countries for more aggressive strategies seeking high returns and accepting higher risk, and (iii) various permutations associated with other strategies, including ones that have predetermined pivot points (e.g., shifting from aggressive-to-conservative as a threshold level of value is accumulated, as the user reaches a certain age, and the like). Preconfigured and/or custom strategies may be selected or designed among many available strategies, such as buy and hold, long/short equity, credit-default swap strategies, asset allocation, intertemporal portfolio choice, pairs trading, swing trading, scalping, day trading, news-based, market timing, social trading, front-running, chart-based, computer-science based, automated/algorithmic, and hybrids and combinations of the foregoing. Custom, hybrid and combined strategies may be supported by sets of tokens representing different aspects needed to support the underlying strategy, such as a security token for a growth equity allocation in a portfolio, an intellectual property royalty stream token or production yield token for a current yield goal in a portfolio, and a real estate token in an emerging market for a speculative value accumulation goal of the token. Each set of tokens may be represented in the analytic interfaces described herein, such as showing historical behavior of the underlying asset class, predicted or simulated behavior (optionally using machine learning or AI operating on historical data sets to forecast behavior), correlations among the asset classes (e.g., to indicate where selected tokens may have underlying economic relationships that tend to increase volatility and/or anticipated returns (e.g., due to reinforcing aspects of two asset classes or that have underlying relationships) or that tend to reduce volatility and/or returns (e.g., where the asset classes/tokens tend to be correlated in ways that hedge risk).

In embodiments, the strategy engine 1902 may be trained over time, such as on a training data set 1910 of token designers and outcomes of tokens on the platform, to take an input strategy, discover a set of asset classes that are candidates to satisfy the strategy, select a set of asset class-linked tokens, generate a plan for acquisition and/or disposition of tokens (and possibly other assets), to execute the strategy, and issue a set of instructions (executable over time) to execute the plan. In embodiments, the strategy engine may be trained, using similar inputs and feedback on outcomes, to monitor and rebalance a set of tokens, including based on market changes (e.g., changes in value of tokens or other assets), changes in strategy (including pre-planned changes and ones that emerge), and/or based on other factors.

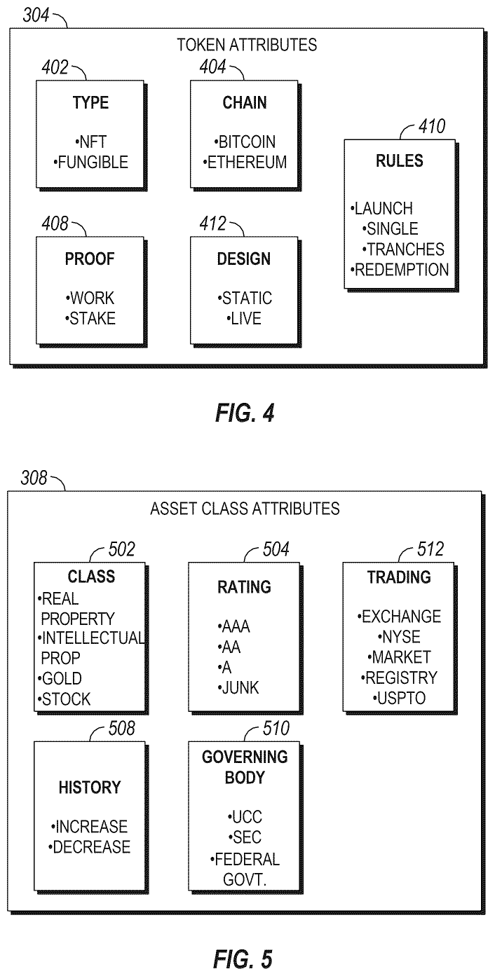

In embodiments, a recommendation for a token designer and/or an algorithmically generated plan for token design may include a set of inputs generated by collaborative filtering, such as operating on a set of token designs of other designers and/or a set of token designs generated automatically for a similar strategy, a similar user, or the like. Selection of a cohort for collaborative filtering may be based on similarity attributes of a strategy (e.g., risk/reward profile, goals, timing, preferences for certain asset classes, geography, and many others), similarity attributes of users (e.g., demographic, psychographic, preference, location, age and other factors), and the like. Once a cohort is formed, recommendations may be provided based on the strategies that are favored by the most similar user and/or that are the most similar in attributes. Collaborative filtering recommendations may take into account historical outcomes, such as risk/reward profiles, as well as predictions and simulations as noted above. Referring to FIG. 4, token attributes 304 which may be part of the token attribute profile 322 may include media type 402, market rules 410 (e.g., how the tokens may be redeemed, whether the tokens will be launched singularly or tranches), proof 408, token design 412 (e.g., static or live), chain 404 (e.g., bitcoin, Ethereum), and the like and may vary between asset classes. Token attributes 304 may include media and display properties, trading rules, blockchain attributes, consensus algorithm details, tokenomics details, and smart contract options for token handling (including for token launches (e.g., in tranches), burning, redemption, exchange, and the like). A library of reference designs may be accessed by drop-down menus, drag-and-drop, or the like to facilitate rapid generation of new tokens from precedent, selection of different token attributes 304, and the like.

Hybrid-asset tokens may have attributes of multiple asset classes, such as commodities, securities, real-estate, intellectual property baskets, and the like. Asset class attributes 308, which may be part of the token's asset class attribute profiles 324. The asset class attributes 308 may include identifying data (such as what conventional legal and market frameworks govern asset ownership and transfer), historical data on the asset class (including linkages to relevant analytic data sets, such as displaying price and trading volume patterns, volatility, valuation estimates, expert commentary, ratings, and many others), and/or projections or simulations of asset class behavior. Referring to FIG. 5, asset class attributes 308 may include class of attribute 502, asset rating 504, information on historical performance of the asset 508, any governing bodies 510 related to the asset, information regarding current trading mechanisms 512 for the asset, and the like.

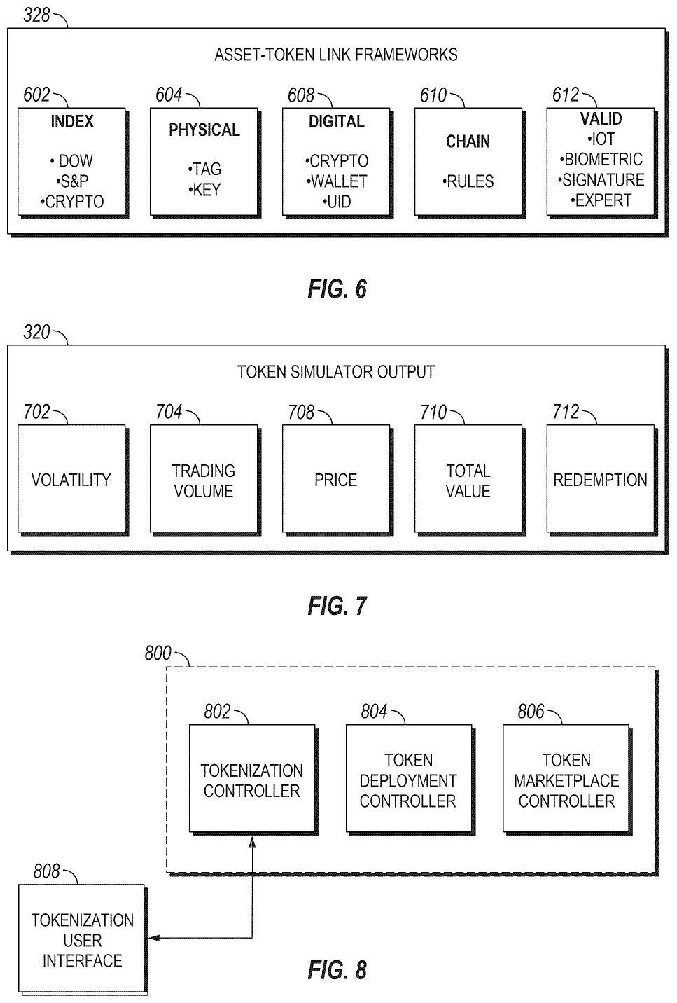

Referencing FIG. 6, an asset-token link framework profile interface 338 may allow a user to select different asset-token link frameworks 328 such as where the asset or token is traded on an index 602 (e.g. DOW, S&P, etc.), whether there is a physical linkage 604 such as an asset tags, whether there are digital linkages 608 between the asset and token such as a user ID, digital wallet, cryptographic linkage and the link. There may be data or rules about an associated block chain 610 and how the asset-token link is validated 612 (e.g. IoT sensors, biometric measurements, signatures, expert authentication, or the like).

An asset-token link framework profile interface 338 may allow a user (e.g., a token designer) to determine how a token will be linked to the asset class, such as through a cryptographic linkage (e.g., between a token and another digital item), through an orchestration system (such as where purchases, sales and other actions relating to the asset class are orchestrated to correspond to actions of tokens, and vice versa), through physical linkages 604 (such as through asset tags), through validation or authentication processes (such as involving sensors or cameras that record actions on the asset class), or combinations of these or other linking frameworks. In embodiments, a user may generate at least one asset class-linked token in response to a token link description and an asset class description. For example, a user may interface with the asset-class backed tokenization platform 200 and instruct the asset-class backed tokenization platform 200 to mint one or more value stream or asset class-backed tokens on a distributed ledger (e.g., blockchain 254).

A token simulator 312 may allow a token designer to simulate the market behavior of the proposed asset-class backed token 318, such as based on historical asset class behavior, historical token trading data, and a set of economic and/or tokenomics analytic models. A token simulator interface 340 may allow a designer to select token simulator parameters to be used by the token simulator 312 when simulating the market behavior of the proposed asset-class backed token 318. In embodiments, a token simulator 312 may simulate contributions of an underlying asset class to which a token is linked, as well as contributions of tokenization, such as the impact that additional liquidity, diminished cost of counterparty discovery (such as provided by automated market making), fractionalization (such as reduced transaction side that makes it possible for more entities to participate), reduced holding costs, increased security, rewards (such as for yield farming, mining, or the like), or other factors. This may be accomplished, for example, by analytical comparison of other similar tokens (such as based on various parameters of similarity, including parameters of tokenomics, parameters of the underlying asset class, and others) to the underlying asset classes to which they are linked or by which they are backed.

Referring to FIG. 7, token simulator output 320 may include predictions of token volatility 702, token trading volume 704, token price 708, total value 710, information regarding redemption applications 712 as described elsewhere herein, and the like. Redemption applications 712 may be indirect, such as where a token is linked merely by indexing to an underlying asset class or member thereof, optionally including embodiments where the token is a synthetic representation of a set of rights. In such cases, a smart contract may be defined that takes an index value for the asset class, or member thereof, and calculates a current redemption value of the token (which may be denominated in currency, cryptocurrency, other tokens, points, or other denomination). Upon a signal for redemption (such as in redemption application 712 or interface thereof), the smart contract may execute its calculation, determine the value, and send an instruction to the relevant entity (e.g., an account and/or payments system) to deliver the value to the redeeming user. The smart contract may similarly instruct that the token be “burned” or otherwise rendered unusable once redemption is complete. Redemption may be partial, such as where a portion of funds are delivered and the smart contract associated with the token sets a new value for future redemption(s). Redemption may also be direct, such as where a token represents or embodies access controls. For example, a token may be used to unlock access to a production facility, such as a 3D printer, such that the production of the printer is allocated to the token holder for a stated duration, stated number of units produced, or the like. This may be applied to various production types, such as energy production, materials, farm products, manufacturing lines and the like. As with other redemption, a smart contract may embody and govern redemption rules, such as by tracking incremental or partial redemption, and burning or rendering the token invalid upon complete redemption. Redemption may also trigger account changes, such as transfer of a token on a distributed ledger, in a wallet or the like.

A circuit, as used herein, should be understood broadly. In certain embodiments, components having terminology such as a controller, a component, an engine, a processor, or the like may be utilized instead of, and/or in conjunction with, a circuit, and accordingly those terms should be understood broadly with similar considerations to those presented with regard to circuits. Circuits, as used herein, include correlated aspects of the system configured to perform selected operations thereof, and can include logic gates, programmable logic circuits, interface devices (e.g., network communication devices and/or connecting hardware), I/O devices (e.g., user input devices such as a mouse, keyboard, touch screen, voice input, displays, etc.), any sensor utilized by the system, any actuator utilized by the system, processors or processing resources, computer readable memory, data stored in computer readable memory, data accessed by the system, API interfaces (e.g., to a marketplace, third party service, etc.), or the like. In certain embodiments, aspects of a circuit may be embodied as instructions stored on a computer readable memory configured such that a processor executing the instructions thereby performs one or more operations of the circuit. In certain embodiments, as will be understood in the context of particular descriptions herein, a circuit includes any one or more of these, and/or is in communication with any one or more of these. The present disclosure depicts each controller, circuit, component, engine, memory element, data structure, or the like, as a single device for clarity of the present description. A given controller, circuit, component, engine, memory element, data structure, or the like, may additionally or alternatively be distributed, in whole or part.

Referencing FIG. 8, an example system 800 for creating asset-linked tokens is schematically depicted. The example system 800 may be utilized with, included with, and/or include, in whole or part, any systems, assemblies, controllers, components, circuits, or the like, as set forth throughout the present disclosure, including at least the platforms and/or systems set forth in relation to FIGS. 1-3. Additionally or alternatively, the system 800 and/or aspects thereof, may be utilized to perform any methods, operations, and/or procedures set forth throughout the present disclosure. The example system 800 includes a tokenization controller 802 that implements a tokenization user interface 808, a token deployment controller 804 that implements asset-class backed token transactions, and a token marketplace controller 806 that implements an asset-class backed token trading system.

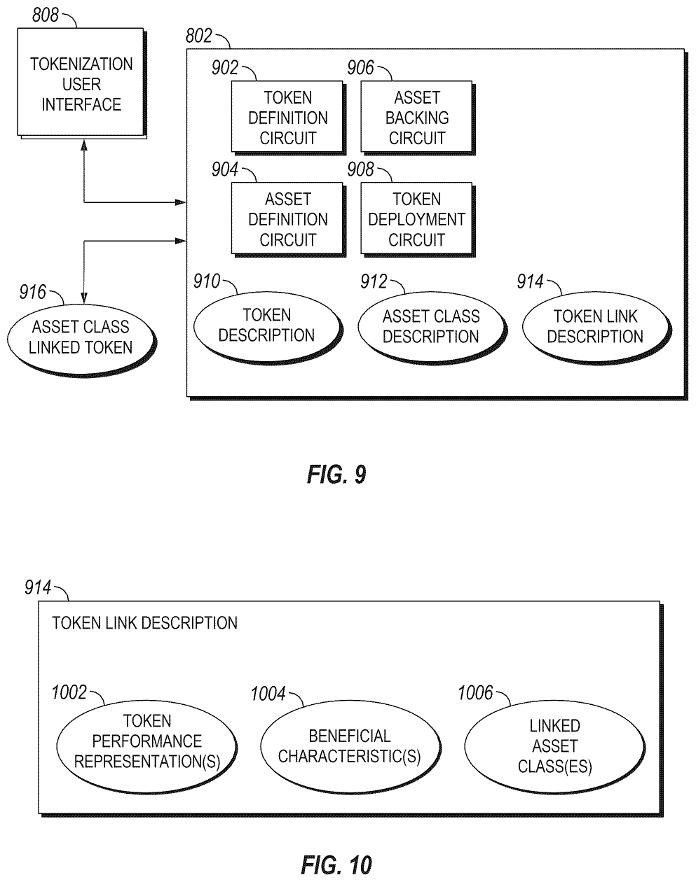

Referencing FIG. 9, an example tokenization controller 802 is schematically depicted. The example tokenization controller 802 includes a token definition circuit 902 that interprets a token description 910 in response to user operations with the tokenization user interface 808, an asset definition circuit 904 that interprets an asset class description 912 in response to user operations with the tokenization user interface 808, and an asset backing circuit 906 that interprets a token link description 914, including a token performance description corresponding to a beneficial characteristic of at least one asset corresponding to the asset class description 912. The example asset backing circuit 906 generates at least one asset class linked token 916 in response to the token link description 914 and the asset class description 912. In embodiments, the asset backing circuit 906 may be configured to invoke a minting function of a smart contract 250A stored on a distributed ledger, as described in more detail below, in order to generate the asset class linked token 916.

In certain embodiments, the token description 910 includes aspects of the token that are set by a user creating the token utilizing the tokenization user interface 808, for example including a name or identifier of the token, a description utilized with the token (e.g., on a marketplace), the purpose of the token, or the like. In certain embodiments, user selections for the token description 910 may be limited by the platform and/or tokenization user interface 808, for example to limit a maximum or minimum initial value for a token, to ensure that certain information about the token is available to potential purchasers (e.g., set by regulations, policies, an administering party for a platform, or the like), and/or may be limited to selections made available by an administering party for the platform (e.g., limited to certain types of assets, certain beneficial characteristics of assets, a limited total number of assets or asset types that can be linked to a token, etc.).

In certain embodiments, the asset class description 912 includes a description of the backing or linked asset, and/or available beneficial characteristics of the asset(s) that can be linked to the token. In certain embodiments, the beneficial characteristics of the asset(s) that can be linked to the token may depend upon the asset itself (e.g., a property based asset may allow linking to rental income, property taxes, and/or insurance collection for a property, where a precious metal based asset may allow linking to distinct characteristics, such as a value, volatility of value, production for a country, specific mine, the entire world, etc., an ore cut for a mine or region, etc.).

In certain embodiments, the token link description 914 includes the backing (or linked) assets or asset classes, amounts of the assets, which beneficial characteristic of the asset(s) are linked to the tokens, and the like. In certain embodiments, the token link description 914 further includes rules governing the token, for example threshold values related to the beneficial characteristics being utilized (e.g., where the performance of the token is modulated based on external factors such as inflation, production capacity, news events, crop yields, elapsed time since the token was created, first acquired, last traded, etc., or the like), and/or changes to the asset-token linkages in response to whichever factors are selected. In certain embodiments, the backing (or link) between the asset (and/or asset class) and the token may be a hard link—for example where the token performance follows the beneficial characteristic of the asset or asset class due to a hard constraint (e.g., ownership of the token is linked to a specific amount of the underlying asset) and/or due to a specific rule (e.g., the performance of the token is guaranteed—for example with another linked token that changes value in response to a failure of the original token performance to strictly follow the beneficial characteristic). In certain embodiments, the backing (or link) between the asset or asset class and the token may be a soft link—for example where the token link and/or rules are configured such that the token performance is expected to follow the beneficial characteristic, but the token performance may not necessarily match that performance in actual practice. For example, a token linked to the value of an amount of gold may instead be linked to a basket of other precious metals or other assets which tend to follow the price of gold, but which may not precisely follow the price of gold in practice. The nature of the token link description 914 may be indicated with the asset class linked token 916 or not, for example depending upon applicable regulations, policy decisions from an administrator of the platform, selections by the user creating the token, or the like. For example, a published asset linked token 1108 presented for offer on a marketplace may include information about which assets or asset classes are linked to the token, whether the link is a hard or constrained link, or a soft link, and what rules are applicable to the token to enforce the link to the asset or asset class, including which thresholds, data, or events apply to the token, and/or how the link is expected or scheduled to change over time (e.g., for a token with characteristics such as value tracking, volatility tracking, risk tracking, etc., that change in a known or planned manner over time, with respect to certain events or metrics, or the like). In certain embodiments, the token link description 914 associates specific assets and/or asset classes with the token—for example, a revenue stream of a particular farm or hotel, which may also change over time (e.g., switching which farms are linked based on season, etc.). In certain embodiments, the token link description 914 does not associate specific assets with the token—for example, a token backed by a fungible asset, an asset class, and/or a token linked to a derivative asset (e.g., a basket of farms, intellectual property, or the like). In certain embodiments, the token link description 914 is exhaustible in whole or part, for example with an asset that is consumable in fact (e.g., a consumable asset such as a specific stored crop, oil, or the like) and/or consumable in a logical sense (e.g., an intellectual property asset allowing for a specific number of uses, a number of users, a number of installations, etc.). In certain embodiments, the token link description 914 is associated with a number of assets or asset classes that may change over time, for example a token representing a group of subscriptions (and/or a revenue stream of the subscriptions), a number of license seats, or the like.

Referencing FIG. 10, an example token link description 914 is schematically depicted. The example token link description 914 includes a token performance representation 1002 corresponding to a beneficial characteristic 1004 of a linked asset 1006. The linked asset 1006 may any type of asset including, without limitation, any type of asset as set forth throughout the present disclosure. Example and non-limiting linked asset(s) 1006 include: a precious metal asset (e.g., gold, silver, platinum, a precious metal index, and/or a combination of metals); an asset pre-cursor (e.g., a planted crop, revenue stream for an asset under construction, produced ore from a mine before processing, etc.); a fiat currency (e.g., a sovereign currency based asset); a real estate asset (e.g., a property, revenue associated with a property, residual value from a sale or disposition of a property, profits from a real estate investment trust, etc.); a financial asset (e.g., a financial instrument, a contract and/or revenue associated with a contract, and/or a dividend associated with a security or other financial instrument); a security asset (e.g., a secured instrument such as a stock, bond, or associated benefit or revenue therefrom); an intellectual property asset (e.g., revenue associated with an element of IP such as a copyrighted work, a group of subscriptions and/or revenue therefrom, a right to utilize an IP element, such as a copyrighted work, manufacturing instruction set, or the like, etc.); a production asset (e.g., a crop from a farm, an output of a manufacturing facility, and/or revenue generated therefrom); a beneficiary asset of any one or more of the foregoing (e.g., a contingent or residual right to any of these, for example based upon the occurrence of certain events, elapsed time, or the like); and/or a derivative asset of any one or more of the foregoing (e.g., a packaged and/or securitized version of any of the foregoing, such as a share of revenue from a group of manufacturing facilities, manufactured assets under a certain license, etc.). In certain embodiments, a linked asset 1006 may be a combination of these—for example, a share of license revenue from an IP license to manufacture a specific object, combined with a license to manufacture a set number of units of the specific object. In certain embodiments, combined assets may be of a similar nature—for example, a revenue share associated with licensed seeds as well as a harvested crop revenue for a particular farm, or of a dissimilar nature—for example an asset (or asset class) linked to a precious metal asset combined with an asset linked to a dividend from a particular stock. The utilization of similar and/or dissimilar assets linked to and/or backing a token allows for separate tuning of the token performance representation 1002 from the beneficial characteristics 1004—for example allowing the asset class linked token 916 to follow the value of an asset with lower volatility, with leveraged (or deleveraged) movement of the value, or the like. In certain embodiments, the utilization of multiple linked assets 1006 allows for generation of tokens that have specific selected responses to events, such as a weather event occurring that may affect a crop, housing prices, or the like, that may be relevant to particular users or classes of users, and that are not linked in the general economic system.

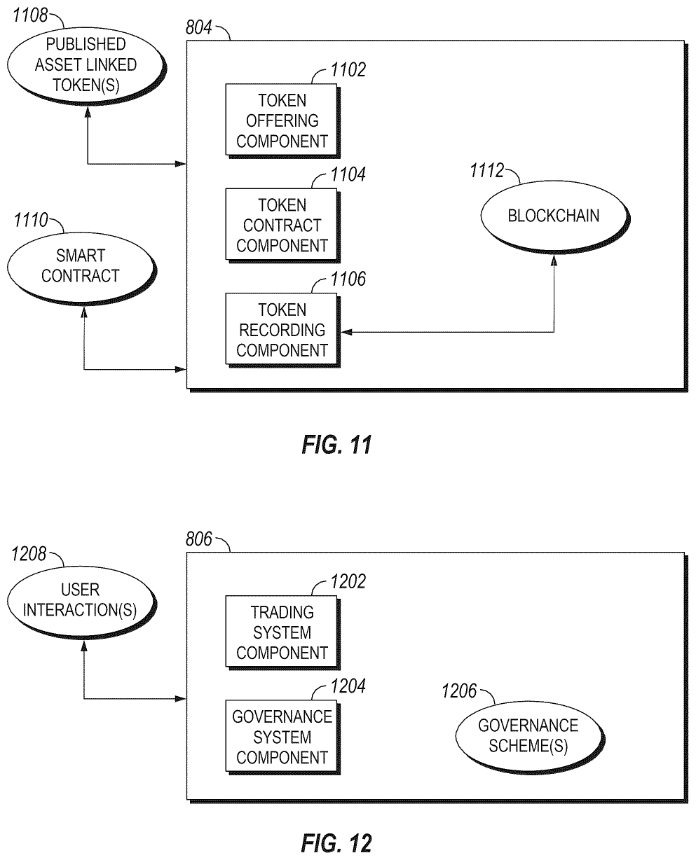

Referencing FIG. 11, an example token deployment controller 804 is schematically depicted. The example token deployment controller 804 includes a token offering component 1102 that publishes the exposed asset class linked token(s), for example based on the asset class linked token 916 exposed (e.g., minted on a distributed ledger) by the token deployment circuit 908, and provided as a published asset class linked token 1108 (e.g., a token minted on a distributed ledger), to a token marketplace system (e.g., operated by the token marketplace controller 806). In certain embodiments, the asset class linked token 916 is published upon creation, where operations of the token deployment controller 804 are performed by the token deployment circuit 908. In certain embodiments, for example where an administrator of the token marketplace chooses to verify and/or otherwise approve tokens before they are published, and/or where publication control is provided to allow the user to offer an asset class linked token 916 to only some users and/or to a selected group of users, the token offering component 1102 performs the publication of the asset class linked token(s) 1108. The published asset class linked token(s) 1108 may be listed on an interface, for example a market operated on a website, web portal, mobile application, or the like, and/or the published asset class linked token(s) 1108 may be recorded on a blockchain 1112 or other ownership and/or transfer recordal system, thereby being made available to users having access to the market and/or blockchain 1112. In embodiments, the example token deployment controller 804 includes a token contract component 1104 that executes a smart contract 1110 to acquire the published asset class linked token(s) 1108—for example in response to user selections to acquire the published asset class linked token(s) 1108, and/or in response to user rules set up to automatically acquire tokens having certain characteristics (e.g., price, expected value, volatility description(s), liquidity description(s), etc.). In certain embodiments, the smart contract 1110 performs in any manner as set forth throughout the present disclosure, including binding the parties (e.g., the creator and/or previous owner of the token, and the acquirer of the token) to the terms and conditions related to the token. The terms and conditions related to the token may be created as a part of the token description 910, and/or according to terms applied by an administrator of the token marketplace. The example token deployment controller 804 includes a token recording component 1106 that records transactions of the published token(s) 1108 in response to the executed smart contract 1110, for example by appending the transaction onto the blockchain 1112, recording the transaction in a secured database, or the like. In certain embodiments, for example where transactions are not executed using a smart contract 1110, the operations of the token recording component 1106 are performed in response to a received indication that a transaction has occurred, for example based on a notification or transaction value received from the token marketplace controller 806 in response to user operations of token creators, buyers, and/or sellers.

In embodiments the token deployment controller 804 may deploy a token (or set of tokens) with a set of robotic deployment agents, such as using automated market maker (AMM) capabilities, such as by pairing a token with another form of token (e.g., a cryptocurrency or digital currency) using a constant product trading function. As noted elsewhere in this disclosure, counterparty discovery can be a challenge in transactions, imposing a transaction cost that impedes development of a robust market that enables parties to gain through mutually beneficial exchanges. This may be particularly true in the case of markets for new or unfamiliar items, such as new tokens described in various embodiments described herein. To enable such thin or novel markets, or for other reasons, a set of algorithmic automated market making services or capabilities (e.g., as provided by AMM 2350 and/or RDA system 2352, as described in further detail below) may be used in various embodiments described herein, by which a set of automated, robotic agents may facilitate trading in assets (such as, in embodiments, a set of asset stream-backed tokens that may be designed by a token designer). Thus, in embodiments, as noted above, a transaction platform as described herein may include a set of automated market maker (AMM) services or capabilities 2350 by which a set of automated robotic agents may provide liquidity or otherwise facilitate trading for a set of assets. The set of automated market maker capabilities 2350/2352 may, in embodiments, be partially or fully implemented in the asset stream-backed tokenization platform (e.g., as RDA system 2352), such as to allow a token designer to design, configure and deploy automated market making for a set of tokens. The RDA services 2352 may be driven by artificial intelligence, such as a set of AI services that are used to discover, design, and/or configure an appropriate set of automated market maker capabilities 2350 for a given situation, such as one that provides a desired amount of liquidity, a desired risk profile, a profile of utilization of liquidity, a desired capital efficiency for deposited liquidity or committed collateral, or the like. Such AI services may be trained on a training data set, such as of human design actions or a training data set of outcomes from deployment of automated market makers. As with other capabilities, automated market making services 2350 may be simulated in the simulation capabilities of the asset stream-backed tokenization platform.

In embodiments a set of automated market making services 2350 may access a set of liquidity pools, which may include a set of assets (such as cryptocurrencies, digital currencies, or other asset streams noted throughout this disclosure) that can be used for trading. The assets or collections thereof may be discovered by web search, crowdsourcing, or other mechanisms, including by providing targeted offers to holders of assets based on inspection of public blockchain information, public wallet information, or the like. Target offers may include smart contract mechanisms under which a set of liquidity providers can deposit assets into a set of liquidity pools in exchange for a given set of incentives or consideration, or yield, such as a share of trading fees generated by an automated market maker, or the like.

In embodiments, the automated market maker services 2350 can be structured such that prices automatically adjust based on demand for a token, such as in embodiments of a token set that is designed by the token designer in the case of an asset class-backed token. The token designer may select any of a variety of automated market maker models, including based on a simulation or modeling of the behavior of the respective models that includes inputs on the underlying asset classes or streams to which a token is linked or by which it is backed. Such embodiments may include use of a constant function market maker (CFMM) where the automated market maker 2350 is configured based on a constant function such that the combined asset reserves of a set of trading pairs on an exchange must remain unchanged (such as a trading pair of a token designed by a designer and another token, such as a cryptocurrency or digital currency). In embodiments, user deposits may be held by a custodian, or user deposits may be held within a smart contract that a trader can use for liquidity, such as for trading tokens. In non-custodial embodiments, users can undertake trading via the smart contract with a liquidity pool, rather than having to discover a specific counterparty.

CFMMs may include one or more of constant product market maker (CPMM), a constant sum market maker (CSMM), a constant mean market maker (CMMM) (where the weighted geometric mean of each liquidity pool is kept constant), or the like. While each of these known approaches to automated market making will enable market making, there are challenges with each of these models; for example, the constant sum market maker can lead to arbitrage and draining of the liquidity pool if there are differences in market prices for the traded assets. These models of automated market making have also been criticized for issues with impermanent loss (where more would have been earned by just holding an asset rather than staking it to a liquidity pool) and low capital efficiency (such as due to the absence of control as to what price points are offered to traders, in contrast to traditional exchanges where order book operators can set prices precisely to make efficient use of available liquidity), among others.

In embodiments more advanced forms of automated market makers can be used, including in connection with design and deployment of a set of asset stream-backed tokens using the token design platform described herein. This may include a set of one or more of hybrid automated market makers, dynamic automated market makers, proactive market makers, and/or virtual automated market makers. Such embodiments may include use of an advanced hybrid constant function market maker that combines a plurality of functions and configuration parameters that allow a degree of configuration of risk exposure, a degree of adjustment for price impacts, or the like. One known example, the stableswap invariant, deploys a constant product market maker and a constant sum market maker that provides greater use of liquidity at mid-range prices (while more conventional market makers tend to use liquidity most effectively only at price extremes). Another known variant is the dynamic automated market maker (DAMM), uses feeds of pricing information and volatility data from public sources (such as a price feed, oracle or the like) to dynamically distribute liquidity to different points on the price curve, thereby making it adaptive to varying market conditions. For example, liquidity can be concentrated during periods of low volatility and expanded during periods of high volatility to improve liquidity pool capital efficiency. In embodiments, a proactive market maker (PMM) may be used, where the market maker seeks to mimic human market-making behavior based on input data on price feeds, such as seeking to increase liquidity in proximity to the current market price, thereby improving capital efficiency. In embodiments, a proactive market maker may be trained, based on a training data set of human market-making activities and on outcomes from market-making activity, to effectively replicate human market-making activity for a given asset class. In other embodiments, a set of virtual automated market makers (VAMM) may be used, such as the existing perpetual protocol. These may use a constant product market maker formula, but rather than using a liquidity pool, collateral is deposited to a smart contract (subjecting the collateral to risk of liquidation in the case of large price movements) and synthetic assets are traded rather than the underlying token. These and other types of advanced automated market makers should be understood to be encompassed by the set of automated market making services and capabilities 2350 that may be included in, integrated with or linked to the transaction platforms and systems described throughout this disclosure. In embodiments, the selection of a particular market making model 2350 can be selected based on the characteristics of the underlying asset class in the case of an asset-class linked token and/or can be selected based on the trading characteristics of the pair (or larger set) of tokens that may include one or more asset-class linked tokens and one or more other tokens that are linked by the algorithmic market making function. Selection may be based on analytics of trading volume, trading velocity, yield (including at different points on a price curve of an exchange), capital efficiency, and other metrics. In embodiments, an intelligent agent (e.g., as provided by RDA system 2352) may be trained to select appropriate token pairs, appropriate market making functions and/or appropriate configuration parameters for market making functions, such as on a training data set of human selections and/or by supervised, semi-supervised, or deep learning on a set of market making outcomes.

Referencing FIG. 12, an example token marketplace controller 806 is schematically depicted. The example token marketplace controller 806 includes a trading system component 1202 that makes the published asset class linked tokens 1108 available to at least a portion of users of the asset-class backed token trading system 800, for example all users, selected users (e.g., positively selected users, users associated with a particular entity, users associated with a particular sub-market of the marketplace, etc.), and/or a rule-based selection of users (e.g., users meeting a certain asset threshold, subscribing users, users performing certain searches such as using certain keywords in a search, and/or users that have performed transactions for certain types of tokens and/or related to certain types of assets or asset classes). The example trading system component 1202 further accepts user inputs for transactions (e.g., as user interactions 1208) of the published asset class linked tokens 1108, including at least user interactions 1208 to search for tokens, to access tokens, to make tokens available for discovery and/or trading, to offer tokens for trading, and/or to purchase tokens.

The example token marketplace controller 806 includes a governance system component 1204 that performs operations to support governance scheme(s) 1206 for the asset class linked tokens 1108, including operations that may regulate aspects of generating the tokens, publishing the tokens, offering the tokens, purchasing the tokens, and/or maintaining the tokens. The governance scheme(s) 1206 may include regulatory components (e.g., with respect to applicable laws for the tokens and/or entities offering and/or purchasing tokens), policy components (e.g., to ensure that policies by offering parties, transacting parties, an administrator of the token marketplace, and/or an administrator of assets or asset classes linked to tokens—such as a listing company, exchange, or the like) that are to be implemented and/or maintained with respect to the tokens. In certain embodiments, the applicable governance scheme(s) 1206 may depend, in whole or part, on the mix of assets or asset classes linked to a particular token, on the nature of an entity offering and/or purchasing a token (e.g., size, investor class, indicated preferences, certifications, etc.), on a jurisdictional location of an aspect of the marketplace or transaction (e.g., a location of an administrator of the marketplace, a location of a server of the marketplace, a location of an offering entity, a location of a purchasing entity, and/or a location of a linked asset and/or asset class). As the linking of a particular token can change over time, and as relevant parties to the token may change over time (e.g., due to transactions of the token, and/or changes in the relevant party away from the marketplace, such as in a sale or merger of an entity), the relevant governance scheme(s) 1206 for a token may also change over time. In certain embodiments, the governance system component 1204 performs one or more operations such as: adjusting the token link description 914 in response to the governance scheme 1206 associated with the asset class description 912, and/or confirming the token link description 914 (e.g., confirmation that attributes and descriptions of the token remain compliant, and/or confirming that appropriate notifications, acknowledgments, or the like have been completed). In certain embodiments, the governance system component 1204 may provide notifications to entities, remove tokens from listing or publication, and/or operate user interfaces to provide governance information to users, and/or to get acknowledgements from users, in response to the applicable governance scheme 1206 and/or changes to the token, relevant entities, transactions with the token, and/or changes to the governance scheme 1206 itself (e.g., changes in regulations, laws, policies, or the like). In certain embodiments, changes to the token—for example which assets or asset classes are linked, and the mix thereof, may also involve operations of the governance system component 1204 to ensure that the token, marketplace, and users of the marketplace, remain compliant with the applicable governance scheme 1206.

The terms asset-class backed token, asset-class backed token, asset class-backed token, and/or asset class-linked token, as used herein, should be understood broadly. Tokens of the present disclosure are cryptographically secure elements that can be held, traded, or otherwise exercised as a digital property. Tokens may be managed, held, and/or traded using any secure digital backbone for managing ownership and access, for example using digital certificates or a blockchain for recording transactions. In certain embodiments, a token may represent a single unit of ownership, ownership of multiple units, and/or ownership of share of a unit. Without limitation to any other aspect of the present disclosure, a token as utilized herein operates in a similar manner to a cryptocurrency asset, may be a cryptocurrency asset, and/or may include one or more cryptocurrency assets as a part, or all, of the assets or asset classes backing the token and/or linked with the token. An asset class linked token may be referenced as an asset-class backed token, an asset class backed token, an asset linked token, and/or other similar terminology herein. An asset class linked token represents and/or is linked with a beneficial characteristic of another asset, or a class of assets, that is distinct from the token itself. For example, an asset class linked token may be generated to follow the risk profile, volatility, liquidity, value trajectory, value offset profile (e.g., relative to inflation or another dynamic indicator), or the like, of a particular asset (e.g., an identifiable asset such as a particular farm, production facility, or the like) or an asset class (e.g., gold, soybeans, oil, real estate in California, real estate in downtown Manhattan, net income for a basket of companies in a particular industry, etc.). In certain embodiments, even where an identifiable asset is linked to the asset class linked token, the identifiable assets may be changed over time—for example due to operations of linking rules for the token over time and/or in response to certain events.

The term beneficial characteristic, as utilized herein, should be understood broadly. A beneficial characteristic is a characteristic that is dependent upon the underlying asset. Thus, a token that has a performance (e.g., as a token performance representation) corresponding to the beneficial characteristic of an asset (and/or asset class) is a token created to have a performance that follows, in some sense, the performance of that characteristic of the asset and/or asset class. For example, if the beneficial characteristic of the asset is the asset value, a token created to have a performance linked to that beneficial characteristic will have a value that follows the asset value. In certain embodiments, a token may have a performance corresponding to more than one beneficial characteristic of an asset or asset class (e.g., an asset value, asset volatility, asset liquidity, etc.), and/or corresponding to one or more beneficial characteristics of more than one asset or asset class (e.g., a token having a performance corresponding to a value of an amount of a gold asset, and further corresponding to a revenue stream of a production asset). Without limitation to any other aspect of the present disclosure, a performance that corresponds to a beneficial characteristic may be a performance that matches the beneficial characteristic (e.g., if the linked asset doubles in value, then the token doubles in value), and/or that has a selected function relative to the beneficial characteristic (e.g., that is scaled relative to the beneficial characteristic, such as 1.5×, 2×, 0.5×, etc.; that is offset relative to the beneficial characteristic, such as x+0.5, x−1.0, etc.; and/or that has a more complex relationship to the beneficial characteristic, such as matching, scaling, and/or offsetting from the beneficial characteristic depending upon the value or performance of the beneficial characteristic itself—for example matching value returns up to 5%, and utilizing a different function such as doubling returns or halving returns above 5%, for example by adjusting a leveraging of the token based on the value returns, and which may be performed for any reason such as limiting losses, maximizing gains, adjusting volatility, or the like). In certain embodiments, a token may have a performance that corresponds to a number of beneficial characteristics in any manner, for example having fractionated performance (e.g., 25% like beneficial characteristic A, and 75% like beneficial characteristic B), priority based performance (e.g., following beneficial characteristic A under certain conditions, and following beneficial characteristic B under other conditions), and/or a weighted or cost-based performance (e.g., using a scoring function with regard to beneficial characteristic A, another scoring function with regard to beneficial characteristic B, where the token performance is tuned to maximize, incrementally improve, and/or enforce thresholds for the overall score value from the scoring functions).

Embodiments herein can thereby be utilized to tune the performance of a token based on underlying asset classes that have independent value, creating a token that has the selected performance characteristics based on the selected characteristics of the underlying asset(s), with ownership and trading of the token grounding the performance to give the user leverage to exercise the benefits of the token for the selected purpose. Embodiments herein allow for token creators, holders, and traders, to perform numerous real-world operations that cannot be done utilizing previously known instruments. For example, a token may be configured to follow the value of a first asset, and to emulate the volatility of a second asset. In another example, a token may be configured to trade a value related to an asset that is not tradeable in previously known systems, for example to trade on a portion of a revenue stream from an asset, or a more complex operation such as trading on a selectable portion of the revenue stream, such as amounts of the revenue stream exceeding a static (e.g., amounts exceeding $1,000,000 per year) or dynamic (e.g., amounts exceeding 8% net profit) threshold of the revenue stream of an asset. Embodiments herein also provide for a convenient interface to create and execute such tokens, where similar options for attaching to and/or following an aspect of an asset would previously require complex and highly specialized agreements between multiple parties to execute similar capability. Embodiments herein also provide for enhanced liquidity, allowing for parties to engage and trade in otherwise complex arrangements without having to negotiate terms of agreement, and allowing numerous parties, including potentially any party having access to a trading marketplace for asset class linked tokens, to trade assets with a low burden of entry, reduced cost of creating and maintaining arrangements, and/or improving liquidity of tokens by facilitating the creation, publication, and transactions of the tokens). Embodiments herein provide technical tools that allow for configured arrangements that can facilitate the creation and execution of projects, investments, and/or trading arrangements that would otherwise be unavailable due to a lack of previously available tools to manage risks, distribute investments throughout a sufficiently sized investor pool, and/or provide sufficient protection and transparency for returns on investment for those projects, investments, and/or trading arrangements.

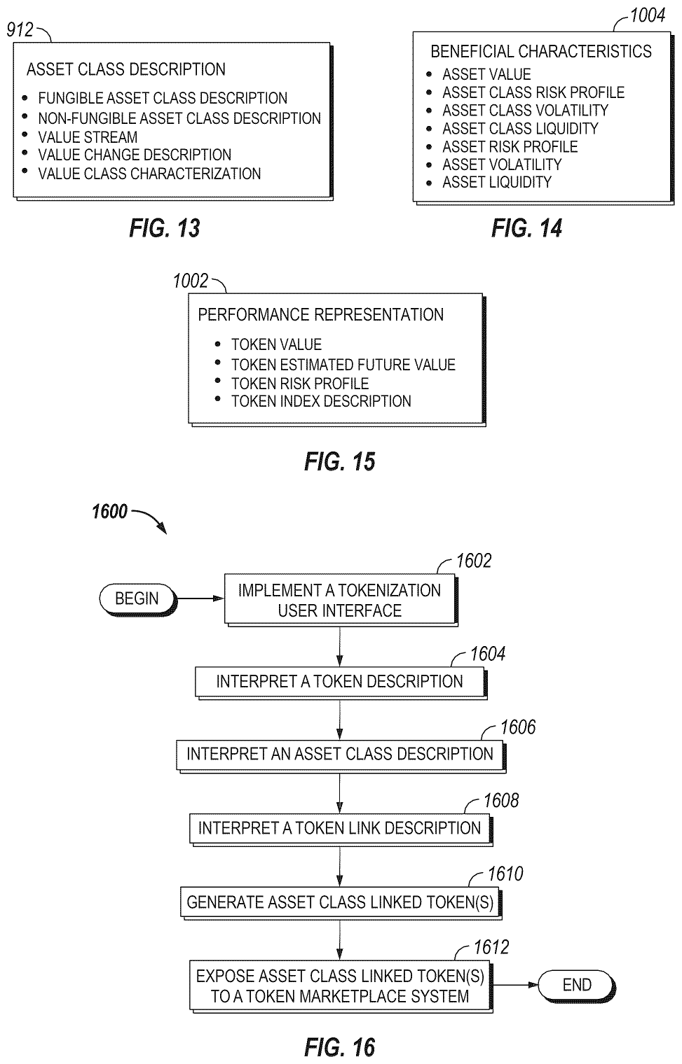

Referencing FIG. 13, an example asset class description 912 is schematically depicted. The asset class description 912 may be determined in response to user entries on a tokenization user interface 808, and/or may further be determined in response to default values, values determined according to a governance scheme 1206, preferences indicated generally by a user, and/or values determined according to rules set by an administrator of the tokenization controller 802. In certain embodiments, the type of assets or asset classes in the asset class description 912 may be utilized to adjust or constrain any of these (e.g., listing a particular asset or asset class may invoke a set of default values, rules, etc.). The asset class description 912 may be stored in a data structure, including potentially in a blockchain (e.g., the same or a distinct blockchain from one utilized to record transactions of tokens, such as blockchain 1112), or the like. In certain embodiments, the asset class description 912 may be stored locally (e.g., on a user device that is performing operations to generate a token), and/or may not be stored, for example where the asset class description 912 is created and utilized for a published asset class linked token 1108 in a single workflow, where the asset class description 912 is utilized to generate a token and then discarded. In certain embodiments, an asset class description 912 or portions thereof may be stored, for example to support generating a token over multiple sessions, and/or to re-use all or a portion of an asset class description 912 for later use in generating another token using the same asset or asset class. The example asset class description 912 includes a fungible asset description (e.g., for assets or asset classes based on fungible assets), a non-fungible asset description (e.g., for assets or asset classes based on non-fungible and/or identifiable assets), a value stream (e.g., allowing linking of tokens to a revenue stream, capitalization associated with an asset-which may vary over time, or the like), a value change description (e.g., allowing linking of tokens to changes in an asset value relative to a baseline, whether the asset value is a total value or a value stream), and/or a value class characterization (e.g., allowing linking of tokens to a rating or quality of an asset or asset class, to a compliance with requirements for the asset or asset class; for example compliance requirements may relate to storage, maintenance, inspections, location, security, etc., where failure to meet compliance and/or results of compliance performance, such as inspection results, may affect the value of the asset or asset class).

Referencing FIG. 14, an example beneficial characteristic 1004 is schematically depicted. The example beneficial characteristic 1004 allows for a token, in whole or part, to have a dependency upon a selected characteristic of linked assets or asset classes. Example and non-limiting beneficial characteristics 1004 include one or more of: an asset value, an asset risk profile, an asset volatility (e.g., the tendency for value changes and/or value change fluctuations within a selected time period, and/or statistical descriptions of these, which may be determined against any value dimension of the asset or asset class, such as sale value, collateral value, revenue stream value, or the like), an asset liquidity (e.g., a description of how likely the underlying asset or asset class can be sold, purchased, or the like, including a time factor-how long a transaction is expected to take, a pricing factor—how much variability in price may be expected relative to a market price, a market size factor—e.g., how many potential sellers and/or purchasers are likely to be available, and/or which may further include a function of these with respect to a volume, for example a token that is likely to involve 10,000 units of an asset may have a different liquidity characteristic than a token that is likely to involve 1,000 units of that same asset). In certain embodiments, the beneficial characteristic 1004 may depend upon the entity that is generating the token, for example an entity that is a primary producer of an asset class (e.g., a precious metal mining company) generating a token that is linked to a large quantity of a precious metal asset may be expected to have a different effect on the market (e.g., reflected as an adjustment to the asset value, volatility, liquidity, etc.) than another entity that is a primary consumer of the asset class (e.g., a high grade electrical connector company). In certain embodiments, the token performance representation 1002 (e.g., reference FIG. 15) associated with the token may reflect the target offeror and/or acquirer for a token, for example with a performance of the token tuned for a particular type of holder for the token. In certain embodiments, a beneficial characteristic 1004 may additionally or alternatively include an asset class value, asset class risk profile, asset class volatility, and/or asset class liquidity.

Referencing FIG. 15, an example token performance representation 1002 is schematically depicted. In certain embodiments, the token performance representation 1002 reflects the intended performance of the token (e.g., 8% rate of return, XX volatility index, YY liquidity index, etc.). In certain embodiments, the token performance representation 1002 reflects the expected performance of the token. In certain embodiments, a user interacting with the tokenization user interface 808 utilizes both of these—for example setting intended performance values for the token and adjusting the asset class description 912 and/or beneficial characteristics 1004 of linked assets until the expected performance of the token matches, or is sufficiently close, to the intended performance values. In certain embodiments, the tokenization controller 802 populates recommended assets and/or asset classes based on the intended performance for the token, making it convenient for a user to adjust the linking mix of assets and/or asset classes to achieve the intended performance. In certain embodiments, the token performance representation 1002 is utilized to adjust (e.g., by the asset backing circuit 906) the asset/asset class linking mix after the token is generated, published, and/or traded, for example according to rules as described throughout the present disclosure. Example and non-limiting aspects of the token performance representation 1002 include one or more of: a token value (e.g., a value of the token, a value progression of the token, and/or a value description such as a rate of return, net present value, etc.), a token estimated future value (e.g., any of the value parameters at a selected future time, over a selected range of future times, a perpetual value progression target, etc.), a token risk profile (e.g., relative to any selected risk, such as a volatility risk, liquidity risk, total value loss risk, risk relative to a threshold value such as a minimum rate of return, minimum value, etc.), and/or a token index description (e.g., a token that tracks a present or future mix of assets, a present or future scoring parameter such as a mix of investment return, liquidity, volatility, etc., and/or a token that changes performance targets over time, and/or in response to events, in a selected manner, such as: having a first return/risk profile at a first time, and a second return/risk profile at a later time; having a first return/risk profile before a first event such as a weather incident, start of production for a facility, or the like, and a second return/risk profile after the event; a token linked to a first asset class mix at a first time and linked to a second asset class mix at a second time; and/or trajectories of these).

Referencing FIG. 16, an example procedure 1600 to generate an asset class-linked token is schematically depicted. Operations of the procedure 1600 may be performed by any components, controllers, circuits, or the like as set forth herein, including at least components of the platform set forth in relation to FIGS. 1-3, and the controllers set forth in relation to FIGS. 8-9 and 11-12. The example procedure 1600 includes an operation 1602 to implement a tokenization user interface, an operation 1604 to interpret a token description, an operation 1606 to interpret an asset class description, and an operation 1608 to interpret a token link description. The example procedure 1600 further includes an operation 1610 to generate an asset linked token(s) in response to the token description, the asset class description, and/or the token link description. The example procedure 1600 further includes an operation 1612 to expose the asset linked token(s) to a token marketplace system, which may be published (e.g., offered) for trading on the token marketplace system.

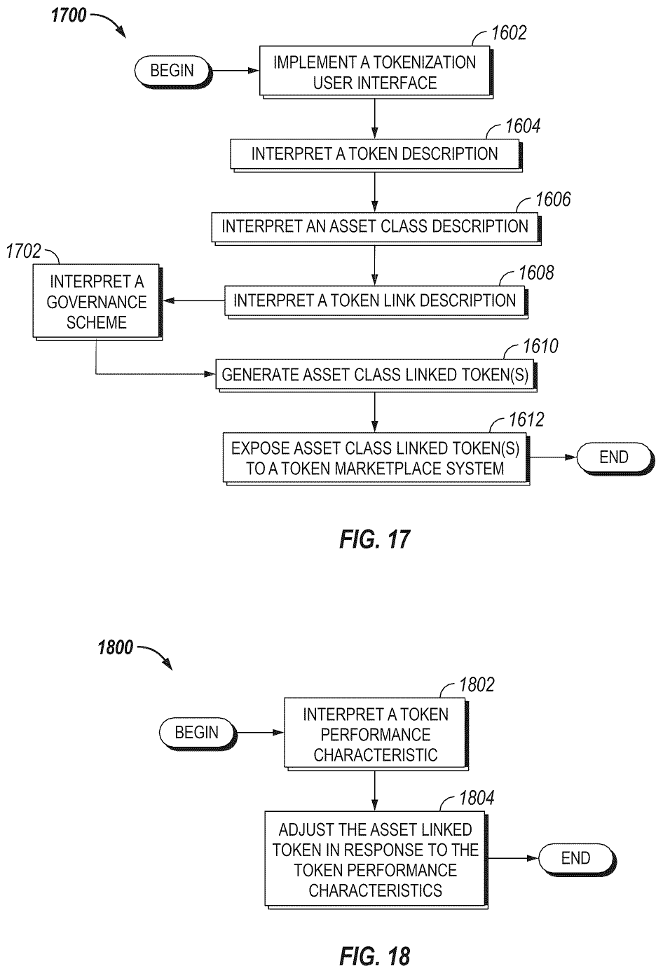

Referencing FIG. 17, an example procedure 1700 for generating an asset linked token is schematically depicted. The example procedure 1700 is similar to procedure 1600, but further includes operations to implement a governance scheme for asset linked tokens. The example procedure 1700 includes an operation 1702 to interpret a governance scheme, where operation 1610 to generate the asset linked token(s) is further performed in response to the governance scheme—for example ensuring that the generated token is compliant with the governance scheme, and/or includes linking rules to enforce the governance scheme over the life cycle of the token.

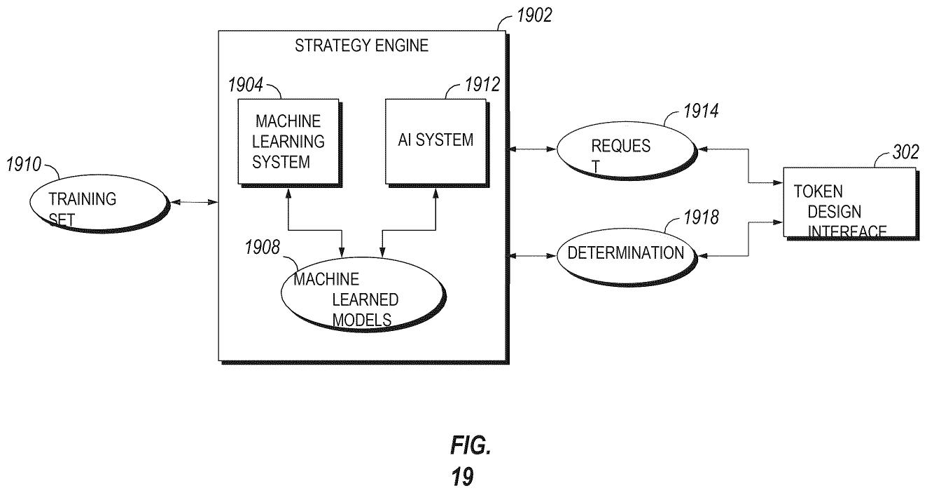

Referencing FIG. 18, an example procedure 1800 to adjust an asset linked token is schematically depicted. Operations for procedure 1800 may be performed in relation to generated tokens, published tokens, and/or tokens that are already held by acquiring entities, for example through operations with the token marketplace. The example procedure 1800 includes an operation 1802 to interpret a token performance characteristic, and an operation 1804 to adjust the asset linked token (e.g., adjusting a mix of linked assets or asset classes) in response to the token performance characteristics.

### Strategy Engine Process

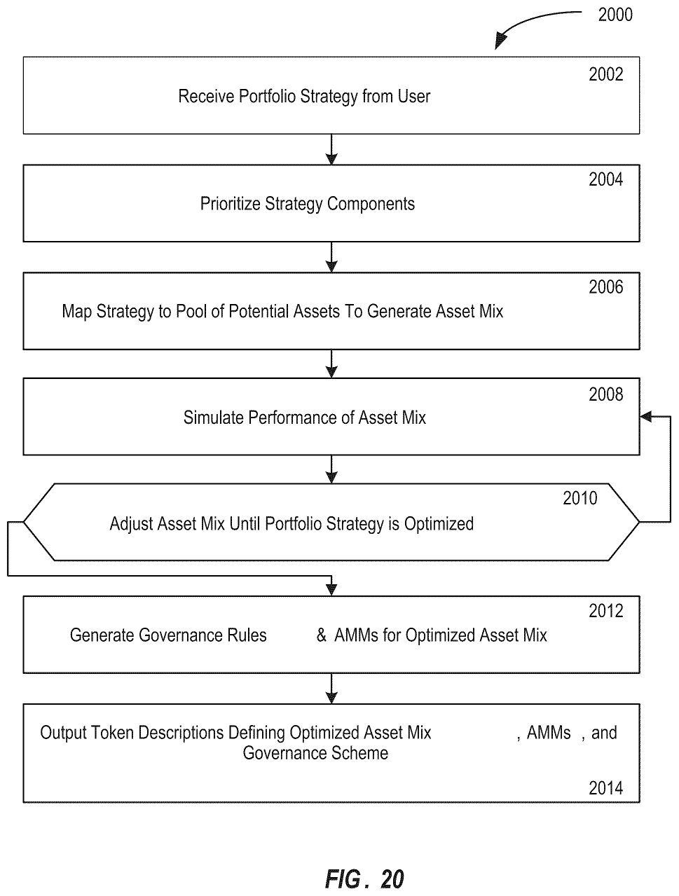

FIG. 20 illustrates a method 2000 for designing and/or testing a token strategy that may be executed by the strategy engine 1902. At 2002, the strategy engine 1902 may receive a strategy for a token or collection of tokens from a device associated with a user. The user may be an individual, business, group of businesses, group of individuals, or any other entity that may wish to design a strategy for one or more asset class-backed tokens. In some embodiments, the user may wish to generate asset class-backed token(s) that the user will purchase such that the user will own or have rights to the portfolio of assets after purchasing the asset class-backed token(s). In these embodiments, the user may wish to design a portfolio of asset class-backed tokens that align with the user's objectives (e.g., investing objectives, business objectives). Additionally or alternatively, the user may wish to generate asset class-backed token(s) backed (at least in part) by assets that are owned or managed by the user such that the asset-class backed tokens may be sold to other users. For example, the owner may own a first group of assets and may wish to design a strategy for generating and selling asset class-backed tokens that are backed by the first class of assets and/or other assets in order to raise capital.

In embodiments, the strategy engine 1902 may use an AI component such as a language model (e.g., a large language model) to assist a user in designing one or more goals or strategy inputs. For example, an AI chat bot may ask a user various questions about their objectives (e.g., a preset list of question and/or questions generated on the fly in response to user responses) and use the user response generate strategy inputs that align with the user responses (e.g., a list of asset performance attributes). Additionally or alternatively, the AI chat bot may summarize strategy inputs for user review and/or editing, make changes based on user feedback, and/or the like. Additionally or alternatively, the AI component may assist the user in understanding various mechanics of asset class-backed tokens, for example by answering questions that users have about the operation of the asset class-backed tokens, the various assets, various simulations performed by the strategy engine, and/or the like. In embodiments, the machine learning system 1904 and/or AI system 1912 may implement a language model, which may be a commercial language model, open-source language model, fine-tuned language model, and/or the like. Additionally or alternatively, the language model may be provided by a third-party system (e.g., a language model provided by a commercial language model provider such as OPENAI). In these embodiments, the platform 200 may provide contextual information to the language model to enable the language model to answer various user questions. The contextual information may include, for example, a preset list of questions that may be asked to determine user strategies, asset descriptions of assets and/or asset classes that are available and/or embeddings of the asset descriptions, strategy inputs and formats for data fields and/or values of strategy inputs, etc. The platform 200 may then transmit user queries to the language model along with the associated contextual information, thus enabling the language model to response appropriately to the user query. Additionally or alternatively, the contextual information may be stored as embeddings that are accessible to the language model. In embodiments, the platform 200 may parse response provided by the language model, extract information therefore, and use the information in the process (e.g., if the language model generates one or more strategy attributes, the platform 200 may recognize and extract the attributes.

The strategy input by the user (and/or generated by an AI component with user assistance) may include several components. The strategy may include one or more asset performance attributes that may specify or impact a mix of assets that may be associated with the asset class-backed tokens. In embodiments, the asset performance attributes may include one or more indicators of portfolio composition (e.g., an indicator of whether the portfolio should target growth vs. stability, prioritize one type of asset over another, etc.), other asset allocation factors (e.g., a desired amount of diversification, a desired sector to target, a desired risk tolerance, a desired amount of dividends or other income, a predictability of revenues or income, a desired amount of wealth accumulation, desired spending goals, desired margin-of-safety factors, desired removal or addition of volatility), estate planning goals (e.g., desired tax sheltering), desired non-financial effects (e.g., carbon neutrality by inclusion of renewable energy credits, pollution abatement, or the like), supply chain goals (e.g., insurance of the reliability/availability/price of certain specified materials, commodities, manufactures, etc.), desired IP rights (e.g., rights to manufacture and/or sell specified products in a specified territory or territories), risk management goals (e.g., hedging against specified outcomes or events), access to illiquid or otherwise difficult to transact assets (e.g., licenses to use non-fungible goods or services), and/or the like. The strategy input by the user may define any number of attributes. For example, a user may use a device to interface with the token design interface 302, which may provide menus, lists, forms, or other user interfaces for specifying various attributes that may include predetermined or customizable attributes and/or goals.

The strategy input by the user may further include an indication of a desired token value and/or value of a collection of tokens. For example, the user may specify that each token should be close to or match a target value, should fall within a range of values defined by a minimum or maximum value, and/or the like. Additionally or alternatively, the user may specify that a collection of tokens making up a portfolio may should be close to or match a target value, should fall within a range of values defined by a minimum or maximum value, and/or the like. In some of these embodiments, users may specify automated market maker (AMM) configurations that may be deployed on the blockchain with the asset class-backed tokens. For example, users may specify one or more trading pairs that should be provided by AMMs, a type and/or pricing function of the AMM, a price or price range that the AMMs should target, and/or the like. The AMM configurations may be manually provided by the user and/or determined automatically by the strategy engine 1902 using AI assistance in order to meet a user's strategy goals, as described in more detail below. Additionally or alternatively, the strategy engine may follow a hybrid approach in which a user may specify some aspects of one or more AMMs (e.g., trading pair) and the strategy engine 1902 may determine other AMM configuration information algorithmically and/or using AI-assisted techniques.

The strategy input by the user may further include token attributes specifying how the token or token collection should be structured. For example, a first example user may wish to generate a single non-fungible token that is backed by a collection of assets, such that the user may easily trade the single non-fungible token. A second example user may wish to generate a collection of 100 non-fungible tokens, each of which is backed by a different time period of revenue from the assets backing the collection, such that the user can allow bidding on the 100 non-fungible tokens on secondary markets. A third example user may wish to generate 1,000 fungible tokens, each corresponding to 0.1% of the value of the assets backing the tokens. A fourth example user may wish to generate a token of tokens, where each token includes a number of assets that may be combined in various ways. A fifth example user may wish to generate fractional ownership tokens, where each token has a fractional ownership interest in a physical object. Any of the various tokens described herein may be specified by the user. In embodiments, the token attributes may be any of the token attributes 304 described herein (e.g., type 402, chain 404, proof 408, design 412, rules 410, etc.). Again, some or all of the attributes of the user strategy (e.g., the type and/or number of tokens, chain, etc.) may be generated or modified by an AI model (e.g., a language model) based on user interaction and/or feedback as described above. For example, the contextual information provided by the platform 200 to the language model may including formatting information indicating that attributes may include a type 402 attribute, a chain 404 attribute, etc., and the language model may then generate, based on user responses and feedback, specific values for the attributes that the platform 200 may parse and extract.

The strategy input by the user may further include governance components, such as a need to comply with or avoid certain regulations, restrictions on trading or ownership of the tokens, and/or other regulatory components, policy components, and/or other governance components as described in further detail below. In some embodiments, the user may specify governance components as part of the input to the token design interface 302. Additionally or alternatively, the strategy engine 1902 may automatically select certain governance components based on the other inputs by the user and/or based on various simulations as described in more detail below. For example, if the user strategy indicates that tokens generated according to the user strategy may include financial instruments subject to certain regulations, the strategy engine 1902 may automatically select governance components corresponding to the regulations. Thus, for example, the governance components may include both user-supplied governance components and governance components that are automatically selected by the strategy engine 1902. As above, some or all of the aspects of the user strategy (e.g., one or more governance components) may be generated by an AI model (e.g., a language model) based on user interaction and/or feedback as described above.

The token design interface 302 may collect the specified asset performance attributes, token attributes, and/or governance components and provide them to the strategy engine 1902 as part of a first request 1914. At 2004, the strategy engine 1902 may prioritize the strategy components such that the most important, desirable, or necessary asset performance attributes, token attributes, and/or governance components are ranked higher than others. In embodiments, the strategy engine 1902 may transmit a first determination 1918 in response to the first request 1914 to the token design interface 302 to solicit user input to assist in prioritizing the strategy components. In embodiments, the first determination 1918 may include a default ranking of the attributes and/or governance components based on one or more rules and/or models 1908 leveraged by the machine learning system 1904 and/or AI system 1912. For example, the models 1908 may be trained to indicate that certain attributes and/or governance components (e.g., regulatory components, IP rights, supply chain goals) tend to be higher ranked than others (e.g., volatility performance attributes) based on a training data set comprising previous user prioritization inputs or the like.

In embodiments, the machine learning system 1904 and/or AI system 1912 may leverage generative AI models (e.g., large language models) to assist in prioritizing the strategy components. For example, the strategy engine 1902 may generate and submit one or more queries specifying the attributes and/or governance components the machine learning system 1904 and/or AI system 1912 using a query that requests the generative AI model to rank the strategy components. The strategy engine 1902 may then receive a ranked list of attributes and/or governance components from the generative AI model implemented by the machine learning system 1904 and/or AI system 1912. Furthermore, in some embodiments, at least one of the queries generated by the strategy engine 1902 and submitted to the generative AI model may request the generative AI model to identify potential conflicts between the various attributes and/or governance components. Accordingly, the strategy engine 1902 may receive a response from the generative AI model that indicates potential conflicts.

The token design interface 302 may display a user interface including some or all of the ranked attributes and/or governance components, which the user may modify (e.g., to change the ranking and/or resolve conflicts) as desired. For example, if a first token performance attribute indicates high growth and a second token performance attribute indicates low risk, the user may prioritize whether the strategy should focus more on high growth or low risk due to the potential conflict between these performance attributes. Additionally or alternatively, the user may indicate that certain attributes or components are required (e.g., a particular governance component is required, specified IP rights are required, etc.) and/or that certain attributes or components are optional. In some cases (e.g., where an attribute conflicts with another attribute), the user may remove the attribute via the prioritization user interface.

In embodiments, the strategy engine 1902 may leverage one or more trained models implemented by the machine learning system 1904 and/or AI system 1912 to detect potential conflicts between various of the user-supplied attributes and/or governance components. For example, a stored training set 1910 may include various user supplied attributes and/or governance components and indications of potential conflicts, which may be leveraged by the machine learning system 1904 and/or AI system 1912 to train a model that detect conflicts or potential conflicts. In these embodiments, the automatically detected conflicts may be flagged for the user during the prioritization step such that the user can indicate the relative importance of each, remove attributes that reduce the likelihood of achieving conflicting attributes, and/or the like. Accordingly, the first determination 1918 may indicate potential conflicts detected by the strategy engine 1902.

At 2006, the strategy engine 1902 may map the attributes to one or more assets in a pool of asset data maintained by the strategy engine 1902 and/or tokenization platform 200. Each asset may be mapped to one or more attributes associated with the asset, such as a risk attribute, a growth attribute, a carbon neutrality attribute, a fractional ownership attribute, an IP rights attribute, and/or any of the attributes of the various assets described herein. Additionally or alternatively (e.g., where the attributes indicate that the user wishes to own a certain asset), a selected or otherwise indicated asset may be selected from the pool of asset class data. The asset class data and/or attributes associated with the asset class data may be obtained from various sources and compiled (e.g., by the strategy engine 1902 and/or tokenization platform 200) into a comprehensive data set. The sources may include, for example, one or more asset exchanges (e.g., a stock or commodities exchange), one or more IP exchanges, markets for real estate or other assets, and/or other data producers that may provide information about assets and attributes associated with the assets. Other potential data sources are described in connection with FIG. 1 above.

In embodiments, the asset data may be part of a training set 1910, which may be used to train machine learned models 1908 to perform the mapping in conjunction with the machine learning system 1904 and/or AI system 1912. Additionally or alternatively, the strategy engine 1902 may evaluate the asset class using various logical and/or mathematical techniques in order to achieve certain performance attributes (e.g., balancing of carbon emissions with carbon offsets).

For example, if the user specifies a strategy that includes, as a first priority, carbon neutrality, a target growth of 7% as a second priority, a low volatility as a third priority, and a high level of diversification as a fourth priority, the strategy engine 1902 may perform operations to generate an asset mix that is carbon neutral, has a high percentage chance of achieving the target growth, has a high or medium percentage chance of low volatility (e.g., to the extent volatility conflicts with growth, growth may be prioritized), and has a high level of diversification (e.g., because diversification may not conflict with other performance attributes). In example embodiments, the strategy engine 1902 may use one or more machine learning models 1908 to generate the asset mix, which may output a certain asset mix (e.g., a mix of securities or other types of assets) based on the prioritized attributes. In embodiments, the asset mix may specify a number of each asset based on the attributes and any target token value supplied as part of the user strategy. Additionally or alternatively, the asset mix may indicate percentages of assets (e.g., such that token value is not yet taken into account).

In addition to or as an alternative to using machine learning models, the strategy engine 1902 may use matching strategies to select potential assets for an asset mix. For example, when a user strategy includes carbon neutrality, the strategy engine 1902 may automatically select renewable energy credits and/or pollution abatement credits to be part of an asset mix because these credits may be associated with a positive carbon reduction attribute that specifies an amount of CO2 reduction per credit. Then, if the asset mix includes other attributes (e.g., energy stocks, mining stocks) associated with a negative carbon reduction attribute (e.g., an increase in CO2), renewable energy credits may be added to “balance” the carbon attributes to achieve carbon neutrality. Thus, for example, a total amount of negative carbon reduction (e.g., indicating a net CO2 increase) associated with an asset mix may be used to select additional renewable energy credits until the total value for carbon reduction is at least zero.

Another example asset may be an IP rights asset that may specify licenses to one or more patents or patent portfolios corresponding to certain products, standards (e.g., communication standards), pharmaceuticals, methods, and the like, one or more copyrighted works, rights to perform the copyrighted work, and/or the like, or other IP rights. If the user-provided performance attributes specify particular IP rights and the asset pool includes corresponding assets that match the specified IP rights, the assets may be added to the asset mix.

At 2008, the strategy engine 1902 may simulate the performance of the selected asset mix. In embodiments, the strategy engine 1902 may use the token simulator 312, described in more detail elsewhere herein, to simulate the future performance of the selected asset mix. The token simulator 312 may provide a token simulator output 320 indicating various performance metrics. The token simulator 312 may indicate, for example, probabilities of achieving a particular growth rate over the next year, 3 years, 5 years, or other time period, probabilities of achieving other financial performance metrics, and/or the like. Additionally or alternatively, the token simulator 312 may indicate the probability that a specified asset remains available (e.g., due to supply chain constraints), that adverse economics and/or geopolitical events do not impact the ability to manufacture components for the asset, and/or the like, as described elsewhere herein.

In some embodiments, the strategy engine 1902 may simulate the pricing of the selected asset mix using an RDA system 2352 (described in more detail below), which may be configured to generate pricing estimates for various trading pairs using machine learning models or other AI-assisted techniques. Thus, for example, if a particular asset mix includes one or more assets that correspond to existing AI-assisted models that predict performance of the subset of assets based on historical trading pair data, the strategy engine 1902 may invoke the RDA system 2352 to predict performance data for the corresponding one or more assets. In some embodiments, trained AI models may exist for some (but not all) of the asset mix. In these embodiments, the trained AI models may be used to partially simulate performance of the asset mix. Furthermore, the strategy engine 1902 may use other techniques to simulate performance for the remaining assets (e.g., as described below for the token simulator 312) and generate a combined simulated performance of the entire asset mix.

At 2010, the strategy engine 1902 may adjust the asset mix based on the results of the simulation and/or based on user inputs. The strategy engine 2010 may provide the asset mix generated at 2006 and the simulated performance of the asset mix generated at 2008 to the token design interface 302, which in turn may present the asset mix and/or simulated performance to the user or a device associated with the user for presentation to the user. The user may then manually adjust the asset mix and the token design interface 302 may cause the simulation to re-run on the adjusted asset mix (e.g., by repeating step 2008). The strategy engine 1902 may repeatedly iterate by adjusting the asset mix and re-simulated asset mix as many times as desired by the user in order to optimize the portfolio until a user is satisfied with the asset mix and/or the simulated performance of the asset mix.

In some embodiments (not illustrated in FIG. 20), after simulating the asset mix, the user may re-prioritize performance attributes or other aspects of the user provided strategy and, in response, the token design interface may cause re-execution of step 2006 based on the adjusted strategy. For example, based on the simulation results, a user may realize that a particular attribute is detracting from one desired performance aspect, and accordingly may decide to eliminate the attribute. As another example, the simulation results may indicate that one attribute needs to be ranked more highly than another attribute in order to have a sufficient effect on the simulated performance, so the user may re-rank the attributes to achieve a desired performance in the updated simulated results.

In embodiments, the strategy engine 1902 may use automated methods to optimize the portfolio strategy based on the simulation results. For example, the strategy engine 1902 may adjust an asset mix by randomly swapping out a first selected asset for a second asset of the same type, then re-run the simulation to see if the user attributes are more or less likely to be achieved based on the adjusted asset mix. If the attributes are more likely to be achieved, the adjustment may be kept and if not, the adjustment may be reverted before attempting another iteration. Thus, by performing a large number of simulations based on randomized or semi-randomized variations, the strategy engine 1902 may iterate towards an optimal asset mix.

In embodiments, the strategy engine 1902 may use generative AI models (e.g., as implemented by the machine learning system 1904 and/or AI system 1912) to assist in optimizing the portfolio strategy based on the simulation results. For example, the strategy engine 1902 may submit a query comprising a summary of the simulation results to a generative AI model and request that the generative AI model provide a set of proposed optimizations based on the summary of the simulation results. The strategy engine 1902 may receive the generative AI response and use the suggested optimizations to adjust the portfolio strategy (e.g., asset mix), then re-simulate the performance of the asset mix (e.g., by looping back to step 2008).

At 2012, the strategy engine 1902 may generate one or more governance rules and/or AMM configurations based on the asset mix, the desired performance of the asset mix, and/or any governance components specified by the user strategy. For example, governance rules may be mandated by law for certain classes of security, or may be used for other purposes, as described elsewhere herein. In embodiments, the user may provide user-selected governance rules and/or the strategy engine 1902 may select mandatory governance rules based on the selected asset mix.

Additionally or alternatively, the strategy engine 1902 may generate AMM configurations specifying the design of one or more AMMs that will be deployed with the asset class backed token (if any). For example, the AMM configurations may indicate, for each AMM, one or more of a trading pair (e.g., another token that may be automatically traded for the asset class backed token using the AMM), a pricing function, a pool weighting (e.g., the relative weighting of each asset of a multi-asset mix in a liquidity pool), a fee structure (e.g., a percentage of a transaction taken as transaction fees and a distribution of the transaction fee to liquidity providers), one or more rules for managing the liquidity pool, risk mitigation rules (e.g., trading size limits, use of stop-loss orders, etc.), and/or distribution rules for incentivizing liquidity providers to contribute to the liquidity pool.

In embodiments, the strategy engine 1902 may leverage an RDA system 2352 (described in more detail below) to use one or more AI-assisted techniques to train models that optimize the AMM configurations. These techniques may include supervised learning techniques that train model(s) (e.g., neural networks, regression models, decision trees, etc.) based on historical training data. Additionally or alternatively, the AI techniques may include reinforcement learning techniques for iteratively training a model based on interactions with the market. Other relevant techniques may include evolutionary algorithms and/or deep learning techniques. In these embodiments, a training data set may include trading data, market conditions data, asset volatility data, liquidity demand data, and/or the like. Moreover (e.g., for supervised learning techniques), the training data set may include target data that includes AMM parameter data specifying any of the above AMM configuration data (e.g., trading pair parameters, pricing functions, pool weighting parameters, fee structure parameters, liquidity pool management parameters, risk mitigation parameters, distribution parameters, etc.).

At 2014, the strategy engine 1902 may output a portfolio specification comprising one or more token descriptions 910, asset class descriptions 912, token link descriptions 914, AMM configurations, and/or other configuration data corresponding to the optimized asset mix. Additionally or alternatively, the strategy engine 1902 may output a governance scheme incorporating the one or more token governance rules. The one or more token descriptions 910, asset class descriptions 912, token link descriptions 914, AMM configurations, and/or governance rules may be used to generate one or more asset-class backed tokens and/or to deploy related smart contracts (e.g., AMMs), as described elsewhere herein. In embodiments, the portfolio specification may specify a plurality of different tokens where each token is backed by a different asset of the portfolio. Additionally or alternatively, the portfolio specification may specify one or more hybrid tokens, where each hybrid token is backed by multiple (or all) assets of the portfolio.

### Minting Asset-Class Backed Tokens Using Smart Contracts

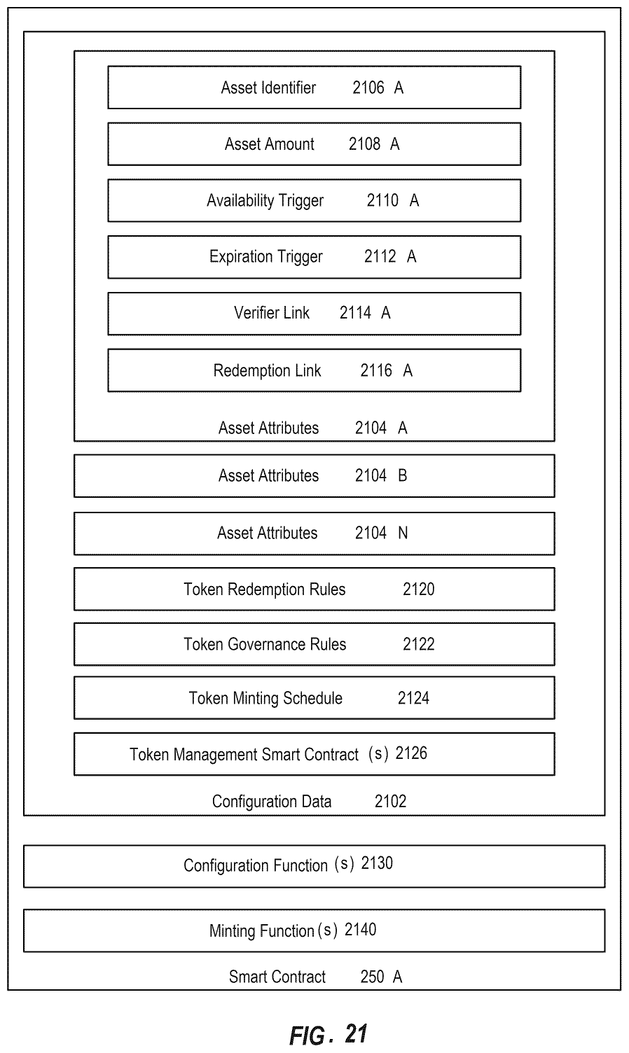

FIG. 21 illustrates an example smart contract 250A that may be used by the asset class-backed tokenization platform 200 to generate one or more asset class-backed tokens on a distributed ledger (e.g., blockchain). In embodiments, an example smart contract 250A may be configured to generate a plurality of similar asset-class backed tokens (e.g., a set of fungible tokens, or a set of non-fungible tokens that share at least some common attributes), which may be referred to herein as a collection of asset-class backed tokens. The example smart contract 250A may generate the one or more asset-class backed tokens as described above for step 1610. The token design system 204 and/or token deployment system 208 of the asset-class backed tokenization platform 200 may be configured to interface with any of the other smart contracts 250 described herein to invoke various functions of the smart contracts.

In embodiments of the disclosure, a plurality of smart contracts 250 configured to mint asset-class backed tokens may be deployed to various blockchains or other distributed ledgers, with each such smart contract being configured to mint at least one token or class of token. For example, different smart contracts 250 may be provided on an Ethereum blockchain, a Solana blockchain, etc. In these embodiments, the asset-class backed tokenization platform 200 may deploy an example smart contract 250A in order to cause minting of one or more collections of asset-class backed token(s) on a particular distributed ledger (e.g., the chain 404 specified by the token attributes 304 supplied by a user during a token design phase). In embodiments, a single smart contract 250 may be used to mint multiple collections of tokens. Additionally or alternatively, each collection of tokens may be minted by a different smart contract 250.

The example smart contract 250A may have one or more functions and may store and/or access configuration data that may be used during a minting process. In embodiments, at least one of the functions may be a minting function, and at least one of the functions may be a configuration function that may be used to supply configuration data to the smart contract 250A. To use the smart contract 250A to mint a plurality of asset-class backed tokens, an asset-class backed tokenization platform 200 may initially configure the smart contract 250A by providing configuration data to the smart contract 250A using a configuration function of the smart contract 250A, which may store the configuration data. The asset-class backed tokenization platform 200 may then call a mint function of the smart contract 250A to mint (e.g., once or repeatedly) one or more asset-class backed tokens based on the configuration data. Additionally or alternatively, the smart contract 250A may be configured to mint an asset-class backed token without pre-storing configuration data (e.g., if the configuration data is provided to the mint function directly, if the configuration data is stored off-chain, etc.).

The smart contract 250A may store configuration data 2102, which may include any data used for minting an asset-class backed token (e.g., asset-class backed token metadata). For example, the configuration data may include one or more token attributes (e.g., token attributes 304), one or more asset class attributes (e.g., asset class attributes 308), data from a token description 910, data from an asset class description 912, data from a token link description 914, and/or the like. In the illustrated example, the configuration data 2102 for a particular asset-class backed token or collection of asset-class backed tokens may include asset attributes 2104 for a plurality of assets (e.g., for a hybrid token backed by multiple assets), one or more token redemption rules 2120, one or more token governance rules 2122, and/or a token minting schedule 2124.

In the illustrated example, the configuration data 2102 includes a plurality of first asset attributes 2104A that include an asset identifier 2106A, an asset amount 2108A, an availability trigger 2110A, an expiration trigger 2112A, a verifier link 2114A, and a redemption link 2116A. However, these attributes are merely exemplary, and additional or alternative asset attributes may be provided for other assets and/or other asset-class backed tokens. In the illustrated example, the configuration data specifies multiple assets by specifying different sets of asset attributes (e.g., asset attributes 2104A-2104N). Multiple sets of asset attributes may be specified when a single smart contract 250A is used to mint multiple types of tokens (e.g., one type of token per set of asset attributes), when a smart contract 250A is used to mint asset-class backed tokens backed by multiple assets (e.g., one token is backed by each type of attribute), when tokens are tokens are being minted, and/or the like.

In example embodiments, an asset identifier 2106A may identify a particular asset that is used to back the asset-class backed token (e.g., gold, a type of stock, a type of intellectual property, a revenue stream, a crop harvest, etc.). The asset identifier may include a textual description of the asset, a unique identifier corresponding to the asset (e.g., a ticker symbol, a registration number, and/or some other unique identifier), and/or any other information that may be used to identify the specific asset (for a non-fungible asset) or class of asset (for a fungible asset).

In example embodiments, an asset amount 2108A may identify the amount of the asset identified by the asset identifier 2106A. For example, the asset amount may indicate a specific number of the asset, a weight of the asset, a percentage of the asset, a fractional ownership interest in the asset, a specific right or bundle of rights associated with the asset, a time period of the asset (e.g., for a time-wise division of a revenue stream, a time division of utilization rights or access control, or the like), or any other means of dividing up ownership or other rights to specific asset(s) or amount(s) of a fungible asset.

In example embodiments, an availability trigger 2110A may specify a trigger that may cause the asset to become available, for example an earliest time at which the asset may be available (e.g., for redemption). For example, if an asset class is a right to a particular future time period of a revenue stream, the revenue from the revenue stream may not be available for redemption until the future time period. Similarly, if the asset corresponds to a percentage of a crop harvest, the asset may not be available for redemption until a time period of or related to the actual harvest. Thus, for example, the availability trigger 2110A may store a timestamp after which the asset becomes available.

Additionally or alternatively, the availability trigger 2110A may specify any other type of trigger that may make the asset available. For example, certain assets (e.g., insurance payouts) may become available in case of events such as weather events, damage to property, a health procedure taking place, etc. In these embodiments, an availability trigger 2110A may indicate a data source, such as a recognized public data source, such as an oracle, that may indicate whether a particular event has occurred. Additionally or alternatively, the availability trigger 2110A may indicate that the asset may be available if a particular event or other trigger has above a threshold probability of occurring, below a threshold probability of occurring, falls within a particular range of probabilities, and/or the like. In these embodiments, the availability trigger 2110A may indicate a corresponding oracle that may store predictions generated using artificial intelligence techniques (e.g., machine learning models) of the probability of future events occurring.

In example embodiments, an expiration trigger 2112A may specify an expiration condition, such as a latest time at which the asset may be available (e.g., for redemption). For example, an expiration timestamp may be used for certain expiring assets, such as futures contracts, options, and/or any other asset that may expire after a certain date. Additionally or alternatively, an expiration trigger 2112a may reference an oracle that may indicate whether certain events have occurred, are likely to occur or not occur, and/or the like, as described above for the availability trigger 2110A.

In example embodiments, a verifier link 2114A may link to a system, oracle, and/or smart contract for verifying that the asset exists, is owned by a particular party, is stored in a particular location, and/or the like. For example, the verifier link 2114A may indicate an oracle associated with a third party that underwrites the asset (e.g., by ensuring that the minter of the asset has possession of the asset and/or is likely to have possession of the asset in the future).

In example embodiments, a redemption link 2116A may contain a link to a system and/or smart contract for redeeming the asset-class backed token in order to receive the asset. For example, the redemption link may include a link to a website where a holder of the asset-class backed token may confirm the holder's ownership of the asset-class backed token, enter an address or bank account information for receiving the asset, and/or the like. Additionally or alternatively, the link may be a link to a smart contract configured to assist in redeeming the asset-class backed token.

In embodiments, the configuration data 2102 may further include one or more asset attributes 2104B-N for second, third, and/or up to any number N of assets that are associated with the asset-class backed token. In embodiments, various assets 2-N may be configured using the same attributes and/or different attributes (e.g., depending on the type of asset).

In embodiments, the configuration data 2102 may further include one or more token redemption rules 2120, which may indicate how token(s) may be redeemed for the asset class backing the token(s). For example, an asset-class backed rule may indicate that an asset-class backed token corresponding to the configuration data 2102 entitles its holder to either of a first asset (e.g., the asset indicated by asset class attributes 2104A) or a second asset (e.g., the asset indicated by asset attributes 2104B), but not both. In this example, an asset-class backed token's value may correspond to whichever of the first asset or the second asset has a greater value. Another example rule may indicate that an asset-class backed token entitles its holder to a first asset, but if the value of the first asset falls below a threshold value, the token holder may be entitled to a second asset. In this example, the second asset may be used to hedge against a drop in value for the first asset. Other rules may indicate, for example, conditions in which the holder of the token is entitled to certain assets and/or may redeem certain assets (e.g., based on a corresponding value of each asset, a total value of all assets, etc., based on the discretion of the holder, based on certain asset values being less than or greater than other asset values), whether certain assets can be redeemed separately or must be redeemed at the same time, and/or the like. In embodiments, the token redemption rules 2120 may be used to configure a valuation system and/or redemption system, as described in more detail elsewhere herein.

In embodiments, the configuration data 2102 may further include one or more token governance rules 2122 that may be used to control one or more aspects of the asset-class backed token. For example, token governance rules 2122 may include purchaser eligibility rules that indicate to whom the asset-class backed token may be sold. Purchaser eligibility rules may specify, for example, that a purchaser of the asset-class backed token must meet accredited investor requirements (e.g., must own more than a certain value of other assets), that a purchaser of the asset-back token must be a holder of an entitlement token (e.g., an NFT verifying the purchaser's right to purchase an asset or class of assets), that a purchaser of the asset-class backed token must be approved by a third party, and/or the like. Additionally or alternatively, token governance rules may indicate a party that is responsible for valuation of the asset-class backed token, whether some or all of the assets backing the token must be insured before a sale or transfer, and/or the like.

In embodiments, the configuration data 2102 may further include one or more token minting schedule(s) 2124. A token minting schedule 2124 may specify how many tokens to mint for an initial mint and/or instructions for minting additional tokens after the initial mint. For example, a token minting schedule may configure one or more future mints when an asset corresponds to a recurring revenue stream or some other recurring asset. The token minting schedule may define a period for minting new asset-class backed tokens (e.g., yearly, monthly, quarterly, etc.) and a number to mint per period. For example, the token minting schedule may indicate that 100 asset-class backed tokens may be minted each year (e.g., where each token corresponds to 1% of an allocated revenue stream for an upcoming year, as defined by asset attributes). The token minting schedule may further define which portion of a revenue stream each asset-class backed token corresponds to. For example, the token minting schedule may indicate that 1200 asset-class backed tokens may be minted each year, where a first 100 tokens each correspond to 1% of a January revenue for the following year, a second 100 tokens each correspond to 1% of a February revenue for the following year, and the like. Thus, the token minting schedule (e.g., in conjunction with asset attributes) may define instructions for periodically minting asset-class backed tokens.

Additionally or alternatively, the token minting schedule 2124 may define other conditions (e.g., non-periodic conditions) for minting tokens. For example, the token minting schedule may identify a minimum and/or maximum number of tokens that should be kept in circulation. Thus, for example, if a certain number of asset-class backed tokens are burned (e.g., because the tokens are redeemed for their corresponding assets), new asset-class backed tokens may be automatically minted to replace them until a minimum number of tokens in circulation is reached. Additionally or alternatively, the token minting schedule may define trigger conditions for minting a certain number of new tokens (e.g., such that a new batch of tokens is minted whenever the trigger occurs).

In embodiments, the configuration data 2102 may specify one or more token management smart contracts via attribute 2126 that may manage the asset-class backed tokens after they are minted. For example, the management smart contract indicated by attribute 2126 may manage the transfer of the asset-class backed tokens from one user to another (e.g., ensuring any eligibility requirements are met), may manage the modification of asset-class backed tokens if permitted, may manage income flows associated with the token (e.g., the management smart contract may receive payments and distribute the payments to token holders, and/or the like). Additionally or alternatively, in embodiments the smart contract 250A may manage the tokens after they are minted (e.g., the minting smart contract 250A and managing smart contract 250B may be the same smart contract).

In embodiments, the example smart contract 250A may include one or more functions that may be invoked by the tokenization platform 200 and/or by other smart contracts 250. For example, the example smart contract 250A may include a configuration function 2130 that may accept configuration data 2102 and/or store the configuration data 2102 in the example smart contract 250A. For example, prior to minting a configured set of asset-class backed tokens, the tokenization platform 200 may generate configuration data 2102 for the asset-class backed tokens and then initiate a distributed ledger transaction that calls a configuration function 2130 of a smart contract 250A. The configuration function 2130 may accept, as one or more arguments, the configuration data 2102 and/or equivalent data values. The configuration function 2130 may then store the arguments as configuration data 2102 and/or perform other actions to configure the example smart contract 250A and/or other smart contracts to mint the corresponding asset-class backed tokens.

In embodiments, an example smart contract 250A may be configured without the use of a configuration function 2130. For example, a tokenization platform 200 may pre-configure an example smart contract 250A using the configuration data 2102 and then initiate one or more distributed ledger transactions that cause the pre-configured example smart contract 250A to be stored on the distributed ledger.

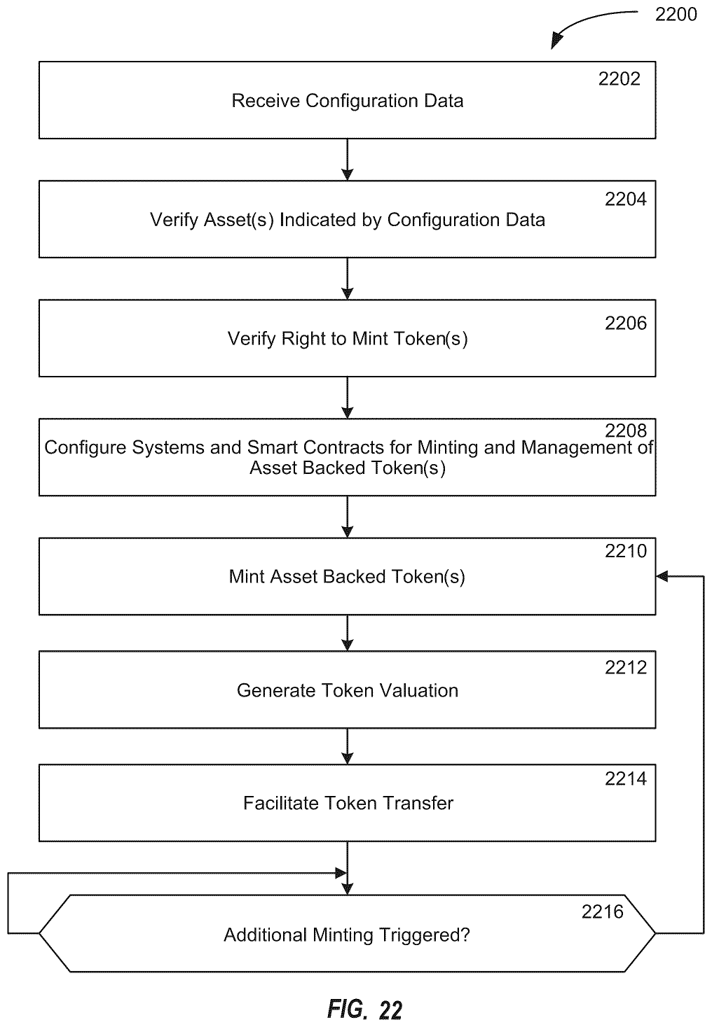

In embodiments, the example smart contract 250A may include a minting function 2140 that may cause or initiate one or more distributed ledger transactions that mint one or more asset-class backed tokens based on the configuration data 2102. The minting function 2140 may perform some or all of the steps described in the process illustrated at FIG. 22. In embodiments, minting a token may include generation of a new unique token and associated attributes. The new token may be generated and stored within the smart contract 250A and/or within another smart contract 250B (described further below). The new token may be stored with a unique identifier, a record indicating a current owner (which may initially be set to a default value such as the minting party and may later be changed to indicate the blockchain address of a current owner after a purchase or other token transfer), and a plurality of attributes. In embodiments, some of the attributes may include links to off-chain data, which may be stored in centralized storage (e.g., a file server) or decentralized storage (e.g., IPFS).

FIG. 22 illustrates an example process for minting tokens using a tokenization platform 200 and/or example smart contract 250A. The process of FIG. 22 may be executed in full or in part by an example smart contract 250A and/or in full or in part by an asset-class backed tokenization platform 200, which may call various functions of the smart contract 250A. For example, as described in more detail below, the smart contract 250A may configure itself to periodically mint tokens according to a token minting schedule (if provided as part of configuration data 2102), and/or the platform may periodically call the smart contract minting function as indicated by the token minting schedule.

At step 2202, the smart contract 250A and/or the asset-class backed tokenization platform 200 may receive configuration data 2102. In embodiments, the configuration data 2102 may be generated by the asset-class backed tokenization platform 200 based on one or more of the token attributes 304, asset class attributes 308, and/or asset-token link frameworks attributes 310. For example, as described above with respect to FIG. 3, the token design system 204 may generate a proposed asset-class backed token 318 including a particular token attribute profile 322, asset class attribute profile 324, and/or asset-token link framework 328. Additionally or alternatively, the strategy engine 1902 may generate a portfolio specification as described elsewhere herein, which may include token attributes 304, asset class attributes 308, asset-token link frameworks attributes 310, and/or configuration data 2102. In some embodiments, data corresponding to the proposed asset-class backed token 318 may be converted into configuration data 2102 by the platform 200 (e.g., by the token deployment system 208, which may handle communication with one or more smart contracts 250, including the smart contract 250A).

In embodiments, the platform 200 may leverage a language model provided by an AI system 1912 to allow a user to review the configuration data 2102, explain the type of asset-class backed tokens (e.g., number, performance, etc.) that will be minted using the configuration data 2102, allow the user to make changes to the configuration data 2102 (e.g., to mint a different number of tokens), to swap out one asset or asset class for another asset or asset class, etc., before proceeding with the method. In other words, the user may interactively modify the configuration data 2102 as desired prior to proceeding with configuration/deployment of a smart contract and/or minting. In these embodiments, the platform 200 may submit a prompt including the various configuration data 2102 and/or other relevant data (e.g., formatting rules for the configuration data 2102, general information about assets or asset-class backed tokens, etc.) to the language model so that the language model includes contextual information enabling it to respond to user queries, then may display a user interface that allows a user to ask various follow-up questions based on the provided context. After receiving a user query via the user interface, the platform 200 may include the user query along with the previous conversation history (e.g., which may include the previously provided contextual information) to the language model and receive and display a reply, which the platform 200 may interpret in various ways (e.g., if the language model responds with a modified set of configuration data 2102, the platform 200 may detect (e.g., using a parser) and use it to modify the configuration data 2102. In a similar way, the platform may leverage a language model to explain how a smart contract 250A will work after being deployed/configured with configuration data 2102 (e.g., such that a user may ask about various smart contract functions and receive answers based on context provided to the language model by the platform 200, such as smart contract code and/or documentation).

In embodiments, the asset-class backed tokenization platform 200 may provide the configuration data 2102 to the smart contract 250A (e.g., it may call a configuration function 2130 of the smart contract 250A, providing the configuration data 2102 as an argument to the configuration function). In embodiments, the asset-class backed tokenization platform 200 may select which of a plurality of smart contracts 250 to configure based on the configuration data 2102 or other data (e.g., a token attribute profile 322). For example, if the configuration data 2102, the token attribute profile 322, or some other data indicates that the asset-class backed token is an Ethereum token, the asset-class backed tokenization platform 200 may select a smart contract that is already deployed on the Ethereum blockchain to configure. The asset-class backed tokenization platform 200 may then call the configuration function of the selected smart contract. Additionally or alternatively, the asset-class backed tokenization platform 200 may deploy a new smart contract to the selected blockchain instead of configuring an already deployed smart contract.

At step 2204, the asset-class backed tokenization platform 200 and/or smart contract 250A may be configured to verify the assets indicated by the configuration data 2102. For example, the asset-class backed tokenization platform 200 and/or smart contract 250A may use the verifier link 2114 for each asset specified in the configuration data to check that the asset exists, that the asset is available (e.g., that the asset is not already backing another token), that the asset is stored in a designated location (e.g., a storage facility), that the asset's title is not encumbered, and/or that the asset is otherwise in a condition to be used to back the one or more tokens to be minted. For example, a verifier link 2114 may indicate an off-chain system associated with an asset verification and/or storage provider. In embodiments, different verifier systems may be used for different assets indicated in the configuration data. Additionally or alternatively, each verifier link 2114 may link to an API of a system (e.g., the asset-class backed tokenization platform 200 and/or some other system) that interfaces with a plurality of verifiers in order to verify the assets. Additionally or alternatively, the tokenization platform 200 and/or smart contract 250A may use one or more oracles 2308 to obtain off-chain data from a verifier located at a verifier link 2114. In these embodiments, the oracles 2308 may periodically and/or on-demand (e.g., in response to a query record stored by the smart contract 250A) obtain verification data and store the verification data on-chain for access by the smart contract 250A.

At 2206, the asset-class backed tokenization platform 200 and/or smart contract 250A may be configured to verify that the user requesting the minting has the right to mint the tokens. For example, the user may already have ownership of the assets indicated by the configuration data 2102 (e.g., as indicated by the verifier 2114, which may indicate the ownership status of each asset). Additionally or alternatively, the user may provide sufficient fungible tokens (e.g., by transferring the tokens to a wallet maintained by the asset-class backed tokenization platform 200 and/or to the address of the smart contract 250A) to allow the user to obtain the assets as part of the minting process. For example, if a first asset is available for purchase at a certain unit price (e.g., as indicated by the asset verifier, a marketplace system, a token simulator 312, etc.) and the configuration data indicates that the asset-class backed token should be backed by a certain number of units of the first asset, then at step 2206 the asset-class backed tokenization platform 200 and/or smart contract 250A may verify that the user either already owns the specified assets or has provided sufficient funds (e.g., fungible tokens) to purchase the designated number of first assets at the current unit price.

In embodiments, the asset-class backed tokenization platform 200 and/or smart contract 250A may wait until a token pool has sufficient funding (e.g., a sufficient number of fungible tokens associated with a defined price and/or asset-class backed tokens with a sufficiently high value estimate) to proceed with minting the tokens. In these embodiments, multiple users may contribute funding to the pool and the asset-class backed tokenization platform 200 and/or smart contract 250A may track the value of funds (e.g., tokens) contributed by each user so that the minted asset-class backed tokens may be apportioned to different users according to their contribution value. Thus, for example, the asset-class backed tokenization platform 200 and/or smart contract 250A may provide for a crowdfunding model where users pool funds for a mint until a goal amount is reached and then the method 2200 proceeds to mint the asset-class backed tokens.

At step 2208, the asset-class backed tokenization platform 200 and/or smart contract 250A may use the configuration 2102 to configure one or more smart contracts 250A. In embodiments, a configuration function 2130 of a minting smart contract 250 may execute one or more instructions to configure the smart contract to mint the asset-class backed tokens using the configuration data 2102. For example, the configuration function 2130 may cause the smart contract to store some or all of the configuration data 2102 in a storage area of the smart contract. Additionally or alternatively, the asset-class backed tokenization platform 200 and/or the smart contract 250 may configure other smart contracts and/or systems using the configuration data 2102, such as a token management smart contract, one or more AMMs 2350 and/or RDA systems 2352, a governance system, and/or the like. For example, the token redemption rules 2120 of the configuration data 2102 may be used (e.g., by the asset-class backed tokenization platform 200 and/or the smart contract 250A) to configure a token management smart contract 250B, as described elsewhere herein. In embodiments, the smart contract 250A may configure the token management smart contract 250B by storing the configuration data on the distributed ledger (e.g., in storage of the smart contract 250A) so that the configuration data may be retrieved by the token management smart contract 250B from the distributed ledger. Additionally or alternatively, an asset-class backed tokenization platform 200 may configure the token valuation system and/or the token redemption system by sending at least a portion of the configuration data 2102 (e.g., the token redemption rules 2120) to the token management smart contract 250B.

In embodiments that include the deployment of one or more AMMs 2350 for the asset class backed tokens, the tokenization platform 200 may deploy AMMs 2350 based on AMM configuration data generated by the strategy engine, as described above, Additionally or alternatively, the tokenization platform 200 may configure an RDA system 2352 to train, deploy, and/or execute one or more AI models for generating pricing data for use by the on-chain AMM 2350 to provide a pricing function for automated trading of the asset class backed token. In embodiments, the tokenization platform 200 may obtain the AI models from a third-party resource and/or from the user configuring the minting of the asset class backed token. Additionally or alternatively, the tokenization platform 200 may train a custom AI model based on historical data for one or more assets and/or asset classes corresponding to the asset class backed token and/or historical data for a second token of a trading pair provided by the AMM 2350.

At step 2210, the configured smart contract 250A may mint one or more asset-class backed tokens as indicated by the initial mint instructions of a token minting schedule 2124. For example, if the token minting schedule 2124 indicates that 100 asset-class backed tokens should be minted, where each asset-class backed token is backed by a specified amount of each of assets A-N (e.g., as indicated by the asset identifiers 2106 and asset amount 2108 for each asset A-N), then the smart contract 250A may mint the indicated 100 asset-class backed tokens. Additionally or alternatively, tokens may be minted on-demand (e.g., in response to a user requesting and paying for the minting of a token using a function of the smart contract 250A). Each minted asset-class backed token may be assigned one or more corresponding assets as indicated by the configuration data 2102. In general, any or all of the data fields stored as configuration data 2102 may be written as attributes of the minted asset-class backed tokens. For example, a minted asset-class backed token may include all of the asset attributes 2104A for a first asset backing the token, such as an asset identifier 2106A, an asset amount 2108A, an availability trigger 2110A, an expiration trigger 2112A, a verifier link 2114A, and/or a redemption link 2116. Similarly, a minted asset-class backed token may include asset attributes 2014B-N for other assets that back the asset-class backed token. Additionally or alternatively, in lieu of storing some or all of the attributes in the asset-class backed token, the asset-class backed token may store a link to data stored elsewhere (e.g., in another smart contract or off-chain in decentralized storage or the like). In some embodiments, the corresponding attributes may be obtained from the configuration data 2102 stored in the smart contract 250A.

The asset-class backed tokens, once minted, may be stored on the distributed ledger within the smart contract 250A and/or within a smart contract 250B for managing the tokens, as described in more detail elsewhere herein. In some embodiments, the smart contract 250A that minted the token and the smart contract 250B that manages the tokens may be the same smart contract 250 or different smart contracts.

At 2212, the asset-class backed tokenization platform 200 and/or the smart contract 250A may initiate a valuation of the minted asset-class backed tokens. For example, the asset-class backed tokenization platform 200 and/or the smart contract 250A may call a token simulator 312 configured to generate a valuation of the minted asset-class backed token. As described in more detail elsewhere herein, the token simulator 312 may value each asset-class backed token based on the assets backing the token (e.g., their current value, predicted value, etc.), whether ownership of the assets is verified or not, any rules for redeeming multiple assets, predicted likelihoods of certain events occurring, and/or the like.

At 2214, the asset-class backed tokenization platform 200 and/or the smart contract 250A may facilitate a transfer of the tokens. In some embodiments (e.g., where the user requesting the minting wishes to hold the asset-class backed tokens), the asset-class backed tokenization platform 200 and/or the smart contract 250A may cause a transfer of the tokens to the user that initiated the mint. In embodiments in which multiple users contributed funds to acquire the assets backing the tokens (e.g., for a crowdfunding model), the asset-class backed tokenization platform 200 and/or the smart contract 250A may distribute the tokens to the users in proportion to the amount of funding they provided. In some embodiments (e.g., where the user requesting the minting wishes to sell the asset-class backed tokens to raise capital), the asset-class backed tokenization platform 200 may automatically generate listings for the minted asset-class backed token on a marketplace. In some embodiments, the listings may indicate the valuation generated at step 2212 and/or be purchasable for an amount matching or exceeding the valuation generated at step 2212.

At 2216, the asset-class backed tokenization platform 200 and/or the smart contract 250A may mint additional asset-class backed tokens if/when a trigger specified in the asset minting schedule is detected. For example, if the minting schedule specifies a periodic minting of additional tokens, then the asset-class backed tokenization platform 200 and/or the smart contract 250A may wait until a corresponding time is reached and then mint additional assets. Additionally or alternatively, if the minting schedule specifies a minting of additional tokens based on an event, then the asset-class backed tokenization platform 200 and/or the smart contract 250A may periodically poll other systems (e.g., oracles) and/or smart contracts to determine whether the even has occurred and then mint additional assets after detecting that the trigger has occurred.

### Managing Asset-Class Backed Tokens Using Smart Contracts

In embodiments, one or more smart contracts 250 may be configured to manage the asset-class backed tokens after they are minted. In some embodiments, a token management smart contract attribute 2126 may be included in configuration data 2102 prior to minting, such that the asset-class backed tokens may be minted and linked to the corresponding smart contracts 250 indicated by the attribute 2126 after minting. Additionally or alternatively, the minted asset-class backed tokens may be stored within a storage area of a smart contract 250 that is configured for token management (e.g., they may be wrapped by the smart contract). In embodiments, one or more smart contracts 250 may be configured with a wide variety of different management functions depending on the corresponding asset-class backed token(s) and associated attributes. Example management functions are described in detail below, but it should be appreciated that any type of management function may be used to manage asset-class backed tokens as desired.

According to a first example, a collection of asset-class backed tokens may be backed by a set of different assets relating to a complex project and managed by a smart contract 250. For example, the assets may include land, infrastructure existing or to be built on the land, a supplier ecosystem, inputs for a factory or other productive asset, a productive asset itself (e.g., a factory or power plant) that is built or scheduled to be built, stock in a company that manages the power plant, and/or the like. Such a collection of asset-class backed tokens may allow for productive investment in long-term revenue streams, such as a future power plant. In this example, acquiring a single asset-class backed token of the collection may provide part ownership for the land used to hold the productive asset, the inputs for the productive asset, the company that manages the productive asset, and/or the productive asset itself.

In this example, one or more smart contracts 250 may be configured to manage the associated mechanics of the asset-class backed tokens, such as verification of receipt of rental funds, division of revenue among token holders, raising of new capital, and/or the like. In embodiments, the smart contract(s) may include functions for implementing each or all of these mechanics. For example, if the token is backed by the land associated with the project, a smart contract 250 may be configured with a function that verifies that lease payments for use of the land are paid by the user of the land (e.g., the smart contract may have a function that allows for the receipt of cryptocurrency or other token-based payments to be made directly to the smart contract and/or the smart contract may monitor the receipt of payments to a designated payment blockchain address) and may be configured to divvy up the payments to all token holders (e.g., such that a rental revenue of 100 k may be divided up evenly among the holders of 1,000 tokens that are backed by the land asset and/or other related assets). Additionally or alternatively, if some or all of the payments are made off-chain, the smart contract may be configured to communicate with an oracle 2308 that has access to payment data such that the oracle 2308 is configured to verify the receipt of the payments. In these embodiments, the smart contract may be configured to instruct the oracle 2308 to cause distribution of the received payments to the token holders.

Additionally or alternatively, if the asset-class backed tokens are backed by ownership of a productive asset (e.g., factory, power plant, energy production facility, etc.), once the productive asset begins operating, a smart contract 250 (e.g., the same smart contract that manages rental payments or a different smart contract) may have a function configured to receive (or verify the receipt by another on-chain address or off-chain payment system via oracle 2308) a portion of revenue from the operation of the productive asset (e.g., 2% of top line revenue) and divvy up this revenue to the blockchain addresses of token holders. In these embodiments, an availability trigger 2110A specified in the configuration data 2102 may indicate that the revenue verification and division should begin when a specified oracle system indicates that the productive asset is in operation. Additionally or alternatively, the tokenization platform 200 may regularly (e.g., at periodic intervals) invoke a configured function of the smart contract that verifies revenue receipts and/or distributes revenue to blockchain addresses of token holders. In these embodiments, an oracle system (e.g., oracle system 2302) may provide information about revenue streams, indicate the amount to be transferred to the smart contract 250 and divvied out, and/or the like.

Additionally or alternatively, one or more smart contracts 250 associated with the asset-class backed tokens of the first example may be configured to raise new capital for a related project (e.g., an increase in capacity for the productive asset) and manage the distribution of revenues due to increased production (e.g., between the new capital contributors and existing token holders). In these embodiments, the smart contract 250 may be configured to receive the new capital and distribute it appropriately (e.g., to blockchain addresses that are managed by parties responsible for allocating the raised capital). Moreover, the smart contract 250 may be further configured to receive and/or verify receipt of revenue from the productive assets and to distribute the revenue accordingly (e.g., in part to blockchain addresses of token holders).

In some embodiments, a collection of asset-class backed tokens may correspond to a plurality of complex projects (e.g., several projects to build new power plants or other energy production or generation facilities such that an asset-class backed token may correspond to several pieces of land, several productive assets, several sets of inputs, stocks for several companies, etc.) in order to diversify risk, reduce potential volatility in revenue, provide more predictable valuation growth, provide increased upside by focusing on earlier stage projects, and/or the like. In these embodiments, smart contracts may receive and/or verify receipt of rental revenue, profits produced by the productive assets, stock distributions, proceeds from sales of stocks, and/or the like, and may distribute the revenues accordingly (e.g., to blockchain addresses of token holders) as described above.

In embodiments, asset-class backed tokens may be backed by a plurality of energy production facilities (e.g., oil and gas facilities, such as oil platforms, oil wells, refineries, land related thereto, equipment related thereto, and/or the like), energy storage facilities (e.g., oil and/or gas storage, including strategic petroleum reserves and/or fractional ownership thereof, entitlement to revenues from the sale of stored oil and/or gas, etc). In these embodiments, the tokens may entitle the owners of each token to shares of revenues generated by the energy production and/or storage facilities, and a management smart contract may receive and/or verify receipt of revenue streams or other profits produced by the production facilities, stock distributions, proceeds from sales or rentals of equipment, and/or the like, and may distribute the revenues accordingly (e.g., to blockchain addresses of token holders) as described above.

According to another example, a collection of asset-class backed tokens may each be associated with non-exclusive IP rights together with a portion of the revenue or profit derived from commercialization of the IP. For example, each token may be backed by a license to make, sell, or otherwise use one or more goods, services, performances, and/or other items protected by intellectual property. In this example, a smart contract 250 may be configured to collect revenue from licensees of the intellectual property and to distribute a portion of the profit to the blockchain accounts of token holders. In some embodiments, for the collection of tokens according to the second example, some or all of the tokens may be backed by licenses to IP rights with degrees of exclusivity (e.g., in terms of geography, field of use, or other restrictions). In these embodiments, one or more smart contracts 250 may be configured to manage the collection of various segments of revenue (e.g., revenue from a particular location or field of use) and to distribute (at least a portion of) the revenue to the blockchain accounts of corresponding token holders. As above, the smart contract 250 may receive revenues directly and/or to verify receipt of revenues to other blockchain addresses and/or off-chain payment systems via oracle 2308, and may be triggered for periodic verifications and/or distributions by other smart contracts and/or by the tokenization platform 200.

In some embodiments, a smart contract 250 may be configured to allow token holders to sublicense IP rights corresponding to their token(s), for example by creating a new set of tokens that split up portions of the IP rights associated with their tokens. Thus, for example, a token holder may cause the minting of new tokens for IP rights assets backing the token holder's tokens. In these embodiments, the smart contract 250 may track and handle the division of revenues corresponding to the IP rights among the token holder of the original token and the holders of the tokens backed by the sublicensed IP rights. For example, in the case of a single entity creating a token that divides revenues from IP rights, a smart contract 250 may be configured to monitor royalty payments (e.g., via an oracle) and to divide the revenue into equal portions or otherwise predefined portions and to transfer the respective portions to accounts (e.g., digital wallets) of those token holders. In general, a smart wrapper that wraps an asset-class backed token may be configured to automatically allocate a specified amount of funds (e.g., cryptocurrency, fiat currency, or the like) to an account holder of the token when a corresponding smart contract (or other programmatic logic) detects a distribution condition (e.g., upon receiving a notification from an oracle that a certain amount of funds were received).

In embodiments, a collection of asset-class backed tokens may be backed by digital land that exists in a virtual reality/metaverse application. The asset-class backed tokens may convey ownership of the digital land, and a smart contract 250 may be configured to collect rent from users of the digital land (e.g., digital operator that may lease the digital land) and/or verify that rent has been paid from the users of the digital land. In these embodiments, the smart contract 250 may be configured to divide the revenue received from the users into portions (e.g., equal portions) corresponding to the issued asset-class backed tokens and to transfer each respective portion to a respective account (e.g., digital wallet) that holds the corresponding asset-class backed token.

In embodiments, a collection of asset-class backed tokens may be backed by one or more real world assets as well as one or more digital twins of real-world assets. For example, the real-world asset may be a specialized machine, factory, energy production facility, rental vehicle, robot, or the like, and the digital twin may allow simulations of the real-world asset (e.g., for predictions, training, modelling, and the like). In this example, the asset-class backed tokens may entitle the token holders to revenues from usage of the real-world asset and revenues from the digital twin of the real-world asset. For example, the digital twin may earn revenues via usage by simulation systems, data analysis systems, AI systems, and/or the like, which may use the digital twin for analysis, data generation purposes (e.g., for generating synthetic AI training data), or the like. This revenue may then be collected by the smart contract (and/or the revenue may be detected via an oracle system) and distributed to the token holders as discussed elsewhere herein.

In some embodiments, a smart contract configured to manage asset-class backed tokens may be configured with voting functions that allow token holders to vote on one or more governance aspects or other decisions related to the one or more asset(s). For example, a configuration function of the smart contract may allow a facility owner or manager to configure a new voting topic (e.g., by signing a transaction that invokes the configuration function and provides argument that configure the vote, which may include a specification of the issue for voting, rules for voting, and various voting options). In these embodiments, the configuration function may be rights-restricted such that it may only be accessible to a particular account holder (e.g., the function invocation may only be effective if signed using the private key of a designated blockchain account, which the smart contract may verify using the public key of the designated blockchain account). Then, each token holder may invoke a voting function, including arguments that specify the issue being voted on and the user's vote. Again, the smart contract may use public/private key cryptography to gate access to the voting function to the holders of the tokens. In an example implementation, a collection of asset-class backed tokens may be associated with a land development project, such that the token holders may collectively manage and/or extract value from the land. For example, a token may be backed by a first asset that corresponds to energy availability of land, a second asset that corresponds to power generation systems on the land, such as solar or wind generation systems, a third asset that corresponds to permitted transmission lines, a fourth asset that corresponds to energy ratings (e.g., green ratings), a fifth asset that corresponds to accessibility or transportation on the land, a sixth asset that corresponds to water rights, and/or the like. In this example, a smart contract 250 may manage a decision-making process for developing the land (e.g., allowing token holders to vote on land usage), generate capital for each of the various project elements (such as by selling tokens), collect and distribute revenues from the land development (including allocating revenues according to token ownership), and/or the like. Various parameters of such tokens may be configured by the token designer, such as ones that align voting rights with capital investment, project timing, and other factors, ones that provide varying economic benefits (such as where revenues or profits are paid out in tranches, such as rewarding preferred returns (optionally including interest payments) to certain token holders that undertake various risks), and the like. In such examples a set of tokens may be configured to give token purchasers varying risk/reward profiles.

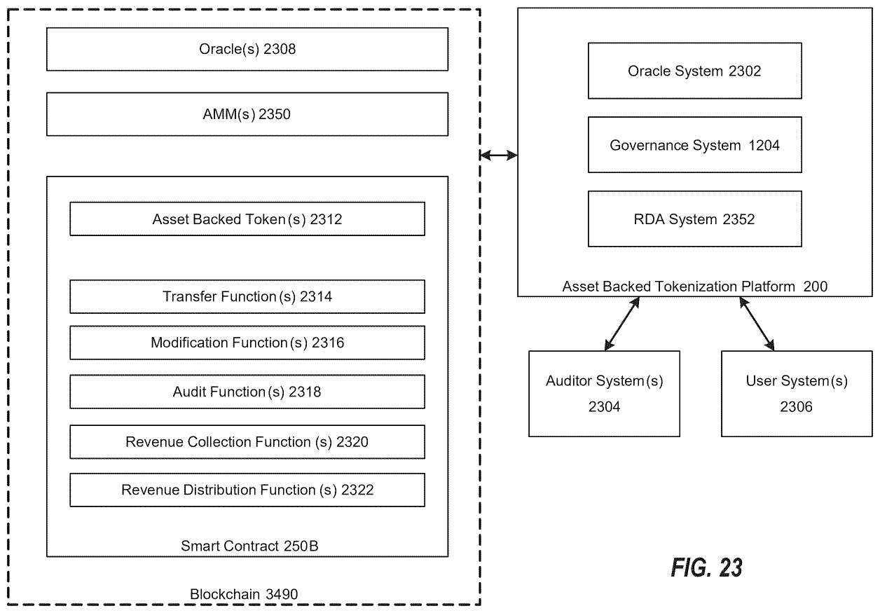

As will be appreciated from the provided examples, one or more smart contracts 250 may be configured with a wide variety of management functions. An example environment including a smart contract 250B configured with several functions that may be useful in a large number of cases is illustrated with respect to FIG. 23. The smart contract 250B may be the same as the smart contract 250A described with respect to FIG. 21 (e.g., the smart contract 250B may include the functions and data of the smart contract 250A or vice versa) or may be a different smart contract.

As shown in FIG. 23, the smart contract 250B may include (e.g., wrap) a plurality of asset-class backed tokens 2312, which may be fungible or non-fungible tokens minted as described elsewhere herein. Each of the wrapped asset-class backed tokens 2312 may be associated with an owner attribute indicating a wallet address (e.g., blockchain address, which may be or be associated with a public cryptographic key of a public/private key pair managed by the owner of the address) for the user that currently owns the asset-class backed token. Additionally or alternatively, the asset-class backed tokens 2312 may be stored elsewhere on the blockchain (e.g., the tokens may not be wrapped by the smart contract 250B). The smart contract 250B may include a plurality of management functions, such as transfer functions 2314, modification functions 2316, audit functions 2318, revenue collection functions 2320, and/or revenue distribution functions 2322, among other management functions. The various functions may be configured to operate based on data associated with one or more oracles 2308, which may be managed by an oracle system 2302 and/or governance system 1204 of the asset-class backed tokenization platform 200 and/or by other systems such as one or more auditor systems 2304.

As an example of use of an oracle system 2302, if the asset-class backed tokens 2312 correspond to a complex project as described according to the first example above, one or more audit functions 2318 and/or revenue collection functions 2320 may be configured to verify receipt of rental income. For example, if rental income is paid off-chain, an auditor system 2304 and/or oracle system 2302 may detect the off-chain rental income, convert any off-chain funds into blockchain funds (e.g., by purchasing fungible tokens via an exchange), and/or update one or more oracles 2308 to indicate the off-chain payment, which may be detected by an audit function 2318 configured to monitor an oracle 2308. Additionally or alternatively, a revenue collection function 2320 may be configured to receive the funds via one or more blockchain transactions. A revenue distribution function 2322 may be configured to divide the received revenue proportionally (or otherwise, such as when users hold different classes of tokens, where some classes of tokens may be associated with different ownership shares, rights to different revenue streams, etc.) among token holders as indicated by address data associated with each asset-class backed token 2312.

In embodiments, the revenue collection function 2320 may receive revenue (or monitor the off-chain receipt of revenue via an oracle) for any of the productive assets that are linked to asset class backed tokens as described herein, including real estate, facilities thereon (e.g., power production or generation, factories, transportation, hotels, toll collectors or other municipal fee generators, etc.), IP rights (e.g., patents, trademarks, copyrighted material, publicity rights, etc.), other rights (e.g., rights to rent or use equipment, rights to display art or other materials, voting rights, other ownership rights, etc.), debt streams (e.g., revenue from loans, including micro financing loans, etc.), sales revenue (e.g., sales of consumer products, commodities, energy, crops, seed, etc.), various other revenue streams (e.g., insurance revenues, crowdfunding revenues, revenues from in-development products, revenues from stocks, bonds, dividends, futures, or other assets), and/or any of the other assets described herein.

In embodiments, any of the functions may modify its operation based on data from oracles 2308. For example, a revenue distribution function 2322 may not distribute revenue until a triggering event has occurred (e.g., a productive asset such as a power plant or any of the other productive or revenue-generating assets disclosed herein begins operating), where the oracle 2308 may store data indicating whether a triggering event has occurred or not based on an indication received from an off-chain system, such as oracle system 2302. Similarly, a revenue collection function 2320 may not require periodic receipt of revenue until a triggering event has occurred. As another example, if a first triggering event occurs (e.g., a productive asset has begun operation) and/or a second triggering event fails to occur (e.g., a revenue collection has not occurred past a deadline date), then a revenue collection function 2320 may perform one or more default actions corresponding to the non-occurrence of the second event (e.g., execute a breach workflow by transferring escrowed funds to the token holders, burning an asset-class backed token held by the breaching party, etc.).

In embodiments, an oracle system 2302 may be configured to monitor a plurality of information sources and to generate and/or configure one or more oracles 2308 based on the information sources. For example, if the asset-class backed tokens are backed by intellectual property assets, the oracle system 2302 may be configured to monitor one or more assignment and/or licensing information sources and to provide data to oracles 2308 indicating the ownership and/or licensing information for the IP rights. For example, when a new licensee is added to the licensing data source, corresponding data indicating the new licensee may be added to an oracle 2308, which may be detected by an audit function 2318. In this example, a revenue collection function 2320 may then begin expecting payment from the new licensee, a modification function 2316 may modify one or more asset-class backed tokens 2312 to indicate the new licensee, and/or the like. Similarly, the oracle system 2302 may monitor an information source that provides sales data for the sales corresponding to the licensed IP rights, and provide such information and/or information indicating required IP royalties to the oracles 2308. An audit function 2318 may then detect the information and configure a revenue collection function 2320 to expect one or more payments corresponding to the royalties by a certain date (e.g., by configuring a breach workflow that may be executed if payment is not received in full). It is appreciated that the oracle system 2302 may be configured to collected additional or alternative data sources in connection with additional or alternative assets. Oracles 2302 may be configured to monitor banking systems, weather feeds, news feeds, social media feeds, government databases, IoT systems, 3^{rd} party data feeds, and/or other suitable data sources. Similarly audit functions 2318 may be configured to monitor data received from any type of oracle 2302 for any suitable condition tied to an asset-class backed token.

In embodiments an oracle system 2302 may comprise or implement a digital twin of a real-world item that is populated at least in part by sensor data that maintains current information about the state of the real-world item, such as its operating status, maintenance condition, location, environmental exposure, production capacity, or any of a wide range of other relevant parameters, such that the smart contract 250B can consume and operate on such information. In some of these embodiments, the digital twin may receive data relating to the state of the real world item and may update the state of the digital twin after processing the received data. For instance, the digital twin may verify the authenticity of the data and preprocess the data (e.g., filter or aggregate the data) prior to updating the state of the real-world item. In embodiments, the digital twin may report some or all of the determined states of the real-world item to a component of the oracle system 2302 that interfaces with the distributed ledger network of nodes. In some embodiments, the digital twin may be configured to interface directly with the distributed ledger network, such that digital twin provides the state information directly to the distributed ledger network.

In embodiments an oracle system 2302 may be embedded or otherwise integrated into a physical item, such as by being installed on information processing infrastructure of the item with access to onboard sensors and diagnostic systems, with access to communications functions (such as to consume information from other items or infrastructure) or the like, and with the capability to process information and publish a stream of information about the physical item, its environment, or the like. The information stream from the embedded oracle 2302 may include various status, operating, capacity, environmental or other information described throughout. In embodiments, the oracle 2302 may be embedded in an item of manufacturing equipment (optionally an additive manufacturing unit), a robot, a vehicle, a mobile device, a personal computer, a wearable device, an augmented reality system, a smart home system, a smart city system, or any of a wide range of products and systems. Thus, in these embodiments, an oracle system 2302 embedded within an item may receive information from one or more sensors onboard the item. The oracle system 2302 may then process the information received from the one or more sensors in various ways (e.g., to update a digital twin, generate a price estimate, or otherwise perform any functions of the oracle system 2302 as described herein) and upload resultant processed information to the blockchain (e.g., to oracles 2308) for any of the use cases described herein.

In embodiments, the oracle system 2302 may be configured to monitor digital environments (e.g., digital land, digital twins, metaverse entities, etc.), and to update one or more oracles 2308 based on the digital environments. Thus, for example, assets backing the tokens may include digital land or use thereof, digital twins or use thereof, and/or other assets that may exist in virtual environments and/or metaverse environments. In embodiments, any of these digital entities may include information about revenue streams (e.g., payments) or other valuation data, which may be used by various functions of the smart contract 250B as discussed elsewhere herein. Additionally or alternatively, the oracle system 2302 may be configured to monitor information sources that provide information about any real-world asset, wherein tangible or intangible (e.g., any of the assets discussed elsewhere herein or any other asset).

In embodiments, user systems 2306 associated with holders of the asset-class backed tokens may have rights to execute various functions of the smart contract 250B. For example, a first token holder may (e.g., by virtue of owning at least one asset-class backed token 2312) call a modification function 2316 that may allow the first token holder to sublicense the token (which may be backed by licensable IP rights) or a subset of the assets backing a token to another user. In this example, when the first token holder calls the modification function 2316, the smart contract 250B may determine that one or more asset-class backed tokens 2312 are assigned to the wallet of the first token holder, and may allow the first token holder to sublicense the asset-class backed tokens to another wallet (e.g., by transferring the asset-class backed token and/or minting a new token for the sublicensee).

In embodiments, a governance system 1204 may configure one or more oracles 2308 to govern the operation of one or more functions. For example, the governance system 1204 may configure an oracle 2308 with eligibility information for controlling a transfer function 2314. The transfer function 2314 may consult the eligibility information before allowing an asset-class backed token to be transferred from a first blockchain address to a second blockchain address. In embodiments, the governance system 1204 may operate in accordance with governance rules 2122 specified in configuration data 2102 (e.g., the governance system 1204 may have received the governance rules 2122 at step 2208 of the method 2200).

As described above, the blockchain 3490 may include one or more automated market makers (AMMs) 2350, which may be embodied (at least in part) as smart contract(s). An AMM 2350 may serve as a decentralized exchange (DEX) on the blockchain 3490 for any of the asset-class backed tokens described herein. Each AMM 2350 may use a smart contract function configured with a formula that can determine (or estimate) prices of one or more assets and/or asset classes that correspond to the asset-class backed token, thereby improving trading and increasing liquidity of the tokens. In some cases, the AMMs 2350 may reduce or eliminate the need for intermediaries (e.g., counterparties for price discovery) and thereby streamline the trading process.

In embodiments, each AMM 2350 may be a smart contract that maintains a liquidity pool. The liquidity pool may include tokenized assets of any type (e.g., fungible tokens, asset-class backed tokens, etc.) depending on the type of AMM and trading pair. In embodiments, these tokens may be provided by liquidity providers (LPs), who may contribute liquidity to the liquidity pool in exchange for trading fees, token rewards, and/or the like. In other words, the AMM 2350 may include a function that accepts contributions from LPs and records the contribution amount and a blockchain address associated with each LP. The AMM 2350 may further include a function for paying out fees and/or rewards upon the occurrence of certain events (e.g., paying out trading fees to the blockchain address of an LP upon occurrence of a trade via the AMM).

In embodiments, as described above, the price function of the AMM 2350 may be based on demand for a particular type of asset-class backed token and/or other analytic metrics associated with use of an asset-class backed token. In these embodiments, the AMM 2350 may obtain dynamic pricing information (e.g., a measure of demand for a type of token) from oracles 2308, which may periodically store updated metrics or other dynamic pricing information on-chain for access by smart contract such as AMMs 2350. Moreover, in embodiments the price function of the AMM 2350 may be based on the outputs of AI models or other machine learning models, which may run off-chain (e.g., on RDA system 2352). Again, in these embodiments, one or more oracles 2308 may periodically store updated information (e.g., updated outputs of AI models running on RDA system 2352) for use by the pricing function of the AMM 2350.

Additionally or alternatively, as described above, different types of AMMs may use different types of price functions. For example, a constant function market maker (CFMM) may use a function that maintains the product of the quantities of two assets of a trading pair as constant, known as constant market depth. Other various functions for different types of AMMs may also be used, some of which are described in more detail above.

In some embodiments, an off-chain RDA system 2352 may operate outside of the blockchain network (e.g., as part of the tokenization platform 200). For example, the RDA system 2352 may implement various AI techniques (e.g., machine learning models) that may be leveraged by price functions of the on-chain AMMs 2350 and/or otherwise provide off-chain computations for the AMMs 2350. This hybrid on/off-chain approach may enable more sophisticated pricing functions with improved transaction speeds and/or lower fees.

In embodiments, oracles 2308 may link the AMMs 2350 with off-chain RDA system 2352, thus enabling information flow between the related on-chain and off-chain components. Thus, for example, the AMM 2350 may use pricing data (e.g., price estimates for real word assets) that is computed off-chain by the RDA system 2352 and uploaded to the chain using the oracles 2308. Additionally or alternatively, the RDA system 2352 may access on-chain data for various tokens (e.g., trading volumes, prices, etc.) and use the on-chain data for off-chain price estimates, training, deployment, and/or refinement of models, or other purposes. In embodiments, the tokenization platform 200 may provide various AMM-related services that may assist users (e.g., blockchain account holders) to more easily interact with the AMMs 2350 on chain. For example, the tokenization platform 200 may generate a graphical user interface that allows users to generate AMM transactions (which may swap one or more first non-fungible tokens or an amount of first fungible tokens for one or more second non-fungible tokens or an amount of second fungible tokens) that invoke the AMM smart contract, transfer first tokens to the AMM, receive second tokens from the AMM, etc. For example, the tokenization platform 200 may receive an AMM trading request from a user associated with a user blockchain account and generate an AMM trading transaction for signature by the user using a private key associated with the blockchain account. Additionally or alternatively, the tokenization platform 200 may send the generated AMM transactions to the user for signature (e.g., using a user's private blockchain key) and/or send the signed AMM transaction to the blockchain (e.g., if a user's wallet does not have functionality to send the signed AMM transaction to the blockchain or the user does not know how to send the signed AMM transaction to the blockchain). Thus, by transmitting the signed AMM trading transaction to the blockchain, the tokenization platform may cause an exchange of tokens using the AMM smart contract based on the trading function.

The tokenization platform 200 may further provide various analytics tools that may analyze blockchain transactions that use of the AMM, such as to measure and/or analyze trading volumes, liquidity pool sizes and/or changes in the liquidity pool, price changes (e.g., based on supply of each token of a trading pair), and/or the like. In these embodiments, the tokenization platform 200 may obtain all transactions or a subset of transactions that invoke AMM trading functions of the AMM smart contract and analyze the transaction data accordingly. In some embodiments, the tokenization platform 200 may retrieve a subset of transactions that take place within a specified time period (or another subset, such as transactions that invoke a particular trading pair, are associated with a particular party, particular transaction size, etc.) and perform one or more analyses thereof.

The tokenization platform 200 may further provide tools and/or user interfaces for assisting users in contributing to liquidity pools and/or providing other liquidity pool functionalities, such as automated rebalancing, yield optimization, implementing loss protection, and/or the like. For example, a graphical user interface generated by the tokenization platform 200 may assist blockchain users to generate and sign liquidity pool funding transactions and/or transactions that otherwise modify or configure the AMM smart contract, broadcast the signed transactions to the blockchain, and/or the like.

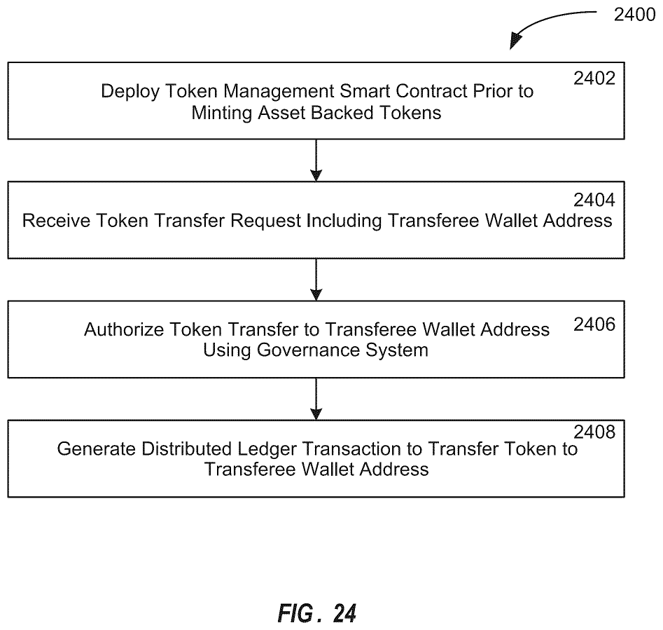

FIG. 24 illustrates an example method 2400 for transferring a token from a first distributed ledger account to a second distributed ledger account. The method 2400 may be performed by an asset-class backed tokenization platform 200 and/or by a token management smart contract 250B. The method 2400 may be used to transfer one or more minted asset-class backed tokens to initial purchasers of the tokens (e.g., a primary sale) and/or to transfer the asset-class backed tokens from one owner to another (e.g., a secondary sale).

At step 2402, the asset-class backed tokenization platform 200 may initially deploy a configured management smart contract (e.g., smart contract 250B and/or any of the smart contracts described above) (e.g., for step 2208). For example, the token management smart contract 250B may be deployed on a distributed ledger (e.g., blockchain) such that it is linked to one or more asset-class backed tokens that it manages. Thus, for example, if the asset-class backed tokens are securities subject to accredited investor requirements or other governance standards, the token management smart contract may be configured to verify that a requested transfer is authorized under the corresponding governance standards (e.g., the transfer function 2314 may be configured to only transfer the token to a new owner if the governance system 1204 authorizes it).

At 2404, the asset-class backed tokenization platform 200 and/or the token management smart contract 250B may receive a token transfer request. For example, a purchasing user and/or a marketplace system may transmit a transfer request using a transfer function (e.g., using a transfer function that is built into the smart contract and/or the blockchain protocol), where the request includes or indicates sufficient fungible tokens for completing the transfer (e.g., an amount equal to a purchase price of the token(s)). The request may further specify a distributed ledger address for a wallet of the purchasing user. Then, at 2406, the asset-class backed tokenization platform 200 and/or the token management smart contract 250B (e.g. via an oracle 2308) may request and receive authorization from the governance system 1204 to transfer the token to the indicated wallet. For example, when the smart contract 250B requests authorization from the governance system 1204, it may do so by storing a query record on the blockchain 3490, which may be discovered by the oracle system 2302 (e.g., because the oracle system 2302 monitors the blockchain 3490). The oracle system 2302 may then communicate with the governance system 1204 to receive the authorization. Upon receiving the authorization, the oracle system 2302 (or another off-chain component of platform 200) may invoke a function of the smart contract 250B that causes the smart contract 250B to proceed with the authorized transaction.

The governance system 1204 may use various rules (e.g., governance rules 2122) and data sources to determine whether to authorize the token transfer request. For example, the governance system 1204 may determine that the wallet is associated with an accredited investor if the total value of the other tokens assigned to the wallet on the distributed ledger are greater than a minimum value or has verified a minimum income requirement. In this regard, the governance system 1204 may consult, for example, marketplace systems and/or valuation systems to determine the value of the tokens associated with the designated wallet. Additionally or alternatively, the governance system 1204 may confirm that the wallet owns an authorization token entitling the wallet to receive the token associated with the token transfer request. Other governance rules may require other forms of verification, whether manual, automated, or semi-automated, before authorizing the token transfer request. In embodiments, the governance system 1204 may use an oracle to store an indication that the transfer is authorized on the distributed ledger. For example, the governance system 1204 may interface with the oracle system 2302 to deploy such an authorization, and the authorization may be detected by the asset-class backed tokenization platform 200 and/or the token management smart contract 250B.

At 2408, after receiving the authorization from the governance system, the asset-class backed tokenization platform 200 and/or the token management smart contract 250B may generate a distributed ledger transaction that transfers the token to the wallet indicated in the transfer token request (e.g., using a transfer function 2314) and broadcast the distributed ledger transaction to a distributed ledger node (e.g., a blockchain node), thereby adding the transaction to the distributed ledger/blockchain.

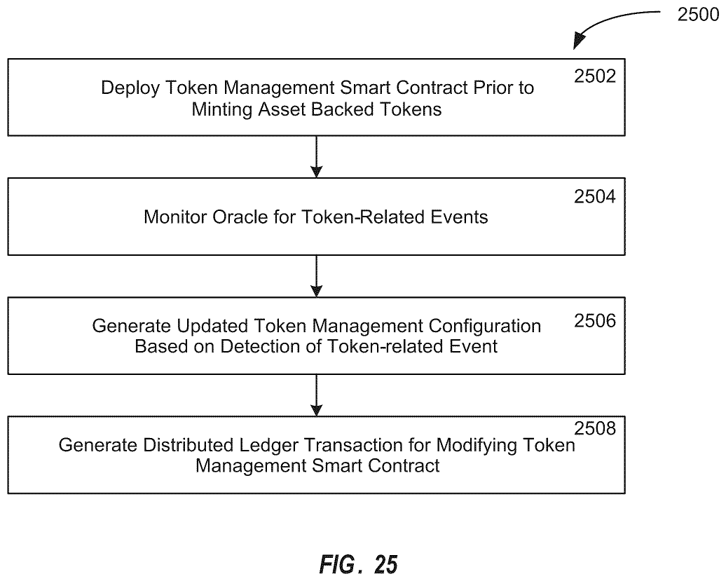

FIG. 25 illustrates an example method 2500 for monitoring one or more oracles for token-related events and updating a token management smart contract accordingly. The method 2500 may be performed by an asset-class backed tokenization platform 200 and/or by a token management smart contract 250B. The method 2500 may be used by dynamic asset-class backed tokens to allow changes based on real world events. As one non-limiting example, the method 2500 may be used to update a token management smart contract for a collection of asset-class backed tokens backed by IP rights when a new licensee takes a license to the IP rights. For example, the token management smart contract may be reconfigured to monitor sales data for the new licensee, receive revenue from the new licensee, and/or distributed the received revenue to token holders.

At step 2502, the asset-class backed tokenization platform 200 may initially deploy a configured management smart contract 250B, as described above (e.g., for step 2208). In the illustrative example where the asset-class backed tokens are backed by licensable IP rights, the token management smart contract may be configured to receive revenue from an initial set of licensees (if any) and distributed the revenue to token holders. Moreover, the token management smart contract may be configured to be updated in response to certain events (e.g., to add additional licensees when a new licensee takes a license). For example, the token management smart contract may be initially configured to monitor an oracle (e.g., as provided by the oracle system 2302) that provides an up-to-date list of licensees and, in response to a new licensee being added, may update the revenue distribution schedule based on the new licensee.

At 2504, the asset-class backed tokenization platform 200 and/or the token management smart contract 250B may monitor a specified oracle that provides data relevant to the management of the asset-class backed tokens (e.g., the updated list of licensees). At 2506, when the asset-class backed tokenization platform 200 and/or the token management smart contract 250B detects a token-related event (e.g., a new licensee or that a previous licensee was removed from the list of licensees), the asset-class backed tokenization platform 200 and/or the token management smart contract 250B may generate an updated token management configuration based on the detection. For example, the updated token management configuration may include the updated list of licensees. Then, at 2508, the asset-class backed tokenization platform 200 and/or the token management smart contract 250B may generate a distributed ledger transaction that updates the token management smart contract with the latest token management configuration (e.g., the current list of licensees, which may be used to configure the token smart contract to check sales data for each of the licensees and receive revenue from each of the licensees) and/or takes action based on the updated configuration data (e.g., sets deadlines to receive revenue from each of the licensees, distributes revenue from each of the licensees, etc.

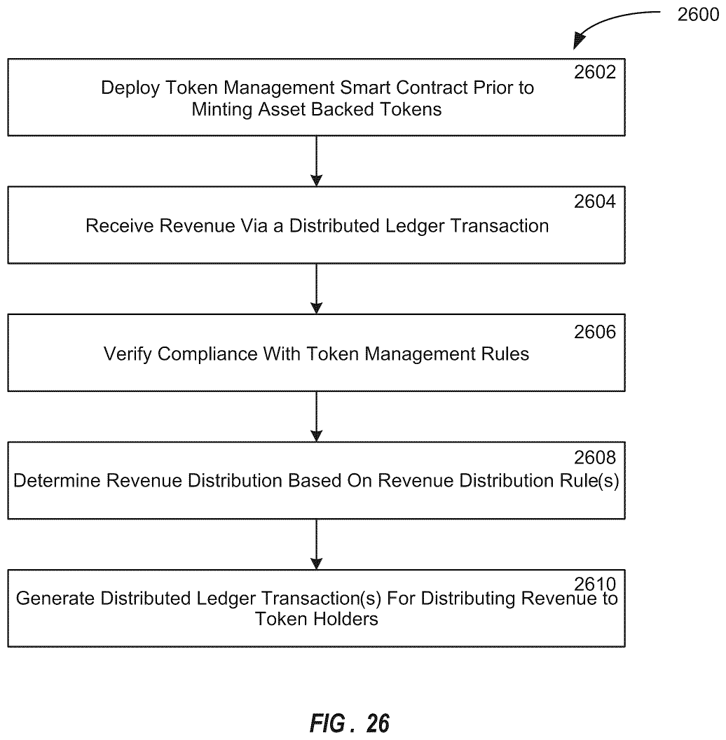

FIG. 26 illustrates an example method 2600 for collecting revenue associated with assets backing the asset-class backed tokens and distributing the revenue accordingly. The method 2600 may be performed by an asset-class backed tokenization platform 200 and/or by a token management smart contract 250B. For example, the method 2600 may be used to receive revenue for a collection of asset-class backed tokens backed by IP rights from each of the licensees of the IP rights, and to distribute the revenues to the token holders accordingly.

At step 2602, the asset-class backed tokenization platform 200 may initially deploy a configured management smart contract 250B, as described above (e.g., for step 2208). In the illustrative example where the asset-class backed tokens are backed by licensable IP rights, the token management smart contract may be configured to receive revenue from licensees and distribute the revenue to token holders. Additionally or alternatively, the method 2600 may be used to manage any token backed by revenue streams in order to collect and distribute the revenue streams in accordance with a token design strategy. For example, the revenue streams may include revenue from a licensee, revenue from a tenant of a property, revenue from a group of tenants (e.g., where each token may correspond to a fraction of revenue across time and/or a set of locations), and/or any other division of any revenue stream.

At 2604, the token management smart contract 250B may receive revenue from a revenue source (e.g., licensee, tenant, group of tenants). For example, the token management smart contract 250B may receive a number of fungible tokens corresponding to an amount owed by a licensee for a certain period as part of one or more distributed ledger transactions. In embodiments, the smart contract 250B may receive revenues over the course of a payment period (e.g., a month), and only proceed with the method once the period has ended (e.g., at the end of the month, the revenues received over the past month may be verified and/or distributed).

At 2606, the token management smart contract 250B may verify compliance with token management rules associated with the received revenue. For example, the token management smart contract 250B may verify that a required amount was received. In example embodiments, each licensee of IP rights (or other revenue source) may be required to submit a certain amount (or percentage of an amount) in a specified period. For example, a licensee may be required to submit a percentage of sales revenue, a tenant may be required to submit an agreed amount of rent, etc. The token management smart contract 250B may determine the owed amount based on data provided via an oracle (e.g., as generated by an oracle system and/or a third party). For example, an oracle 2308 may indicate verified sales revenue figures, leasing agreements, and/or some other indication of how much is owed by each licensee/tenant/etc. In embodiments, this data may be obscured (e.g., encrypted) to prevent access by third parties. For example, the data may be encrypted using a public key associated with the token management smart contract 250B, such that only the token management smart contract 250B may decrypt the data using its corresponding private key.

In embodiments, if the token management smart contract 250B does not receive the amount owed by a revenue source (e.g., licensee, tenant, etc.) by a certain date (e.g., a certain number of days after a revenue collection period expires), it may trigger one or more default/breach provisions for the corresponding revenue source. For example, it may generate a distributed ledger transaction indicating that the licensee or tenant is in default, which may be detected by the asset-class backed tokenization platform 200, which in turn may use one or more manual, semi-automated, and/or automated workflows for processing the default, receiving the owed funds, and/or the like. Additionally or alternatively, the default/breach workflow may involve automatically transferring escrowed funds to token holders, burning tokens held by the breaching party (e.g., licensee tokens authorizing the licensee to make use of the IP rights), and/or the like. In some embodiments, the method 2500 of FIG. 25 may be used to place the debtor back under normal management if the debtor subsequently fulfills its obligations (e.g., by posting an indication of the corresponding event to an oracle and thereby updating the token management smart contract to place the licensee/tenant back under normal management).

At 2608, the token management smart contract 250B may determine a revenue distribution for distributing the received revenue to the holders of the asset-class backed tokens. In embodiments, the revenue may be distributed proportionally to the number of tokens owned by each wallet. Additionally or alternatively, different classes of tokens may receive revenues in varying proportions (e.g., a first-class token may receive a larger percentage of the revenue than a second-class token). Additionally or alternatively, other distribution rules may be used to prioritize or otherwise determine the revenue distribution. Then, at 2610, the token management smart contract 250B may generate one or more distributed ledger transaction(s) that transmit the collected revenue to the various token holders of the asset-class backed tokens according to the determined revenue distribution.

In embodiments, the token management smart contract 250 may distribute the revenues on a periodic basis (e.g., at regular intervals such as monthly, quarterly, etc.) in response to invocations of a distribution function by the tokenization platform 200 or by an oracle system or other system. In other words, the tokenization platform 200 (or other system) may periodically cause revenues collected by the smart contract to be distributed to token holders. Additionally or alternatively, the tokenization platform 200 (or other system) may cause distributions upon the occurrence of asset-related events such as a particular asset having started production (or some other revenue generating activity), stopping production, changing production, and/or the like.

### Token Simulator Example Embodiments

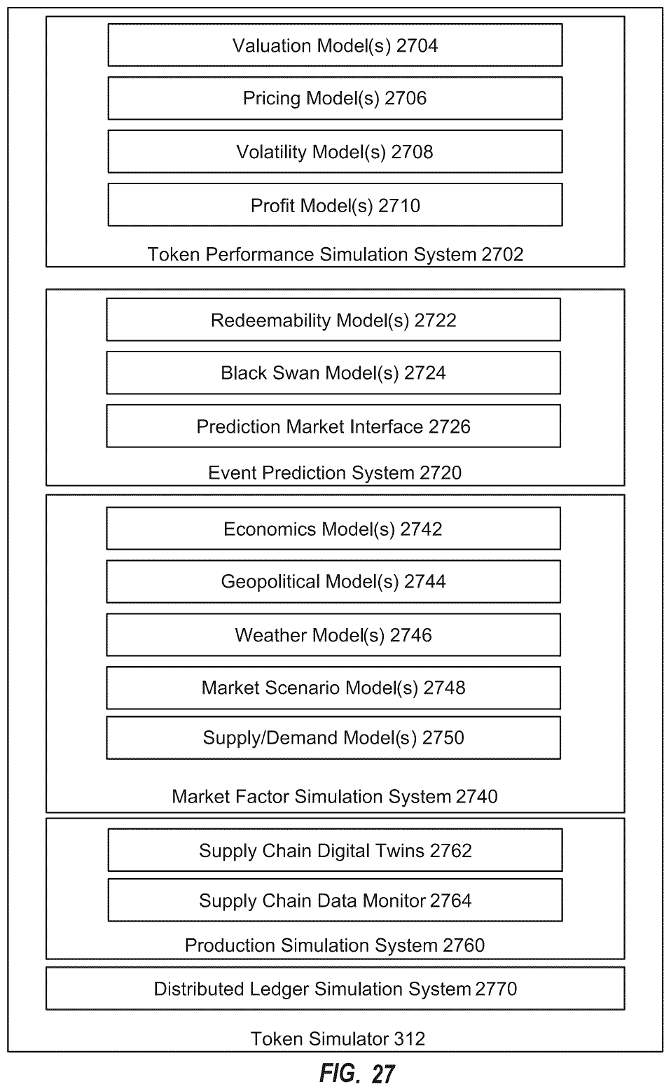

An example embodiment of the token simulator 312 is shown at FIG. 27. The token simulator 312 may include a plurality of systems configured to use various models and/or other data to simulate one or more factors that may affect asset-class backed tokens at a present time and/or in the future. In embodiments, the token simulator 312 may comprise a token performance simulation system 2702 configured to forecast one or more aspects of a token's current and/or future performance, such as a current or future value, a future price, a future volatility, a future profit, and/or the like. Additionally or alternatively, the token simulator 312 may comprise an event prediction system configured to forecast the probability of events that may impact token values, such as redeemability (e.g., whether the asset(s) backing a token may be redeemable at a future date) and/or a likelihood of a black swan event occurring. In some embodiments, an event prediction system 2726 may interface with one or more prediction markets in order to receive prediction market data (e.g., crowdsourced predictions) for future events. In embodiments, the token performance simulation system 2702 may use the event prediction system 2720 to generate token performance forecasts based on various scenarios and their estimated probabilities as predicted by the event prediction system 2720. The token performance simulation system 2702 may include various models, such as a valuation model 2704, a pricing model 2706, a volatility model 2708, and a profit model 2710.

Additionally or alternatively, the token simulator 312 may include a market factor simulation system 2740 configured to forecast various other market factors, such economics (e.g., micro and/or macro) factors, geopolitical factors, weather factors, different market scenarios, supply and demand factors, and/or the like. Additionally or alternatively, the token simulator 312 may include a production simulation system 2760 configured to simulate supply chains or other production systems based on data about inputs, production system capabilities, prices, market forecasts, and/or the like.

In embodiments, a production simulation system 2760 may implement one or more supply chain digital twins 2762 of supply chain components or facilities, which may be used to generate data for simulations by other components and/or to run simulations using the various configured digital twins. For example, the digital twins may include distribution twins (such as representing distribution facilities, assets, objects, workers, or the like); warehousing twins (such as representing warehouse facilities, assets, objects, workers and the like); port infrastructure twins (such as representing a seaport, an airport, or other facility, as well as assets, objects, workers and the like); shipping facility twins; operating facility twins; customer twins (such as representing physical, behavioral, demographic, psychographic, financial, historical, affinity, interest, and other characteristics of groups of customers or individual customers); worker twins (such as representing physical attributes, physiologic data, status data, psychographic information, emotional states, states of fatigue/energy, states of attention, skills, training, competencies, roles, authority, responsibilities, work status, activities, and other attributes of or involving workers); wearable/portable device twins; process twins; machine twins (such as for various machines used to support a value chain network); product twins; point of origin twins; supplier twins; supply factor twins; maritime facility twins; floating asset twins; shipyard twins; destination twins; fulfillment twins; delivery system twins; demand factor twins; retailer twins; ecommerce and online site and operator twins; waterway twins; roadway twins; railway twins; air facility twins (such as twins of aircraft, runways, airports, hangars, warehouses, air travel routes, refueling facilities and other assets, objects, workers and the like used in connection with air transport of products); autonomous vehicle twins; robotics twins; drone twins; and logistics factor twins; among others. Each of these may have characteristics that include mirroring or reflecting changes in states of associated physical objects or other entities, providing capabilities for modeling behavior or interactions of associated physical objects or other entities, enabling simulations, providing indications of status, and many others.

In embodiments, the token simulator 312 may obtain data from various sources for use in simulations. For example, the production simulation system 2760 may include supply chain data monitor 2764 configured to monitor/receive simulation data from various supply chain systems, such as a real time monitoring system (such as onboard monitoring systems for events and status reporting systems on ships and other floating assets, on delivery vehicles, on trucks and other hauling assets, and in shipyards, ports, warehouses, distribution centers and other locations; on-board diagnostic (OBD) and telematics systems on floating assets, vehicles and equipment; systems providing diagnostic codes and events via an event bus, communication port, or other communication system; monitoring infrastructure (such as cameras, motion sensors, beacons, RFID systems, smart lighting systems, asset tracking systems, person tracking systems, and ambient sensing systems located in various environments where value chain activities and other events take place), as well as removable and replaceable monitoring systems, such as portable and mobile data collectors, RFID and other tag readers, smart phones, tablets and other mobile devices that are capable of data collection and the like). The production simulation system may receive simulation data from software interaction observation systems (such as for logging and tracking events involved in interactions of users with software user interfaces, such as mouse movements, touchpad interactions, mouse clicks, cursor movements, keyboard interactions, navigation actions, eye movements, finger movements, gestures, menu selections, and many others, as well as software interactions that occur as a result of other programs, such as over APIs, among many others); mobile data collection systems, visual monitoring systems (such as using video and still imaging systems, LIDAR, IR and other systems that allow visualization of items, people, materials, components, machines, equipment, personnel, gestures, expressions, positions, locations, configurations, and other factors or parameters of entities, as well as inspection systems that monitor processes, activities of workers and the like). The production simulation system 2760 may receive simulation data from point of interaction systems (such as dashboards, user interfaces, and control systems for value chain entities); physical process observation systems (such as for tracking physical activities of operators, workers, customers, or the like, physical activities of individuals (such as shippers, delivery workers, packers, pickers, assembly personnel, customers, merchants, vendors, distributors and others), physical interactions of workers with other workers, interactions of workers with physical entities like machines and equipment, and interactions of physical entities with other physical entities, including, without limitation, by use of video and still image cameras, motion sensing systems (such as including optical sensors, LIDAR, IR and other sensor sets), robotic motion tracking systems (such as tracking movements of systems attached to a human or a physical entity) and many others; machine state monitoring systems (including onboard monitors and external monitors of conditions, states, operating parameters, or other measures of the condition of any value chain entity, such as a machine or component thereof, such as a machine, such as a client, a server, a cloud resource, a control system, a display screen, a sensor, a camera, a vehicle, a robot, or other machine); sensors and cameras and other IoT data collection systems (including onboard sensors, sensors or other data collectors (including click tracking sensors) in or about a value chain environment (such as, without limitation, a point of origin, a loading or unloading dock, a vehicle or floating asset used to convey goods, a container, a port, a distribution center, a storage facility, a warehouse, a delivery vehicle, and a point of destination), cameras for monitoring an entire environment, dedicated cameras for a particular machine, process, worker, or the like, wearable cameras, portable cameras, cameras disposed on mobile robots, cameras of portable devices like smart phones and tablets, and many others, including any of the many sensor types disclosed throughout this disclosure or in the documents incorporated herein by reference); indoor location monitoring systems (including cameras, IR systems, motion-detection systems, beacons, RFID readers, smart lighting systems, triangulation systems, RF and other spectrum detection systems, time-of-flight systems, chemical noses and other chemical sensor sets, as well as other sensors); user feedback systems (including survey systems, touch pads, voice-based feedback systems, rating systems, expression monitoring systems, affect monitoring systems, gesture monitoring systems, and others); behavioral monitoring systems (such as for monitoring movements, shopping behavior, buying behavior, clicking behavior, behavior indicating fraud or deception, user interface interactions, product return behavior, behavior indicative of interest, attention, boredom or the like, mood-indicating behavior (such as fidgeting, staying still, moving closer, or changing posture) and many others); and any of a wide variety of Internet of Things (IoT) data collectors, such as those described throughout this disclosure and in the documents incorporated by reference herein.

In embodiments, the models and systems of the token simulator 312 may use data gathered from a wide variety of sources, including those mentioned above. For example, the various models may be trained based on and/or utilize data including accounting data 3358, access data 3362, asset data 3320, virtual asset tags 3488, worker data 3322, event data 3324, underwriting data 3360, pricing data 3364, claims data 3354, or any other type of data described herein. The data may be collected from various entities 3330 using various monitor and/or data collections systems 3306, 3318. In embodiments, the token simulator 312 may leverage any of the adaptive intelligence systems 3304 described herein to train, develop, deploy, and execute the models.

In embodiments, the token simulator 312 may leverage language models provided by the AI system 1912 to facilitate user interaction with the token simulator 312 and/or understanding of information use as inputs to the token simulator 312 or generated by the token simulator 312. Accordingly, the various inputs and outputs of the token simulator 312 may be provided to the language model as contextual information to allow a user to ask questions about the various inputs, simulations, assumptions, strategies, and/or the like, and to modify various inputs or outputs, at any stage of a token simulator process. Accordingly, a user may interactively adapt input and/or output information to better align with user beliefs or projections, non-public information known by the user, and/or the like. Moreover, the language model may provide explanations of various forecasts, simulations, token data, and/or the like.

Several examples may be useful to illustrate the functionality of the token simulator 312. In example embodiments, a token, or portion thereof, may be redeemable for a future share (e.g., permanent, or for a discrete time period), of the profit that results from the production output of a discrete manufacturing unit, such as a machine on a factory floor, an additive manufacturing unit, a closed environment agricultural system, or many others. In these embodiments, the token simulator 312 may simulate a future profit share of the token, such as by determining an appropriate initial price for the token (e.g., using pricing models 2706 and/or valuation models 2704), the likely generation of profit (e.g., using profit models 2710), and other factors, and thus may enable an understanding of the value of the production output and/or some other value (e.g., for a token that represents a hybrid of asset streams as described in this disclosure). To simulate the value of the production output token, the token performance simulation system 2702, market factor simulation system 2740, and/or production simulation system 2760 may be used. These systems may work separately or together to simulate market pricing for the relevant items that will be produced by the system. For commodity items, the simulation may be based on historical commodity market trends, accounting for relevant market inputs, such as weather (e.g., as indicated by weather models 2746), macroeconomic and/or microeconomic factors (e.g., as indicated by economics models 2742), geopolitical factors (e.g., as indicated by geopolitical models 2744), and others. For non-commodity items, the simulation may account for other factors, such as the pricing of complements, substitutes (which in embodiments may be determined using a similarity clustering model, and the like), which in turn may be based on a demand model that models price elasticity of demand, a supply model that models price elasticity of supply, and the like. In embodiments, a production simulation system 2760 may be configured to model such production-related factors for various non-commodity items. In embodiments, the token simulator 312 may leverage market scenario models 2748, including models that simulate scenarios with market entry by additional competitors, scenarios involving competitive consolidation, scenarios involving market exits, and/or scenarios involving government intervention (e.g., price regulation, funding, and the like), among others. In embodiments, the token simulator 312 (e.g., the production simulation system 2760) may use a cost model that models the cost of components, the cost of production inputs (e.g., raw materials), the cost of operation, the cost of maintenance, and the like. In embodiments, cost information may be aggregated from various third-party data sources (e.g., market reports or pricing streams from proprietary providers or public or government sources), may be entered by one or more experts, may be crowdsourced and/or may be obtained and/or supplemented by sensor data, such as from edge or IoT devices. In these embodiments, the token simulator 312 may regularly collect such data from third party data sources, sensors, and/or the like, and may use the data to regularly re-train and/or update one or more models.

The token simulator 312 may also provide for production simulation using a utilization model (which may include various scenarios, such as for maximum utilization (e.g., where the machine is consistently profitable), partial utilization (such as where use varies based on whether output prices exceed cost of inputs and operating costs, or whether use varies due to other factors, such as availability of operators, availability of inputs, whether the system is working), or the like. Utilization may account for anticipated uptime and capacity, such as determined by an AI system that predicts maintenance and repair needs and the likelihood of an interruption in operations. Production simulation may include simulation based on similar manufacturing systems, such as determined by industry data, by specification information, and/or by operating history by an operator of the same machine or a group of similar machines.

In example embodiments, prediction markets may be leveraged by the token simulator 312 to predict the likelihood of various events. In embodiments, the prediction markets may themselves operate using asset-class backed tokens. For example, an asset-class backed token may be backed by one or more predictions, such as a prediction that a certain event occurs or does not occur by a certain date, a prediction of a number of items produced in a time period by a given manufacturer (e.g., a number of electrical vehicles produced in an upcoming quarter), and/or the like. In these embodiments, the asset may be a synthetic asset that may pay out to token holders based on a prediction made by each token holder and how close the token holder's prediction comes to an actual number. Additionally or alternatively, the market price of the prediction token may indicate a crowdsourced likelihood of an event happening. In these embodiments, prediction tokens may be managed such that token holders may receive a reward for insurance data if a claim is not paid out. Thus, for example, users may be able to crowdsource and fund insurance policies, (e.g., which may otherwise be difficult for emerging asset classes or farmland in developing countries).

In example embodiments, an asset-class backed token may be backed by first user rights for a future special event (e.g., the right to watch a TV show, movie, or other production and/or write a review ahead of its public release, the right to go on a trip, attend a physical event, try various services, make predictions about a lottery or other competition, participate in some venture, etc.). In these embodiments, the asset may exist for the entire duration of the event (e.g., filming of the movie) and the asset owner could have the rights to observe and provide commentary (e.g., pre-reviews without spoilers). In these embodiments, the token simulator 312 may simulate the value of the token based on economic data comprising viewership levels (e.g., for the same or similar shows), social media trend data and/or response data, social media impact scores, and/or the like. In these embodiments, the token simulator 312 may use one or more AI models trained to predict a likely change in social media followers based on the purchase of the asset-class backed tokens and associated rights. For example, various market scenario models 2748 and/or other models may be used for social media impact prediction and/or to make other predictions. The token simulator 312 may use multiple prediction models in various ways. For example, a first model may be used to predict the impact on viewership of the future event and/or a financial impact of the change in viewership. A second model may then be used to predict the impact on followers of a social media influencer that purchases the token/rights and/or the financial impact on the change in followers on the influencer, and/or the like. The model outputs may be used for different purposes by various users of the token simulator 312. For example, an event organizer or rights holder may use the first model to set a floor price for the corresponding asset-class backed token, and potential purchasers may use the second model to determine whether to bid on and/or purchase the asset-class backed token.

In example embodiments, a token simulator 312 may simulate a distributed ledger using a distributed ledger simulation system 2770. For example, the distributed ledger simulation system 2770 may be configured to use the structure and rules of a corresponding distributed ledger (e.g., proof of work, proof of stake, delegated proof of stake). Moreover, the distributed ledger simulation system 2770 can operate with variability in function based on actual existing distributed ledger (e.g., the distributed ledger(s) on which the token exists or will exist). The simulation may further account for other factors such as block creation time, on-chain transaction limits, available transaction throughput, and/or the like. In embodiments, the distributed ledger simulation system 2770 may provide a parallel operating distributed ledger with adjustable variables. Such a simulation system 2770 may be used to simulate the performance of tokens that are backed by specifically correlated items (e.g. gasoline/diesel/electricity/shipping costs/travel costs) and their various complementary/correlated elasticities. For example, such a simulation system 2770 may simulate answers as to whether, for example, as gasoline prices go up, hotel costs go up or down in general and/or in specific areas (e.g. outside of metro areas), or how gasoline costs may impact demand of product sales (e.g., electrical vehicle vs internal combustion engine vehicle sales). In these embodiments, the distributed ledger simulation system 2770 may use data indicating various dependent and independent variables depending on the simulation (e.g., gasoline costs/barrels, diesel, electricity markets, vehicle sales data, hotel costs and hotel classifications, vacation rental data, shipping costs for USPS, UPS, FedEx, DHL, Amazon, Walmart, etc., sentiment data from logistics company executives, weather data, geopolitical impact predictions, and/or the like. In this regard, the distributed ledger simulation system 2770 may leverage other system and/or models of the token simulator 312, such as various economics models 2742, geopolitical models 2744, weather models 2746, market scenario models 2748, and/or the like. Moreover, the distributed ledger simulation system 2770 may use various AI and/or ML techniques to detect and analyze correlations between specific pairs/triplets and to identify new correlations. For example, the models may be seeded with known impacts and then trained to find additional patterns. In these embodiments, simulated tokens may include any tokens backed by the various assets described herein, including commodities futures, ownership shares in hotels/hotel chains/fractional ownership in lodging across a region, car dealership ownership/profit-sharing tokens (e.g., tied to a region, brand, etc.), or any other such assets.

In example embodiments, a token simulator 312 may be used to simulate the market value and demand of an upcoming technical consumer product ahead of its launch. The token simulator 312 may use such predictions to value and/or other simulate the impact of one or more asset back tokens corresponding to the upcoming technical consumer product. For example, the token simulator 312 may use one or more supply and/or demand models 2750 and/or other models to simulate various aspects. The simulator 312 may use a production simulation system 2760 to simulate, for example, a supply chain and manufacturing process using models based on availability raw materials, extraction, manufacturing (e.g., semiconductor fabrication), assembly, and/or shipment. In embodiments, the simulator 312 may further simulate (e.g., using the market factor simulation system 2740) the cost, complexity, timeliness, and predictability of product development. In embodiments, the simulator 312 may further use demand models 2750 to model demand in the consumer market (e.g., size, elasticity, seasonal fluctuations, dependency on add-on products or consumables, dependency on substitutes in adjacent markets). In embodiments, the simulator 312 may simulate the speed of innovation in the consumer market (e.g., whether the relevant field is associated with slow and/or predictable innovation, like storage, or a technology frontier with rapid and potentially disruptive innovation, like extended reality environments and hardware.) In embodiments, the simulator 312 may simulate a magnitude of competition in the consumer market (e.g., whether the market is already occupied by large companies, vs. startups, whether the market is a high-visibility market with broad appeal, like gaming consoles, or a niche market with narrow appeal, like 3D printing, etc.)

In example embodiments, the simulator 312 may further simulate different tokens that are backed by different assets associated with the technical consumer products. For example, a first potential asset-class backed token may be backed by revenue from consumer sales of the technical product. A second potential asset-class backed token may be backed by revenue from consumer subscriptions, a third by revenue from add-on products and services, a fourth by revenue from third parties, a fifth by licensing revenue for IP associated with the product, etc. Additionally or alternatively, tokens may be backed by a mix of various of these or other assets associated with the technical consumer product. The simulator 312 may simulate the various beneficial characteristics of each type of asset performance, such as one-time revenue, ongoing revenue, volatility, sensitivity to popularity or network effects, sensitivity to accumulating momentum of the product, sensitivity to competing products, dependency on ongoing development of the product, etc. The simulator 312 may further simulate how each kind of beneficial characteristic responds differently to market conditions, such as hot vs. cool economies, variable rates of inflation, supply chain disruptions, battles over IP ownership and dominance, geopolitical events such as tariffs, climate change affecting resource availability, etc. The simulator 312 may use models that may be developed based on a vast amount of historic data from comparable markets, as well as various econometrics models.

In example embodiments, the token simulator 312 may provide simulations of micro-financing for a token representing a partial ownership and/or financing of a student class, group of developers, group of innovators, etc. (e.g., revenues collected by selling the tokens may be used to fund student aid/tuition and represent a fractional ownership of some future output of the students in that class, such as a portion of a future salary, ownership of IP developed by students, developers, innovators, etc.). In these embodiments, the simulator 312 may use data indicating a class make-up, generate economic predictions, model probabilities of future employment by student(s), predict licensing potential of future IP, model a cost of IP portfolio development and/or a probability of acquisition, and/or the like.

In example embodiments, the token simulator 312 may provide simulations for renewable energy tokens backed by assets representing the electrical output from renewables installations. In these embodiments, the simulator 312 may simulate aspects of a future climate, consumer demand, output from different types of renewables, and/or the like, and may model the performance of various bundles or mixes of renewables corresponding to different types of installations (e.g., solar, wind, hydro, etc.) in order to simulate the performance of different types of tokens backed by different types of renewables assets.

In example embodiments, the token simulator 312 may provide simulations for logistics tokens representing the right to move a certain weight and/or volume of goods from one location to another within a prescribed time window. In these embodiments, the token may be backed by a door-to-door shipping service that may include packing, transport, insurance, bills of lading, etc. Additionally or alternatively, the token may be associated with futures that may be used to hedge shipping costs for needed routes/weights/volumes of goods. In these embodiments, the simulator 312 may ingest historical transport market data to various shipping mechanisms (e.g., air, land, sea routes) and simulate the pricing and/or performance of the tokens.

In example embodiments, the token simulator 312 may provide simulations for healthcare tokens backed by a care package that represents medical services that may be used to care for certain conditions or groups of conditions, such that the token may act as health insurance. The token simulator 312 may simulate current and future market conditions, cost of medications, cost of medical services, and/or the like in order to value the tokens, and may simulate patient projected costs based on age, health, likelihood of needing services, etc. for potential purchasers of the tokens.

Thus, as will be understood from the foregoing examples, the token simulator 312 may simulate performance for a wide variety of applications by using different models and configurations that may vary depending on the asset backing any given token. In embodiments, general models may be reusable across a wide variety of tokens (e.g., economics models, geopolitical models, generative AI models, etc.), while certain models may need to be tailored to a specific type of asset (e.g., a valuation model for one type of asset may be very different from a valuation model for another type of asset, reflecting different use cases of the asset, different dependencies, and/or the like). The different tailored models may be developed and supplied by interested parties (e.g., token holders that wish to simulate performance of a certain type of asset), and/or may be developed by the token simulator 312 using different tailored data sets. Thus, by configuring a token simulator 312 to operate with both reusable and tailored models, the token simulator 312 may be operable to simulate performance across a wide variety of asset classes while maximizing reusability of data and models where possible.

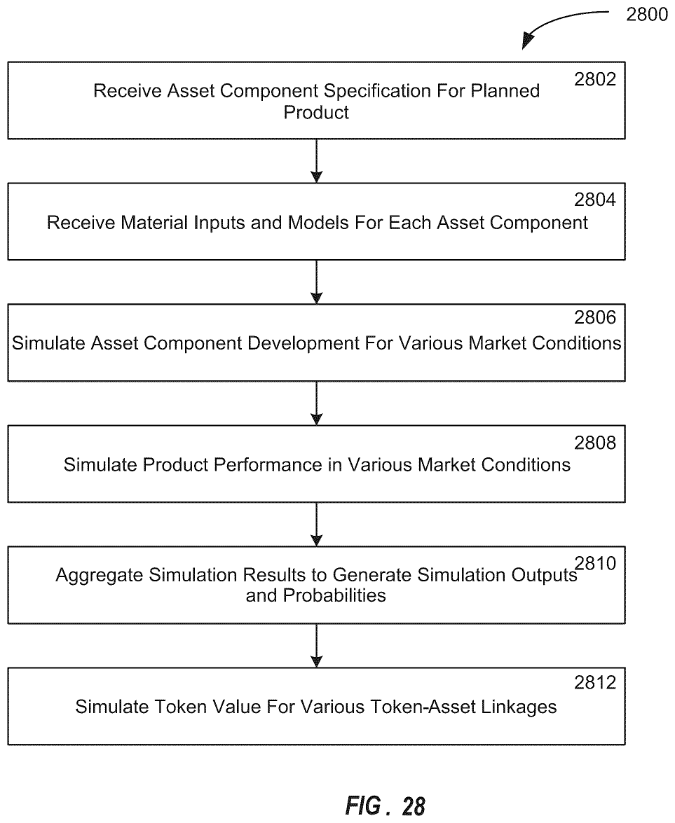

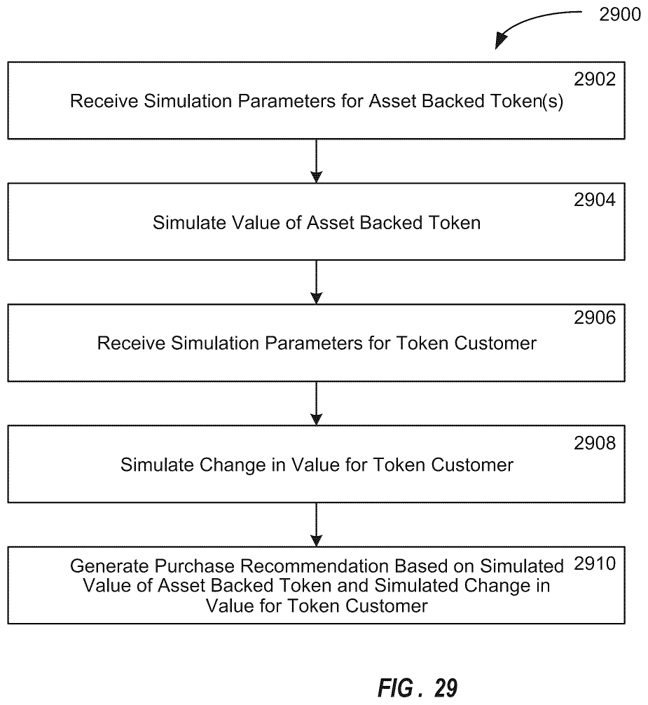

In embodiments, the token simulator 312 may be configurable to use different workflows for various applications. Two example workflows are described with respect to FIGS. 28 and 29. FIG. 28 illustrates an example method 2800 of using a token simulator 312 to predict a value of a set of asset-class backed tokens corresponding to a planned technology product. At 2802, the token simulator 312 may receive (e.g., via the token simulator interface 340) a specification of components of the planned technology product, such as a display, speakers, processor, memory, storage, network adapter, chassis/enclosure, software, and/or the like. For example, a designer of the product may provide various specifications for each component, whether hardware (e.g., a type of processor to be developed, a planned manufacturer of the processor, etc.) or software (e.g., an operating system and/or applications to be developed).

At 2804, the token simulator 312 may receive (e.g., via the token simulator interface 340) one or more material inputs and/or development models for each component. For example, raw materials and/or upstream components for a planned processor may be identified and a model that simulates the development of the processor (e.g., based on various inputs) may be provided. In this example, the model inputs may be raw materials, labor, other components (e.g., including price and supply factors), and/or the like. In embodiments, the raw materials or component specifications may be generated by generative AI models (e.g., based on user descriptions of the product provided via the token simulator interface 340). The models may output a projected development time and/or cost, or otherwise be configured to simulate a development process for the various necessary components of the product and/or the product as a whole.

At 2806, the token simulator 312 may use the provided models and/or other models (e.g., various market scenario models 2748) to simulate development of the various components and the product as a whole in various market conditions. For example, the token simulator 312 may use various economics models 2742 to estimate the cost of labor, raw materials, or other inputs. In embodiments, the range of economic estimates output by the economic models 2742 may vary based by the outputs of geopolitical models 2744, weather models 2746, black swan models 2724, and/or the like that may predict events and/or trends that may impact supply chains, labor costs, and/or the like. In other words, the outputs of various of the token simulator models may be used as inputs to other models, such that detailed predictions of the likelihood of various market conditions may be generated, and the development costs and/or times may be simulated for a representative range of the various market conditions. At 2808, the token simulator 312 may then simulate the performance (e.g., sales volume) of the planned technology product in various market conditions based on various product-specific factors such as the type of product, the projected capabilities of the product as compared to other products in the same field, the software available for use via the product, and/or the like. In embodiments, the token simulator 312 may execute simulations using a digital twin, whereby the digital twin is configured with the appropriate libraries and behaviors to run financial simulations. In some of these embodiments, the token simulator 312 may leverage a digital twin system to perform such simulations, as described elsewhere in the disclosure.

At 2810, the token simulator 312 may aggregate the various scenarios to generate various simulation outputs and/or probabilities for each simulation output. In embodiments, the simulation outputs may include best-case value outcomes corresponding to the various market conditions, which may reveal which market conditions are most important for achieving the best-case outcomes. Similarly, the outputs may include worst-case value outcomes corresponding to the various market conditions, revealing which market conditions are most detrimental to outcomes. Additionally or alternatively, the token simulator 312 outputs may reveal the components that most strongly affect performance (e.g., processors, software) based on the various simulations and market outcomes.

At 2812, the token simulator 312 may simulate a value of a set of asset-class backed tokens that may be linked to the simulated product in various ways. For example, the token simulator 312 may simulate the value of the tokens backed by a percentage of revenue from the sale of the technology product, tokens backed by a percentage of fees paid by software developers to feature their software on the product, tokens backed by a percentage of subscription revenue from consumers paid in relation to the product, and/or various combinations of these and/or other asset-token linkages. Thus, by comparing the various methods of constructing asset-class backed tokens, the product developer may be able to determine the most profitable way to raise capital for the development of the product.

FIG. 29 illustrates an example method 2900 of using a token simulator to predict a value of a set of asset-class backed tokens to a minter of the tokens and to predict a value of the asset-class backed tokens to a purchaser of the tokens in order to generate a purchase recommendation. The method 2900 may be particularly applicable when the value of an asset may be highly variable for different purchasers, such as IP rights (which may be much more valuable to a customer that efficiently or effectively uses the IP rights) or healthcare insurance (which may be much more valuable to a purchaser that is likely to have healthcare needs), to provide just two specific examples. However, it will be appreciated that the method 2900 may be used in a wide variety of use cases for various tokens backed by various assets in different ways, as described in detail herein.

At 2902, the token simulator 312 may receive simulation parameters for a set of asset-class backed tokens backed by one or more types of assets. In embodiments, the simulation parameters may specify the assets and their linkage to the asset-class backed tokens (e.g., the rights that are obtained by owning the token, the required purchase price of the asset-class backed tokens, any ongoing royalties due from exploitation of the assets, any payments owed to the token holders, and/or the like). Additionally or alternatively, the simulation parameters may include one or more models that may be used by the token simulator 312 to simulate the value of the asset-class backed tokens. According to an example embodiments, the simulation parameters may specify data for a set of IP rights, including a current number of licensees, an established royalty rate, a total addressable market, and/or the like. Additionally or alternatively, the simulation parameters may include a model trained to calculate a value of IP rights based on various input parameters, which may include the specified parameters, derivatives thereof, and/or other inputs that may be generated by the token simulator 312 (e.g., projected market growth or contraction figures, impacts of supply chain issues, etc.).

At 2904, the token simulator 312 may simulate the value of the asset-class backed token based on the simulation parameters. For example, the token simulator 312 may use a valuation model that may be trained to project revenues associated with assets (e.g., IP rights). In embodiments, multiple simulations may be generated for different market scenarios (e.g., average market growth, contraction, supply chain restrictions, etc.) based on projections generated using other models of the token simulator 312, and the results may be aggregated based on a likelihood of each scenario.

In some embodiments, the token simulator 312 may leverage generative AI models to generate market scenarios or estimates, including by performing automatic summarization of market forecast reports generated by third parties, assigning numeric estimates to various text-based predictions, and/or otherwise processing market forecasting data or other simulation data into a format usable by the token simulator 312. In embodiments, the valuation model may take into account the various projected uses of the asset by potential purchasers of the asset, some of which may be generated by generative AI models.

In embodiments, the simulated value of the asset-class backed token may be provided to token holders or other rights holders for the purpose of pricing the corresponding asset-class backed tokens. Additionally or alternatively, the simulated value may be automatically used (e.g., by an automated token marketplace) to set a sales price and/or floor price for the asset-class backed tokens.

At 2906, the token simulator 312 may receive simulation parameters from a potential purchaser of the asset and/or asset-class backed token. The simulation parameters may specify parameters about the purchaser and/or the purchaser's intended use of the asset. For example, if the asset-class backed token confers an IP license, the simulation parameters may indicate how the purchaser plans to use the license (e.g., a number of products the purchaser wishes to manufacture using the license, a planned sales price of the product, a planned marketing budget of the product, a current social media following of the purchaser, etc.).

At 2908, the token simulator 312 may simulate a change in value for the potential purchaser based on the intended use of the asset. For example, the token simulator 312 may project revenues from the intended use of the license, a projected market share for the product, a change in social media following for the purchaser, and/or the like. In some of these embodiments, the token simulator may leverage generative AI models to generate estimates for these changes.

At 2910, the token simulator 312 may generate a purchase recommendation if the projected value for the token purchaser exceeds (e.g., by more than a threshold amount or percentage) the current and/or simulated value of the asset-class backed tokens. Additionally or alternatively, the token simulator 312 may output an indication of the amount by which the simulated change in value exceeds the purchase price of the token, representing the projected increase in value to the purchaser of buying the asset-class backed token.

The various embodiments envision a microservices architecture with many platform components that correspond to the many components disclosed herein for many different lending use cases.

In embodiments, various use cases include the platform being a general-purpose provider across asset classes to back tokens including precious metal-backed tokens, fiat currency backed tokens, real estate backed tokens, and IP-backed tokens (for large IP holders-patents; royalties; brand; publicity rights). In these embodiments, the platform can further leverage blockchain for knowledge functionality as described elsewhere in this disclosure and the documents incorporated by reference herein.

In embodiments, an asset-class backed token may comprise a token that represents a specific production capacity of a machine or system, such as the energy produced by a generator or turbine, such that the token holder may buy, sell, redeem, lend, borrow (such as using the token as collateral) or undertake other transactions that involve the token as a representation of the nominal and/or actual physical capacity of the machine. The token, as with other tokens referenced herein, may be for a fractional share of the production, which may be a fungible fractional share or a non-fungible fractional share (such as representing a specific time period of production and/or a specific amount of capacity, such as the production of a given unit amount of energy. Production capacity may involve all kinds of productions, including energy production, heat production, material production, goods production, services production (where machines or systems produce services, such as in an “as-a-service” business model, and many others.

In various embodiments described herein, artificial intelligence (of various types disclosed throughout this disclosure, including machine learning, natural language processing, robotic process automation, and many others) can be used to improve the performance of and/or extend the capabilities of an asset class-backed tokenization platform. For example, a generative AI system (such as using a set of large language models, a set of transformer models, or the like) may be used to generate content related to the tokens and/or the underlying asset class, such as to improve understanding or save time for a token designer and/or end user. Also, robotic process automation may be trained on a training data set of token discovery tasks, token design tasks, token configuration tasks, token deployment tasks, or other tasks performed by a token designer in the platform in order to undertake and/or recommend actions (which may be supervised, semi-supervised, or autonomous) and in turn may be further optimized by deep learning, such as on outcomes from the platform. Further, AI may be used to learn on outcomes to adjust smart contract configurations, token economic parameters, and other configurable elements of the platform.

In embodiments, methods and systems herein include a platform for enabling transactions wherein a set of tokens is generated and linked to an alternative asset class, such that the value of a token in the set represents a defined unit of the alternative asset class.

In embodiments, methods and systems herein include a platform for enabling transactions wherein a set of tokens is generated and linked to an alternative asset class, such that the value of a token in the set represents a defined unit of the alternative asset class, wherein the token is a non-fungible token that represents a specific unit of the alternative asset class.

In embodiments, methods and systems herein include a platform for enabling transactions wherein a set of tokens is generated and linked to an alternative asset class, such that the value of a token in the set represents a defined unit of the alternative asset class wherein a token is a fungible token that represents an amount of the alternative asset class.

In embodiments, methods and systems herein include a platform for enabling transactions wherein a set of tokens is generated and linked to an alternative asset class, such that the value of a token in the set represents a defined unit of the alternative asset class wherein a token represents an indexed value of the alternative asset class.

In embodiments, methods and systems herein include a platform for enabling transactions wherein a set of tokens is generated and linked to an alternative asset class, such that the value of a token in the set represents a defined unit of the alternative asset class wherein the set of tokens represent fractional ownership interests of units of the alternative asset class.

In embodiments, methods and systems herein include a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing.

In embodiments, methods and systems herein include a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing.

In embodiments, methods and systems herein include a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile.

In embodiments, methods and systems herein include a platform for enabling transactions wherein a set of tokens is generated and linked to an alternative asset class, such that the value of a token in the set represents a defined unit of the alternative asset class, having a digital twin system for representing a set of parameters of the tokens and the alternative assets that back the tokens.

In embodiments, methods and systems herein include a platform for enabling transactions wherein a set of tokens is generated and linked to an alternative asset class, such that the value of a token in the set represents a defined unit of the alternative asset class, having a data collection system for automatically collecting information about the alternative assets that back the tokens.

In embodiments, methods and systems herein include a platform for enabling transactions wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price.

In embodiments, methods and systems herein include a platform for enabling transactions wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, methods and systems herein include a platform that deploys smart contracts for managing tokens linked to an alternative asset class, wherein the smart contracts manage access to the alternative asset.

In embodiments, methods and systems herein include a platform that deploys smart contracts for managing tokens linked to an alternative asset class, wherein the smart contracts manage trading of the tokens.

In embodiments, methods and systems herein include a platform that deploys smart contracts for managing tokens linked to revenue streams, wherein the smart contracts collect and distribute revenue to token holders.

In embodiments, methods and systems herein include a platform that automatically identifies sets of assets that correspond to a strategy and generates tokens linked to the sets of assets.

In embodiments, methods and systems herein include a platform that automatically identifies sets of assets that correspond to a strategy and generates tokens linked to the sets of assets, wherein the platform further simulates the future performance of the tokens and optimizes the sets of assets in accordance with the simulated performance.

In embodiments, methods and systems herein include a platform that automatically identifies assets based on a set of user priorities, identifies and resolves conflicts among the user-defined priorities, and generates tokens linked to the assets in accordance with the priorities.

In embodiments, methods and systems herein include a platform that deploys a smart contract for automatically minting tokens linked to recurring assets according to a minting schedule.

In embodiments, methods and systems herein include a platform for crowdfunding asset purchases and automatically minting tokens linked to the asset purchases.

In embodiments, methods and systems herein include a platform that provides distributed ledger oracles with information that modifies the operation of smart contracts used to manage asset-class backed tokens.

In embodiments, methods and systems herein include a platform that simulates the future value of tokens linked to sets of related assets corresponding to a productive asset.

In embodiments, methods and systems herein include a platform that simulates the future value of tokens linked to sets of related assets corresponding to IP rights.

In embodiments, methods and systems herein include a platform that simulates the future value of tokens linked to sets of related assets in accordance with one or more predicted events, market factors, or production simulations.

In embodiments, methods and systems herein include a platform that simulates the future value of tokens used to raise capital for a consumer product.

In embodiments, methods and systems herein include a platform that simulates the future value of tokens used to raise capital for a consumer product.

In embodiments, methods and systems herein include a platform that simulates the value of tokens backed by IP rights and the projected value of the token to a specific purchaser.

In some embodiments, methods and systems herein include a platform that generates and manages asset-class backed tokens corresponding to a plurality of complex projects in order to diversify risk, reduce potential volatility in revenue, provide more predictable valuation growth, and/or provide increased upside by focusing on earlier stage projects.

In some embodiments, methods and systems herein include a platform for tokenizing a value stream of rental or lease income from a tenant across a period of time and/or set of locations.

In embodiments, methods and systems herein include a platform for enabling transactions includes a NFT or other token for a stream of energy from a specific asset. In embodiments, provided herein is a platform for enabling transactions wherein a set of tokens is generated and linked to an alternative asset class, such that the value of a token in the set represents a defined unit of the alternative asset class. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, wherein the token is a non-fungible token that represents a specific unit of the alternative asset class. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class wherein a token is a fungible token that represents an amount of the alternative asset class. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class wherein a token represents an indexed value of the alternative asset class. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class wherein the set of tokens represent fractional ownership interests of units of the alternative asset class. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class wherein a token is a fungible token that represents an amount of the alternative asset class. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class wherein a token represents an indexed value of the alternative asset class. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class wherein the set of tokens represent fractional ownership interests of units of the alternative asset class. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, wherein the token is a non-fungible token that represents a specific unit of the alternative asset class and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class wherein a token represents an indexed value of the alternative asset class. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class wherein the set of tokens represent fractional ownership interests of units of the alternative asset class. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class wherein a token is a fungible token that represents an amount of the alternative asset class and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class wherein the set of tokens represent fractional ownership interests of units of the alternative asset class. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class wherein a token represents an indexed value of the alternative asset class and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class wherein the set of tokens represent fractional ownership interests of units of the alternative asset class and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, wherein the alternative asset class is one or more of a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing. In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class is a blended asset class of at least two assets among a data stream, a revenue stream, an energy stream, a future income stream, a future production capacity, a future intellectual property capacity, and a future or derivative of any of the foregoing and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile. In embodiments, provided herein is a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile and wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, having a set of interfaces for designing a token that represents a set of alternative assets that are blended by a user of the interface to provide a targeted risk/return profile and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, having a digital twin system for representing a set of parameters of the tokens and the alternative assets that back the tokens. In embodiments, provided herein is a platform for enabling transactions wherein a set of tokens is generated and linked to an alternative asset class, such that the value of a token in the set represents a defined unit of the alternative asset class, having a digital twin system for representing a set of parameters of the tokens and the alternative assets that back the tokens and wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class, having a digital twin system for representing a set of parameters of the tokens and the alternative assets that back the tokens and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, having a digital twin system for representing a set of parameters of the tokens and the alternative assets that back the tokens and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, having a data collection system for automatically collecting information about the alternative assets that back the tokens. In embodiments, provided herein is a platform for enabling transactions wherein a set of tokens is generated and linked to an alternative asset class, such that the value of a token in the set represents a defined unit of the alternative asset class, having a data collection system for automatically collecting information about the alternative assets that back the tokens and wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, having a data collection system for automatically collecting information about the alternative assets that back the tokens and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price. In embodiments, provided herein is a platform for enabling transactions wherein a set of tokens is generated and linked to an alternative asset class, such that the value of a token in the set represents a defined unit of the alternative asset class, having an analytic system for calculating and outputting a set of measures that represent parameters of the alternative assets that back the tokens, wherein the measures represent one or more of a price, a value, a volatility, a risk measure, a trading measure, a future price, an option price, and a derivative price and wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

In embodiments, provided herein is a platform for enabling transactions wherein a set of tokens is generated and linked to an alternative asset class, such that the value of a token in the set represents a defined unit of the alternative asset class, having an analytic system for calculating and outputting a set of measures that represent parameters of the tokens, wherein the set of measures includes one or more of a token price, a token value, a token volatility, a token trading velocity, a token future price, a token risk measure, a token derivative price, and a token option price.

The background description is presented simply for context, and is not necessarily well-understood, routine, or conventional. Further, the background description is not an admission of what does or does not qualify as prior art. In fact, some or all of the background description may be work attributable to the named inventors that is otherwise unknown in the art.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

Physical (such as spatial and/or electrical) and functional relationships between elements (for example, between modules, circuit elements, semiconductor layers, etc.) are described using various terms. Unless explicitly described as being “direct,” when a relationship between first and second elements is described, that relationship encompasses both (i) a direct relationship where no other intervening elements are present between the first and second elements and (ii) an indirect relationship where one or more intervening elements are present between the first and second elements.

Example relationship terms include “adjoining,” “transmitting,” “receiving,” “connected,” “engaged,” “coupled,” “adjacent,” “next to,” “on top of,” “above,” “below,” “abutting,” and “disposed.”

The detailed description includes specific examples for illustration only, and not to limit the disclosure or its applicability. The examples are not intended to be an exhaustive list, but instead simply demonstrate possession by the inventors of the full scope of the currently presented and envisioned future claims. Variations, combinations, and equivalents of the examples are within the scope of the disclosure.

No language in the specification should be construed as indicating that any non-claimed element is essential or critical to the practice of the disclosure.

The term “exemplary” simply means “example” and does not indicate a best or preferred example.

The term “set” does not necessarily exclude the empty set—in other words, in some circumstances a “set” may have zero elements. The term “non-empty set” may be used to indicate exclusion of the empty set—that is, a non-empty set must have one or more elements.

The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The phrase “at least one of A, B, and C” should be construed to mean a logical (A OR B OR C), using a non-exclusive logical OR, and should not be construed to mean “at least one of A, at least one of B, and at least one of C.”

The use of the terms “a,” “an,” “the,” and similar referents in the context of describing the disclosure and claims encompasses both the singular and the plural, unless contradicted explicitly or by context.

Unless otherwise specified, the terms “comprising,” “having,” “with,” “including,” and “containing,” and their variants, are open-ended terms, meaning “including, but not limited to.”

Each publication referenced in this disclosure, including foreign and domestic patent applications and patents, is hereby incorporated by reference in its entirety.

Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of multiple embodiments remain within the scope of this disclosure.

One or more elements (for example, steps within a method, instructions, actions, or operations) may be executed in a different order (and/or concurrently) without altering the principles of the present disclosure.

Unless technically infeasible, elements described as being in series may be implemented partially or fully in parallel. Similarly, unless technically infeasible, elements described as being in parallel may be implemented partially or fully in series.

While the disclosure describes structures corresponding to claimed elements, those elements do not necessarily invoke a means plus function interpretation unless they explicitly use the signifier “means for.”

While the drawings divide elements of the disclosure into different functional blocks or action blocks, these divisions are for illustration only. According to the principles of the present disclosure, functionality can be combined in other ways such that some or all functionality from multiple separately depicted blocks can be implemented in a single functional block; similarly, functionality depicted in a single block may be separated into multiple blocks.

Unless explicitly stated as mutually exclusive, features depicted in different drawings can be combined consistent with the principles of the present disclosure.

In the drawings, reference numbers may be reused to identify identical elements or may simply identify elements that implement similar functionality.

Numbering or other labeling of instructions or method steps is done for convenient reference, not to indicate a fixed order.

In the drawings, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. As just one example, for information sent from element A to element B, element B may send requests and/or acknowledgements to element A.

Unless otherwise indicated, recitations of ranges of values are merely intended to serve as a shorthand way of referring individually to each separate value falling within the range, and each separate value is hereby incorporated into the specification as if it were individually recited.

### Special-Purpose System

A special-purpose system includes hardware and/or software and may be described in terms of an apparatus, a method, or a computer-readable medium. In various embodiments, functionality may be apportioned differently between software and hardware. For example, some functionality may be implemented by hardware in one embodiment and by software in another embodiment. Further, software may be encoded by hardware structures, and hardware may be defined by software, such as in software-defined networking or software-defined radio.

In this application, including the claims, the term module refers to a special-purpose system. The module may be implemented by one or more special-purpose systems. The one or more special-purpose systems may also implement some or all of the other modules.

In this application, including the claims, the term module may be replaced with the terms controller or circuit.

In this application, including the claims, the term platform refers to one or more modules that offer a set of functions.

In this application, including the claims, the term system may be used interchangeably with module or with the term special-purpose system.

The special-purpose system may be directed or controlled by an operator. The special-purpose system may be hosted by one or more of assets owned by the operator, assets leased by the operator, and third-party assets. The assets may be referred to as a private, community, or hybrid cloud computing network or cloud computing environment.

For example, the special-purpose system may be partially or fully hosted by a third-party offering software as a service (SaaS), platform as a service (PaaS), and/or infrastructure as a service (IaaS).

The special-purpose system may be implemented using agile development and operations (DevOps) principles. In embodiments, some or all of the special-purpose system may be implemented in a multiple-environment architecture. For example, the multiple environments may include one or more production environments, one or more integration environments, one or more development environments, etc.

### Device Examples

A special-purpose system may be partially or fully implemented using or by a mobile device. Examples of mobile devices include navigation devices, cell phones, smart phones, mobile phones, mobile personal digital assistants, palmtops, netbooks, pagers, electronic book readers, tablets, music players, etc.

A special-purpose system may be partially or fully implemented using or by a network device. Examples of network devices include switches, routers, firewalls, gateways, hubs, base stations, access points, repeaters, head-ends, user equipment, cell sites, antennas, towers, etc.

A special-purpose system may be partially or fully implemented using a computer having a variety of form factors and other characteristics. For example, the computer may be characterized as a personal computer, as a server, etc. The computer may be portable, as in the case of a laptop, netbook, etc. The computer may or may not have any output device, such as a monitor, line printer, liquid crystal display (LCD), light emitting diodes (LEDs), etc. The computer may or may not have any input device, such as a keyboard, mouse, touchpad, trackpad, computer vision system, barcode scanner, button array, etc. The computer may run a general-purpose operating system, such as the WINDOWS operating system from Microsoft Corporation, the MACOS operating system from Apple, Inc., or a variant of the LINUX operating system.

Examples of servers include a file server, print server, domain server, internet server, intranet server, cloud server, infrastructure-as-a-service server, platform-as-a-service server, web server, secondary server, host server, distributed server, failover server, and backup server.

### Hardware

The term hardware encompasses components such as processing hardware, storage hardware, networking hardware, and other general-purpose and special-purpose components. Note that these are not mutually exclusive categories. For example, processing hardware may integrate storage hardware and vice versa.

Examples of a component are integrated circuits (ICs), application specific integrated circuit (ASICs), digital circuit elements, analog circuit elements, combinational logic circuits, gate arrays such as field programmable gate arrays (FPGAs), digital signal processors (DSPs), complex programmable logic devices (CPLDs), etc.

Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack.

Examples of a system-on-chip include a radio frequency (RF) system-on-chip, an artificial intelligence (AI) system-on-chip, a video processing system-on-chip, an organ-on-chip, a quantum algorithm system-on-chip, etc.

The hardware may integrate and/or receive signals from sensors. The sensors may allow observation and measurement of conditions including temperature, pressure, wear, light, humidity, deformation, expansion, contraction, deflection, bending, stress, strain, load bearing, shrinkage, power, energy, mass, location, temperature, humidity, pressure, viscosity, liquid flow, chemical/gas presence, sound, and air quality. A sensor may include image and/or video capture in visible and/or non-visible (such as thermal) wavelengths, such as a charge-coupled device (CCD) or complementary metal-oxide semiconductor (CMOS) sensor.

### Processing Hardware

Examples of processing hardware include a central processing unit (CPU), a graphics processing unit (GPU), an approximate computing processor, a quantum computing processor, a parallel computing processor, a neural network processor, a signal processor, a digital processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

### Processor Architecture

The processor may enable execution of multiple threads. These multiple threads may correspond to different programs. In various embodiments, a single program may be implemented as multiple threads by the programmer or may be decomposed into multiple threads by the processing hardware. The threads may be executed simultaneously to enhance the performance of the processor and to facilitate simultaneous operations of the application.

A processor may be implemented as a packaged semiconductor die. The die includes one or more processing cores and may include additional functional blocks, such as cache. In various embodiments, the processor may be implemented by multiple dies, which may be combined in a single package or packaged separately.

### Networking Hardware

The networking hardware may include one or more interface circuits. In some examples, the interface circuit(s) may implement wired or wireless interfaces that connect, directly or indirectly, to one or more networks. Examples of networks include a cellular network, a local area network (LAN), a wireless personal area network (WPAN), a metropolitan area network (MAN), and/or a wide area network (WAN). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs).

Examples of cellular networks include GSM, GPRS, 3G, 4G, 5G, LTE, and EVDO. The cellular network may be implemented using frequency division multiple access (FDMA) network or code division multiple access (CDMA) network.

Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard).

Examples of a WPAN include IEEE Standard 802.15.4, including the ZIGBEE standard from the ZigBee Alliance. Further examples of a WPAN include the BLUETOOTH wireless networking standard, including Core Specification versions 3.0, 4.0, 4.1, 4.2, 5.0, and 5.1 from the Bluetooth Special Interest Group (SIG).

A WAN may also be referred to as a distributed communications system (DCS). One example of a WAN is the internet.

### Storage Hardware

Storage hardware is or includes a computer-readable medium. The term computer-readable medium, as used in this disclosure, encompasses both nonvolatile storage and volatile storage, such as dynamic random-access memory (DRAM). The term computer-readable medium only excludes transitory electrical or electromagnetic signals propagating through a medium (such as on a carrier wave). A computer-readable medium in this disclosure is therefore non-transitory, and may also be considered to be tangible.

### EXAMPLES

Examples of storage implemented by the storage hardware include a database (such as a relational database or a NoSQL database), a data store, a data lake, a column store, a data warehouse.

Example of storage hardware include nonvolatile memory devices, volatile memory devices, magnetic storage media, a storage area network (SAN), network-attached storage (NAS), optical storage media, printed media (such as bar codes and magnetic ink), and paper media (such as punch cards and paper tape). The storage hardware may include cache memory, which may be collocated with or integrated with processing hardware.

Storage hardware may have read-only, write-once, or read/write properties. Storage hardware may be random access or sequential access. Storage hardware may be location-addressable, file-addressable, and/or content-addressable.

Example of nonvolatile memory devices include flash memory (including NAND and NOR technologies), solid state drives (SSDs), an erasable programmable read-only memory device such as an electrically erasable programmable read-only memory (EEPROM) device, and a mask read-only memory device (ROM).

Example of volatile memory devices include processor registers and random-access memory (RAM), such as static RAM (SRAM), dynamic RAM (DRAM), synchronous DRAM (SDRAM), synchronous graphics RAM (SGRAM), and video RAM (VRAM).

Example of magnetic storage media include analog magnetic tape, digital magnetic tape, and rotating hard disk drive (HDDs).

Examples of optical storage media include a CD (such as a CD-R, CD-RW, or CD-ROM), a DVD, a Blu-ray disc, and an Ultra HD Blu-ray disc.

Examples of storage implemented by the storage hardware include a distributed ledger, such as a permissioned or permissionless blockchain.

Entities recording transactions, such as in a blockchain, may reach consensus using an algorithm such as proof-of-stake, proof-of-work, and proof-of-storage.

Elements of the present disclosure may be represented by or encoded as non-fungible tokens (NFTs). Ownership rights related to the non-fungible tokens may be recorded in or referenced by a distributed ledger.

Transactions initiated by or relevant to the present disclosure may use one or both of fiat currency and cryptocurrencies, examples of which include bitcoin and ether.

Some or all features of hardware may be defined using a language for hardware description, such as IEEE Standard 1364-2005 (commonly called “Verilog”) and IEEE Standard 1076-2008 (commonly called “VHDL”). The hardware description language may be used to manufacture and/or program hardware.

A special-purpose system may be distributed across multiple different software and hardware entities. Communication within a special-purpose system and between special-purpose systems may be performed using networking hardware. The distribution may vary across embodiments and may vary over time. For example, the distribution may vary based on demand, with additional hardware and/or software entities invoked to handle higher demand. In various embodiments, a load balancer may direct requests to one of multiple instantiations of the special purpose system. The hardware and/or software entities may be physically distinct and/or may share some hardware and/or software, such as in a virtualized environment. Multiple hardware entities may be referred to as a server rack, server farm, data center, etc.

### Software

Software includes instructions that are machine-readable and/or executable. Instructions may be logically grouped into programs, codes, methods, steps, actions, routines, functions, libraries, objects, classes, etc. Software may be stored by storage hardware or encoded in other hardware. Software encompasses (i) descriptive text to be parsed, such as HTML (hypertext markup language), XML (extensible markup language), and JSON (JavaScript Object Notation), (ii) assembly code, (iii) object code generated from source code by a compiler, (iv) source code for execution by an interpreter, (v) bytecode, (vi) source code for compilation and execution by a just-in-time compiler, etc. As examples only, source code may be written using syntax from languages including C, C++, JavaScript, Java, Python, R, etc.

Software also includes data. However, data and instructions are not mutually exclusive categories. In various embodiments, the instructions may be used as data in one or more operations. As another example, instructions may be derived from data.

The functional blocks and flowchart elements in this disclosure serve as software specifications, which can be translated into software by the routine work of a skilled technician or programmer.

Software may include and/or rely on firmware, processor microcode, an operating system (OS), a basic input/output system (BIOS), application programming interfaces (APIs), libraries such as dynamic-link libraries (DLLs), device drivers, hypervisors, user applications, background services, background applications, etc. Software includes native applications and web applications. For example, a web application may be served to a device through a browser using hypertext markup language 5th revision (HTML5).

Software may include artificial intelligence systems, which may include machine learning or other computational intelligence. For example, artificial intelligence may include one or more models used for one or more problem domains.

When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

Examples of the models include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformer (GPT).

Training a machine-learning model may include supervised learning (for example, based on labelled input data), unsupervised learning, and reinforcement learning. In various embodiments, a machine-learning model may be pre-trained by their operator or by a third party.

Problem domains include nearly any situation where structured data can be collected, and includes natural language processing (NLP), computer vision (CV), classification, image recognition, etc.

### ARCHITECTURES

Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc.

In a client-server model, some of the software executes on first hardware identified functionally as a server, while other of the software executes on second hardware identified functionally as a client. The identity of the client and server is not fixed: for some functionality, the first hardware may act as the server while for other functionality, the first hardware may act as the client. In different embodiments and in different scenarios, functionality may be shifted between the client and the server. In one dynamic example, some functionality normally performed by the second hardware is shifted to the first hardware when the second hardware has less capability. In various embodiments, the term “local” may be used in place of “client,” and the term “remote” may be used in place of “server.”

Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

Some or all of the software may be arranged logically into layers. In a layered architecture, a second layer may be logically placed between a first layer and a third layer. The first layer and the third layer would then generally interact with the second layer and not with each other. In various embodiments, this is not strictly enforced—that is, some direct communication may occur between the first and third layers.

What is claimed is:

1. A method of minting a plurality of asset-class backed tokens on a distributed ledger, the method comprising:
receiving, by a tokenization platform comprising one or more processors and memory, a token configuration indicating a plurality of revenue-generating assets and a minting party, wherein the plurality of revenue-generating assets includes at least two different types of assets;
configuring, by the tokenization platform, one or more smart contracts to manage revenue associated with the plurality of revenue-generating assets, wherein the configuring comprises:
configuring a first function of the one or more smart contracts to mint a plurality of asset-class backed tokens that are backed by the plurality of assets that include at least two different types of assets; and
configuring a second function of the one or more smart contracts to computationally apportion and distribute the revenue among blockchain addresses of current owners of the plurality of asset-class backed tokens;
deploying, by the tokenization platform, the configured one or more smart contracts on the distributed ledger;
responsive to one or more purchase requests received by the tokenization platform, initiating, by the tokenization platform, a first transaction on the distributed ledger with an address associated with the first function of the one or more smart contracts, wherein the first transaction invokes the first function to cause minting of the plurality of asset-class backed tokens and assignment of each minted asset-class backed token to the blockchain address of a purchasing user by updating ownership records within the one or more smart contracts; and
periodically initiating, by the tokenization platform, one or more second transactions on the distributed ledger with an address associated with the second function of the one or more smart contracts, wherein the one or more second transactions invoke the second function to computationally apportion and distribute cryptocurrency stored by the one or more smart contracts that corresponds to the revenue to the blockchain addresses of the current owners of the plurality of asset-class backed tokens.

2. The method of claim 1, wherein each of the plurality of asset-class backed tokens are backed by a first asset of the plurality of revenue-generating assets and a second asset of the plurality of revenue-generating assets, wherein the first asset is a first type of asset and the second asset is a second type of asset, wherein each asset-class backed token comprises a plurality of attributes including a first asset identifier attribute that identifies the first asset, a first asset amount attribute that identifies a portion of the first asset, a second asset identifier attribute that identifies the second asset, and a second asset amount attribute that identifies a portion of the second asset.

3. The method of claim 2, wherein the plurality of attributes further include at least one of an availability trigger that specifies when the first asset becomes available for redemption or an expiration trigger that specifies when the first asset is no longer available for redemption.

4. The method of claim 2, wherein the plurality of attributes further include one or more of token redemption rules or token governance rules.

5. The method of claim 1, further comprising verifying, by the tokenization platform, that the minting party owns the plurality of revenue-generating assets prior to deploying the one or more smart contracts.

6. The method of claim 1, wherein the minting party is a crowdfunding pool, wherein the blockchain addresses of the current owners of the plurality of asset-class backed tokens are associated with users of the crowdfunding pool, and wherein the distribution of the revenue is in proportion to an amount a corresponding user contributed to the crowdfunding pool.

7. The method of claim 1, wherein the minting party is a portfolio seller, wherein the blockchain addresses correspond to portfolio buyers.

8. The method of claim 1, wherein each asset-class backed token is redeemable for a portion of the plurality of revenue-generating assets.

9. The method of claim 1, wherein the token configuration is received from a token strategy engine configured to generate the token configuration based on a plurality of token performance attributes provided by the minting party.

10. The method of claim 1, wherein the plurality of revenue-generating assets comprises ownership of land and usage rights to the land.

11. The method of claim 1, wherein the plurality of revenue-generating assets comprises ownership of a productive asset and an income stream from the productive asset.

12. The method of claim 1, wherein the plurality of revenue-generating assets comprises a derivative asset corresponding to a first set of assets and a derivative asset corresponding to a second set of assets.

13. The method of claim 12, wherein the first set of assets are each related to a first oil and/or gas production facility and the second set of assets are each related to a second oil and/or gas production facility.

14. The method of claim 1, wherein at least one of plurality of assets is an intellectual property asset, wherein owners of the plurality of asset-class backed tokens are entitled to sublicense at least a portion of intellectual property rights corresponding to the intellectual property asset.

15. The method of claim 1, further comprising:
receiving, by the tokenization platform, a plurality of governance rules based on one or more governance requirements associated with the plurality of revenue-generating assets; and
configuring, by the tokenization platform, the one or more smart contracts based on the plurality of governance rules.

16. The method of claim 1, further comprising:
generating, using a token simulator system, an estimated value of the plurality of revenue-generating assets;
determining, based on the estimated value of the plurality of revenue-generating assets, an estimated value of each token of the plurality of asset-class backed tokens; and
transmitting, to a marketplace system, an indication of the estimated value of each token of the plurality of asset-class backed tokens.

17. The method of claim 16, wherein the marketplace system sets a minimum price of each of the plurality of asset-class backed tokens based on the estimated value of each token of the plurality of asset-class backed tokens, wherein the estimated value of plurality of assets includes an estimated income produced by an income stream asset.

18. A tokenization system for minting a plurality of asset-class backed tokens on a distributed ledger, the tokenization system comprising:
one or more processors; and
memory storing instructions that, when executed by the one or more processors, cause the tokenization system to perform steps comprising:
receiving a token configuration indicating a plurality of revenue-generating assets and a minting party, wherein the plurality of revenue-generating assets includes at least two different types of assets;
configuring one or more smart contracts to manage revenue associated with the plurality of revenue-generating assets, wherein the configuring comprises:
configuring a first function of the one or more smart contracts to mint a plurality of asset-class backed tokens that are backed by the plurality of assets that include at least two different types of assets; and
configuring a second function of the one or more smart contracts to computationally apportion and distribute the revenue among blockchain addresses of current owners of the plurality of asset-class backed tokens;
deploying the configured one or more smart contracts on the distributed ledger;
responsive to one or more purchase requests received by the tokenization system, initiating a first transaction on the distributed ledger with an address associated with the first function of the one or more smart contracts, wherein the first transaction invokes the first function to cause minting of the plurality of asset-class backed tokens and assignment of each minted asset-class backed token to the blockchain address of a purchasing user by updating ownership records within the one or more smart contracts; and
periodically initiating one or more second transactions on the distributed ledger with an address associated with the second function of the one or more smart contracts, wherein the one or more second transactions invoke the second function to computationally apportion and distribute cryptocurrency stored by the one or more smart contracts that corresponds to the revenue to the blockchain addresses of the current owners of the plurality of asset-class backed tokens.

19. The tokenization system of claim 18, wherein each of the plurality of asset-class backed tokens are backed by a first asset of the plurality of revenue-generating assets and a second asset of the plurality of revenue-generating assets, wherein the first asset is a first type of asset and the second asset is a second type of asset, wherein each asset-class backed token comprises a plurality of attributes including a first asset identifier attribute that identifies the first asset, a first asset amount attribute that identifies a portion of the first asset, a second asset identifier attribute that identifies the second asset, and a second asset amount attribute that identifies a portion of the second asset.

20. The tokenization system of claim 19, wherein the plurality of attributes further include at least one of an availability trigger that specifies when the first asset becomes available for redemption or an expiration trigger that specifies when the first asset is no longer available for redemption.
